(19) United States
(12) Patent Application Publication
(10) Pub. No.: US 2010/0131082 A1
(43) Pub. Date: May 27, 2010

(54) Inversion Loci Generator and Criteria Evaluator for Rendering Errors in Variable Data Processing

(76) Inventor: Larry S. Chandler, Falls Church, VA (US)

Correspondence Address: CROWELL & MORING LLP;INTELLECTUAL PROPERTY GROUP, P.O. BOX 14300, WASHINGTON, DC, 20044-4300, US

(21) Appl. No.: 12/626,701

(22) Filed: Nov. 27, 2009

Related U.S. Application Data
(63) Continuation-in-part of application No. 11/802,553, filed on May 23, 2007.

(51) Int. Cl. G05B 13/04

(52) U.S. Cl. 700/30; 700/33

(57) ABSTRACT

Reduction deviations are rendered as dependent coordinate mappings of two-dimensional displacements which characterize restraints associated with deviations of observation sampling measurements from a fitting function. The mappings are considered to be represented by both projections and path coincident deviations. Data inversions are generated as loci and discriminated by criteria corresponding to deviations associated with alternate forms for representing essential weighting. Deficiencies related to nonlinearities and heterogeneous precision are compensated by essential weight factors.

### REFERENCE TO APPENDICES A, B, AND C

This disclosure includes computer program listings and support data in Appendices A, B, and C, submitted in the form of a compact disk appendix containing respective files: Appendix A, created Nov. 26, 2009, containing QBASIC command code file Locus.txt comprising 129K memory bytes, a data folder including 10 ascii alpha numeric data files created between Mar. 24, 2006 and Apr. 16, 2007, comprising 5.58K bytes, and a loci folder including 7 ascii alpha numeric data files created between Nov. 15, 2009 and Nov. 24, 2009, comprising 49.1K bytes; Appendix B, created Nov. 26, 2009, containing four QBASIC command code files, created between 18 Feb. 18, 2009 and Oct. 9, 2009, comprising 479K bytes; and Appendix C, created Nov. 26, 2009, containing four QBA-SIC command code files, created between May 19, 2007 and Nov. 25, 2009, comprising 410K bytes, comprising a total of 1073K memory bytes, which are incorporated herein by reference.

### STATEMENT OF DISCLOSURE COPYRIGHT

The entirety of this document and referenced appendices may be reproduced in whole or in part by the Government of the United States for purposes of present invention patent disclosure. Unauthorized reproduction of the same, whether in whole or in part, is prohibited ©2009 L. S. Chandler.

### BACKGROUND OF THE INVENTION

The present invention relates to means for representing system behavior in correspondence with both sparse or densely represented errors-in-variables observation sampling data. More particularly, the present invention is a data processing system comprising a control system, a weight factor generator, and a locus generator programmed with criteria for recognizing a best fit of errors-in-variables data inversions being rendered to include comparison between two alternate forms of essential weighting of squared path coincident reduction deviations.

As empirical relationships are often required to describe system behavior, data analysts continue to rely upon least-squares and maximum likelihood approximation methods to fit both linear and nonlinear functions to experimental data. Fundamental concepts, related to both maximum likelihood estimating and least-squares curve fitting, stem from the early practice referred to in 1766 by Euler as calculus of variation. The related concepts were developed as first considered in the mid 1700's, primarily through the efforts of Lagrange and Euler, utilizing operations of calculus for locating maximum and minimum function value correspondence.

Maximum and minimum values and certain inflection points of a function occur at coordinates which correspond to points of zero slope along the function related curve. To determine the point where a minimum or maximum occurs, one derives an expression for the derivative (or slope) of the function and equates the expression to zero. By merely equating the derivative of the function to zero, local parameters, which respectively establish the maximum or minimum function values, can be determined.

The process of Least-Squares analysis utilizes a form of calculus of variation in statistical application to determine fitting parameters which establish a minimum value for the sum of squared single component residual deviations from a parametric fitting function. The process was first publicized in 1805 by Legendre. Actual invention of the least-squares method is clearly credited to Gauss, who as a teenage prodigy first developed and utilized it prior to his entrance into the University of Gottingen.

Maximum likelihood estimating has a somewhat more general application than that of least-squares analysis. It is traditionally based upon the concept of maximizing a likelihood, which may be defined either as the product of discrete sample probabilities or as the product of measurement sample probability densities, for the current analogy and in accordance with the present invention, it may be either, or a combination of both. By far, the most commonly considered form for representing a probability density function is referred to as the normal probability density distribution function (or Gaussian distribution). The respective Gaussian probability density function as formulated for a standard deviation of σ_{Y} in the measurement of [symbol] will take the form of Equation 1:

$$D ( Y - y ) = \frac{1}{\sqrt{2 {πσ}_{Y}^{2}}} {e}^{- \frac{{( Y - y )}^{2}}{2 {σ}_{Y}^{2}}} , \qquad ( 1 )$$

wherein D represents a probability density, Y represents either a single component observation or a dependent variable measurement, and [symbol] represents the expected or true value for said single component or said dependent variable. The formula for the Gaussian distribution was apparently derived by Abraham de Moivre in about 1733. The distribution function is dubbed Gaussian distribution due to extensive efforts of Gauss related to characterization of observable errors. Consistent with the concept of a probability density distribution function, the actual probability of occurrence is considered as the integral or sum of the probability density, taken (or summed) over a range of possible samples. A characteristic of probability distribution functions is that the area under the curve, considered between minus and plus infinity or over the range of all possible dependent variable measurements, will always be equal to unity. Thus, the probability of any arbitrary sample lying within the range of the distribution function entire is one, e.g.,

∫_{-∞}^{+∞}D(Y− [symbol] dY=1. (2)

For a typical linear Gaussian Likelihood estimator, L_{Y}, being considered to exemplify variations in the measurement of [symbol] as a single valued function or as a linear function with the mean squared deviations associated with each data sample being independent of coordinate location, the explicit likelihood estimator will take the form of Equation 3:

$${L}_{Y} = {\prod }_{k = 1}^{K} \frac{1}{\sqrt{2 {πσ}_{Y}^{2}}} {e}^{- \frac{{( Y - y )}_{k}^{2}}{2 {σ}_{Y}^{2}}} = ( {\prod }_{k = 1}^{K} \frac{1}{\sqrt{2 {πσ}_{Y}^{2}}} ) {e}^{- {\sum }_{k = 1}^{K} \frac{{( Y - y )}_{k}^{2}}{2 {σ}_{Y}^{2}}} . \qquad ( 3 )$$

The Y subscript on the likelihood estimator without an additional subscript indicates the product of probabilities (or the product of probability density functions) being related to measurements of the dependent variable, [symbol] as an analytical representation of a respective data sample, Yₖ. The lower case italic [symbol] subscript designates the data sample or respective data-point coordinate measurement, and the upper case K represents the total number of data points being considered.

A simplified form for maximizing the likelihood is rendered by taking the natural log of the estimator, as exemplified by Equation 4:

$$ln {L}_{Y} = ln ( {\prod }_{k = 1}^{K} \frac{1}{\sqrt{2 {πσ}_{Y}^{2}}} ) - {\sum }_{k = 1}^{K} \frac{{( Y - y )}_{k}^{2}}{2 {σ}_{Y}^{2}} . \qquad ( 4 )$$

Since the maximum values for the natural log of L_{Y} will always coincide with the maximum values for L_{Y}, maximum likelihood can be determined by equating the derivatives of In L_{Y} to zero. The first term on the right hand side of Equation 4 can be considered to be a determined constant which need not be included. The term on the far right represents minus one half of the respective sum of squared deviations normalized on the square of the standard deviation, so that maximizing the log of the likelihood should provide the same set of inversion equations that will minimize the respective sum of correspondingly weighted square deviations. In accordance with the present invention, the likelihood estimator is independent of the sign of a deviation being squared, so that whether the deviation is generated as Y− [symbol] or [symbol] −Y, the square of that deviation will be the same. Taking the partial derivative of In L_{Y} with respect to each of the fitting parameters, Pₚ, will yield:

$$\frac{\partial ln {L}_{Y}}{\partial {P}_{p}} = {\sum }_{k = 1}^{K} \frac{{( Y - y )}_{k}}{{σ}_{Y}^{2}} \frac{\partial {y}_{k}}{\partial {P}_{p}} . \qquad ( 5 )$$

The p subscript is included to respectively designate each included fitting parameter. Replacing the parametric fitting parameter representations, Pₚ, by determined ones, [symbol] , and equating the partial derivatives to zero will yield Equations 6:

$${\sum }_{k = 1}^{K} \frac{{( Y - y )}_{k}}{{σ}_{Y}^{2}} {( \frac{\partial {y}_{k}}{\partial {P}_{p}} )}_{{𝒫}_{p}} = 0. \qquad ( 6 )$$

The closed parenthesis with double subscript [symbol] is included to indicate replacement of each undetermined fitting parameter, Pₚ, with its respectively determined counter part, [symbol] . The [symbol] subscript infers representation of, or evaluation with respect to, a corresponding observation sample measurement or a respective coordinate sample datum.

Note that the construction of the center equality of Equation 3 is based upon the assumption that the likely deviation of each included sample is Gaussian. Such is seldom the case, but the validity of Equation 3 can be alternately based upon the premise that the sums of arbitrary groupings of sample deviations with non-skewed uncertainty distributions may also be considered as Gaussian.

In accordance with the present invention, non-skewed error distributions, including non-skewed probability density distributions, may be defined as any form of observation uncertainty distributions for which the mean sample value can always be assumed to approach a “true” value (or acceptably accurate mean representation for what is assumed to be the expected or true value) in the limit as the number of random samples approaches infinity.

In accordance with the present invention, mean squared deviations, which are established from groupings of arbitrary samples of non-skewed homogeneous error distributions, can be treated as Gaussian. By alternately considering the likelihood estimator as the product of probabilities of one or more such groupings, rather than the product of individual sampling probabilities, the validity of Equation 3 may be established. In accordance with the present invention, the validity of Equation 3 may be established for applications which are subject to the condition that the summation in the exponent of the second term on the right is at least locally representative of sufficient numbers of data samples of non-skewed uncertainty distribution to establish appropriate mean values along the fitting function. The likelihood estimator can be alternately written in the form of Equations 7 to establish representation of such groupings:

$$\begin{matrix}{L}_{Y} = {\prod }_{g = 1}^{G} {\prod }_{{k}_{g} = 1}^{{K}_{g}} \frac{1}{\sqrt{2 {πσ}_{Y}^{2}}} {e}^{- {\sum }_{{k}_{g} = 1}^{{K}_{g}} \frac{{( {Y}_{g} - {y}_{g} )}_{{k}_{g}}^{2}}{2 {σ}_{Y}^{2}}} \\ = {\prod }_{g = 1}^{G} {\prod }_{{k}_{g} = 1}^{{K}_{g}} \frac{1}{\sqrt{2 {πσ}_{Y}^{2}}} {e}^{- \frac{{K}_{g} \overline{{( {Y}_{g} - {y}_{g} )}^{2}}}{2 {σ}_{Y}^{2}}}\end{matrix}$$

The subscript g of Equations 7 designates the group; the typewriter type G represents the number of groups; the K_{g} represents the number of samples associated with each respective group; and the k_{g} refers to the specific sample of the respective group, such that the total number of data samples is equal to the sum of the samples included in each group. The line over the squared deviations is placed to indicate the mean squared deviation which may be statistically considered or simply obtained by dividing the sum of the squared deviations by the number of addends, or in this example K_{g}. Notice that a relative weighting of the mean squared deviation of each group, as included in the overall sum of squared deviations, is dependent upon an observation occurrence which, in this example, may be assumed to be proportional to the number of elements in the respective group and not the square of said number of elements. (Note that this fact is both significant, and consistent with the example number three of U.S. Pat. No. 7,383,128 B2, which concludes that weighting of squared deviations “must be rendered as inversely proportional to the respective standard deviations and not inversely proportional to the square of said standard deviations, as so commonly assumed.”)

In addition, in accordance with the present invention, note that changes in slope along a fitting function segment will also affect probability of occurrence. The terminology “locally representative,” as considered in correspondence with a specified fitting function, may be defined as over local regions with only small or assumed insignificant changes in slope, or said locally representative may be alternately defined as over local regions without extreme changes in slope.

In consideration of applications of Equation 3, with provision of sample groupings as exemplified by Equations 7 being subject to the condition that the mean square deviations of each of the considered groupings can be assumed to be representative of a Gaussian distribution, in accordance with the present invention the validity of Equations 6 can be established in any one of three ways. These are:
1. Each data sample can be representative of a uniform Gaussian uncertainty distribution over the extremities of a linear fitting function;
2. Each data sample can be representative of a point-wise non-skewed uncertainty distribution, assuming sufficient data samples of a same distribution are provided at each localized region along the fitting function to establish localized sums of nonlinear samples as being characterized by homogeneous Gaussian distribution functions;
3. Each data sample can be representative of a point-wise Gaussian uncertainty distribution, also assuming sufficient data samples of a same distribution are provided at each localized region along the fitting function to establish localized sums of nonlinear samples as being characterized by homogeneous Gaussian distribution functions.

In accordance with the present invention, conditions for maximum likelihood can be alternately realized for data not satisfying any of these three criteria, provided that the elements of the likelihood estimator, as rendered to represent the observation samples and as correspondingly rendered in the sum of squared reduction deviations can be appropriately normalized and weighted to compensate for skewed error distributions, nonlinearities, and all associated heterogeneous sampling. In accordance with the present invention reduction deviations can be defined as the difference between evaluated path designators and respectively mapped observation samples, rendered as dependent coordinate mappings of two-dimensional displacements which characterize restraints associated with deviations of observation sampling measurements from a fitting function.

Reduction deviations, alternately referred to herein as path-oriented deviations,can be rendered in any of at least six representative forms. Along with any approximations of the same, these include:
1. coordinate oriented residual deviations,
2. coordinate oriented data-point projections,
3. path coincident deviations,
4. path-oriented projections,
5 transverse coordinate deviations, and
6. transverse coordinate data-point projections.
   The coordinate oriented residual deviations and data-point projections of form items 1 and 2 are well documented in U.S. Pat. No. 7,107,048, however they do not establish the bivariate coupling that is apparently characteristic of and needed for applications with errors in more than one variable.

In considering the above form items 3 through 6, in accordance with the present invention, in accordance with the Pending U.S. patent application Ser. No. 11/802,533, skew ratios can be included in conjunction with component variability and tailored weight factors to establish essential weighting for rendering sums of squared reduction deviations to compensate for said bivariate coupling and provide adjustments for nonlinearity and heterogeneous observation sampling, thus allowing each individual projection or deviation which might be included in the likelihood estimator to be characterized by a unified and normal (or Gaussian) uncertainty distribution.

In accordance with the present invention, Equations 6 may be alternately written to compensate for skewed uncertainty distributions, nonlinearities and/or heterogeneous sampling by including representation for an essential weight factor, [symbol] , as in Equations 8:

$${\sum }_{k = 1}^{K} {{𝒲}_{{Y}_{k}} ( Y - 𝒴 )}_{k} {( \frac{\partial {𝒴}_{k}}{\partial {P}_{p}} )}_{𝒫 p} = 0. \qquad ( 8 )$$

The Y subscript on the essential weight factor, as in the case of Equations 8, implies the weighting of residual deviations between dependent variable sample measurements, Y, and the respectively evaluated dependent variable, [symbol] .

In accordance with the present invention, the essential weight factor, [symbol] may be defined as comprising a tailored weight factor, W being multiplied by the square of a deviation normalization coefficient, [symbol] (Ref. Pending U.S. patent application Ser. No. 11/802,533.) The purpose of said deviation normalization coefficient is to render the reduction deviation so as to be characterized by a non-skewed homogeneous uncertainty distribution mapped on to a selected dependent variable coordinate. In accordance with the present invention, as related to said Pending U.S. patent application Ser. No. 11/802,533, said deviation normalization coefficient may be defined as the ratio of a non-skewed dependent component deviation to a dependent coordinate deviation mapping, generally rendered as a presumed skew ratio, [symbol] , normalized on the square root of a type of non-skewed dependent component deviation variability, [symbol] :

$$𝒞 = \frac{ℛ}{\sqrt{{𝒱}_{ℛ}}} \frac{{ℛ}_{𝒢}}{\sqrt{{𝒱}_{𝒢}}} . \qquad ( 9 )$$

The leadsto sign, [symbol] suggests one of a plurality of considered representations. The calligraphic [symbol] subscript implies application ‘to path-oriented projections. A similarly placed sans serif G subscript would imply application to path coincident deviations. In accordance with the present invention, as related to said Pending U.S. patent application Ser. No. 11/802,533, the skew ratio may be defined as the ratio of a non-skewed representation for a dependent component deviation to a respective coordinate representation for a considered reduction deviation. In accordance with the present invention, as related to said Pending U.S. patent application Ser. No. 11/802,533, variability is of broader interpretation than the square of the standard deviation. It is not limited to specifying the mean square deviation but may represent alternate forms of uncertainty, including uncertainty in estimates and measurements, as considered in correspondence with respective data sampling or as associated with considered projections; and it may be alternately rendered as a form of dispersion accommodating variability (Ref. U.S. Patents No. 61/81,976 and U.S. Pat. No. 7,107,048) and or alternately include the effects of independent measurement error and/or antecedent measurement dispersions; said antecedent measurement dispersions being considered in correspondence with uncertainty in said data sampling or in the representation or mapping of path coincident deviations or path-oriented projections including path-oriented data-point as considered herein, or coordinate oriented data-point projections as previously considered by the present inventor in U.S. Pat. Nos. 7,107,048 and 7,383,128, and in said Pending U.S. patent application Ser. No. 11/802,533. In accordance with the present invention, weight factors, skew ratios, deviation coefficients, and variability, as thus considered, should all be rendered as functions of the provided data as related to a “hypothetically ideal fitting function” and, as such, they (or successive estimates of the same) should be held constant during minimizing and maximizing procedures associated with forms of calculus of variation which may be implemented for the optimization of fitting parameters.

The deviation variability, [symbol] , as included in representing tailored and essential weighting of squared deviations, in accordance with the present invention, may be considered in at least two general types, which are herein designated symbolically as:
1. [symbol] referring to the considered variability of assumed-to-be non-skewed dependent variable data samples; and
2. [symbol] referring to estimates for the considered variability of determined values for the dependent variable as a function of independent variable observation samples.

Referring now to deviation variability type 1 and considering a simple application with errors being limited to the dependent variable, that is: assuming a non-skewed homogeneous error distribution in measurements of the dependent variable, for no errors in the independent variable or independent variables (plural, as the case may be,) the variability of the dependent component deviation can be considered equal to the mean square deviations (or square of the standard deviation, σ_{Y}²) of the dependent variable measurements. The respective essential weight factor may be represented as the tailored weight factor, W_{Y}_{ₖ}, normalized on the square of the standard deviation and multiplied by the square of the skew ratio:

$${𝒲}_{{Y}_{k}} \frac{{W}_{{Y}_{k}}}{{σ}_{{Y}_{k}}^{2}} {ℛ}_{{Y}_{k}}^{2} . \qquad ( 10 )$$

For this specific application, the skew ratio (being rendered for a homogeneous uncertainty distribution) would be equal to one. The subscripts, Y, which are included on the skew ratio and tailor weight factor, imply that the essential weighting is being tailored to the function [symbol] of path coincident devations, Yₖ− [symbol] whose sample measurements, Yₖ, as normalized on the local characteristic standard deviations, σ_{Y}_{ₖ}, are assumed representative of non-skewed error distributions. The deviation variability in Equations 10 is assumed to be represented as the mean squared deviation or the square of the standard deviation. The subscript [symbol] designates each single observation comprising the dependent and independent variable sample measurements.

In accordance with the present invention, a representation for essential weight factors with the deviation variability type 1, as considered for weighting of path coincident deviations, for more general application, may be expressed in a general form by Equations 11.

$${𝒲}_{{G}_{k}} = {ℛ}_{{G}_{k}}^{2} \frac{{W}_{{G}_{k}}}{{𝒱}_{{G}_{k}}} , \qquad ( 11 )$$

wherein general representation for a mapped observation sample, Gₖ, is included as a subscript to imply allowance, by weight factor tailoring, for any considered representation, transformation, or mapping of a path coincident deviation onto the currently considered dependent variable coordinate, as a function of N−1 independent variables, [symbol] .

In accordance with the present invention, a representation for essential weight factors with the deviation variability type 2, as considered for weighting of squared path-oriented projections, may be expressed in a general form by Equations 12.

$${𝒲}_{{𝒢}_{k}} = {ℛ}_{{𝒢}_{k}}^{2} \frac{{W}_{{𝒢}_{k}}}{{𝒱}_{{𝒢}_{k}}} , \qquad ( 12 )$$

wherein general representation for a path designator, [symbol] is included as a subscript to imply allowance, by weight factor tailoring, for any considered representation, transformation, or mapping of a path-oriented projection onto the currently considered dependent variable coordinate as a function of N−1 independent variables, [symbol] .

Assume a general form for said path designator to be a function of the independent variable or variables, such that:

[symbol]

= [symbol] [symbol] , . . . , [symbol] . . . , [symbol] ₋₁), (13)

where G is considered, in accordance with the present invention, to represent said general form as the function term of a path-oriented deviation which can be evaluated in correspondence with data samples, Xᵢₖ, of said independent variable or variables, i.e.

[symbol]

= [symbol] (X₁ₖ, . . . , Xᵢₖ, . . . , X_{N-1,k}). (14)

So evaluated, the path designators along with the respectively mapped observation samples, G, can establish reduction deviations in the form of projections or approximate path coincident deviations, and define displacements which, when most appropriately rendered, should reflect a statistical correspondence between data samples and a considered fitting function.

In accordance with the present invention, the subscript [symbol] as considered herein, may be replaced by an alternate subscript, G, to distinguish the normalization of path coincident deviations being based upon the assumed representation of true or expected values. Certain past concepts of statistics have been hypothetically based upon this assumption. These concepts can only be consistent with Equation 13 provided that the true or expected value can be directly expressed as a function of orthogonal variable samples. Such cannot be the case for errors-in-variables applications. For appropriate applications, at least one of three alternate considerations can be made:
#1. One can assume that errors in independent variables are indeed small or nonexistent;
#2. For a sufficient amount of data, if the considered path as represented or appropriately weighted can be considered to correspond to a mean deviation path; or
#3. One can replace the considered residual and path coincident deviations by dependent coordinate mappings of path-oriented projections by assuming a Type 2 variability in correspondence with the subscript [symbol] .

Referring to consideration #1, as the errors-in the independent variables are small or nonexistent, the independent variable data samples can be considered to correspond to true values which lie on the fitting function proper, and the path designator of Equation 13 can be correspondingly evaluated by utilizing less sophisticated reduction techniques, thus providing a valid reduction when errors are limited to the dependent variable.

To address consideration #2, that of path coincident deviations, that is, assuming that the defined path might reflect a mean deviation path: This assumption has to be based upon the premise that the path designator, as an evaluated function of displaced data samples, is a sufficiently accurate approximation and that the defined deviation path actually represents or statistically corresponds in proportion to the expected path of the deviations. In accordance with the present invention, by assuming path coincident deviations, the Gaussian distribution of Equation 1 can be alternately expressed by the approximation of Equation 15 to accommodate maximum likelihood estimating with respect to associated deviation paths with type 1 deviation variability:

$$D ( \frac{{W}_{G} {{ℛ}_{G}^{2} ( G - 𝒢 )}^{2}}{2 {𝒱}_{G}} ) \approx \frac{1}{\sqrt{2 π {M}_{G}}} {e}^{- \frac{{W}_{G} {{ℛ}_{G} ( G - 𝒢 )}^{2}}{2 {𝒱}_{G} {M}_{G}}} . \qquad ( 15 )$$

Note that the calligraphic subscript [symbol] on the variability, the weight factors, and the skew ratio of Equations 11 has been replaced in Equation 15 by a sans serif G to indicate that the respective weighting and normalization of the considered deviations are assumed for path coincident deviations to be directly, or at least primarily, associated with the observation uncertainty. The deviation variability, [symbol] is correspondingly defined, in accordance with the present invention, as the variability which is to be associated with the normalization of respective path coincident deviations. An approximation sign is included in Equation 15 as a result of the approximation that path coincident deviations be represented as a function of unknown true or expected values.

The capital M with the subscript G in Equation 15 represents the mean square deviation of the normalized and weighted path coincident deviations, as evaluated with respect to the determined fitting function or considered approximations of the same. In accordance with the present invention, M_{G} represents a constant value (or proportionality constant) which need not be included nor evaluated to determine maximum likelihood.

By assuming sample observation likelihood probability, to be proportional to the tailored weight factor at each respective function related observation point, and by also assuming a sufficient number of weighted samples to insure that the sum of the weighted deviations is representative of a Gaussian distribution, the associated likelihood estimators, as written to include tailored weighting to accommodate the respective probabilities of observation occurrence for path coincident deviations, can be approximated by Equation 16:

$${L}_{G} \approx {\prod }_{k = 1}^{K} \frac{1}{\sqrt{2 π {M}_{G}}} {e}^{- \frac{{W}_{{G}_{k}} {{ℛ}_{{G}_{k}}^{2} ( G - 𝒢 )}_{k}^{2}}{2 {𝒱}_{{G}_{k}} {M}_{G}}} . \qquad ( 16 )$$

Like Equation 15, as considered in accordance with the present invention, forms of Equation 16 can only be considered approximate due to the fact that the mapping of the path/inversion intersection or path descriptor [symbol] for path coincident deviations, can be estimated but not actually be evaluated in correspondence with unknown true or expected points assumed to lie on the pre considered fitting function.

In accordance with the present invention, for path coincident deviations, the tailored weight factors, W_{G}_{ₖ}, may be defined as the square root of the sum of the squares of the partial derivatives of each of the independent variables as normalized on square roots of respective local variabilities, or as alternately rendered as locally representative of non-skewed homogeneous error distributions, said partial derivatives being taken with respect to the locally represented path designator [symbol] multiplied by a local skew ratio, [symbol] and normalized on the square root of the respectively considered type 1 deviation variability, [symbol] .

$$\begin{matrix}{W}_{{G}_{k}} = \sqrt{{\sum }_{i = 1}^{N - 1} {( \frac{\partial {𝒳}_{i} / \sqrt{{𝒱}_{i}}}{\partial {ℛ}_{G} 𝒢 / \sqrt{{𝒱}_{G}}} )}_{𝒫 k}^{2}} \\ = \sqrt{\frac{{𝒱}_{{G}_{k}}}{{ℛ}_{{G}_{k}}^{2}} {\sum }_{i = 1}^{N - 1} \frac{1}{{𝒱}_{ik}} {( \frac{\partial {𝒳}_{i}}{\partial 𝒢} )}_{𝒫 k}^{2}}\end{matrix} \qquad ( 17 )$$

wherein the sans serif subscript, i, implies representation of an independent variable. The k subscript indicates local evaluation or measurement corresponding to an observation comprising N dependent and independent variable sample measurements.

In accordance with the present invention, for said local evaluation both variability and skew ratio may be assumed to be functions of the observed phenomena as related to an ideal fitting function and associated data sampling and, therefore, considered as observation constants which can be removed from behind and placed in front of the differential sign.

In accordance with the present invention, the partial derivatives of independent variables taken with respect to the locally represented path designator, ∂ [symbol] /∂ [symbol] may be evaluated as the inverse of the respective path designator taken with respect to the associated independent variables.

In accordance with the present invention, the terminology, as locally representative of a non-skewed homogeneous error distribution, is meant to imply representation as an element of a localized set or grouping of considered coordinate corresponding observation sample measurements of a same non-skewed homogeneous error distribution.

In accordance with the present invention, the fitting function and respective notation may be arranged to place alternate variables in position to be considered as dependent variables. For example, by replacing the subscript i of Equations 17 with the subscript j, to designate correspondence with both dependent and independent variables in the sum, the tailored weight factor can be alternately written as:

$${W}_{{G}_{dk}} = \sqrt{{\frac{{𝒱}_{{G}_{d}}}{{ℛ}_{{G}_{d}}^{2}} [ \frac{- 1}{{𝒱}_{d}} {( \frac{\partial {𝒳}_{d}}{\partial {𝒢}_{d}} )}^{2} + {\sum }_{j = 1}^{N} \frac{1}{{𝒱}_{j}} {( \frac{\partial {𝒳}_{j}}{\partial {𝒢}_{d}} )}^{2} ]}_{𝒫 k}} \qquad ( 18 )$$

wherein the dependent component is subtracted from the sum. The subscript d is included to designate a specific variable as the dependent variable. The respective path designator, [symbol] and mapped observation sample, G_{d}, need to be rendered accordingly.

With regard to consideration #3, to accommodate path-oriented projections, in accordance with the preferred embodiment of the present invention, one has to re-think the maximum likelihood estimator and establish likelihood as related to the deviation of possible fitting function representations from the observation samples, not as the deviation of the observation samples from unknown expected or true values along the function. With this alternate view of the deviation, in accordance with the preferred embodiment of the present invention, a representation of the respective mapping or path descriptor can be made by successive approximations, and for a deviation variability of type 2, the Gaussian distribution of Equation 1 may be replaced and more appropriately expressed by Equation 19:

$$D ( \frac{{W}_{𝒢} {{ℛ}_{𝒢}^{2} ( 𝒢 - G )}^{2}}{2 {𝒱}_{𝒢}} ) = \frac{1}{\sqrt{2 π {M}_{𝒢}}} {e}^{- \frac{{W}_{𝒢} {{ℛ}_{𝒢}^{2} ( 𝒢 - G )}^{2}}{2 {𝒱}_{𝒢} {M}_{𝒢}}} . \qquad ( 19 )$$

Notice that the subscripts have been switch from what they were in Equation 15, indicating that the deviation variability of the projections, as considered in Equation 19, is related to the independent variable sampling. The respective likelihood estimator can take the considered form of Equation 20,

$${L}_{𝒢} = {\prod }_{k = 1}^{K} \frac{1}{\sqrt{2 π {M}_{𝒢}}} {e}^{- \frac{{W}_{{𝒢}_{k}} {{ℛ}_{{𝒢}_{k}}^{2} ( 𝒢 - G )}_{k}^{2}}{2 {𝒱}_{{𝒢}_{k}} {M}_{𝒢}}} . \qquad ( 20 )$$

In accordance with the present invention, for path-oriented projections with deviation variability type 2, the tailored weight factors, W_{G}_{ₖ}, may be defined as the square root of the sum of the squares of the partial derivatives of each of the independent variables as normalized on square roots of respective local variabilities, or as alternately rendered as locally representative of non-skewed homogeneous error distributions, said partial derivatives being taken with respect to the locally represented path designator [symbol] multiplied by a local skew ratio, [symbol] and normalized on the square root of the respectively considered type 2 deviation variability, [symbol] .

$$\begin{matrix}{W}_{{𝒢}_{k}} = \sqrt{{\sum }_{i = 1}^{N - 1} {( \frac{\partial {𝒳}_{i} / \sqrt{{𝒱}_{i}}}{\partial {ℛ}_{𝒢} 𝒢 / \sqrt{{𝒱}_{𝒢}}} )}_{𝒫 k}^{2}} \\ = \sqrt{\frac{{𝒱}_{{𝒢}_{k}}}{{ℛ}_{{𝒢}_{k}}^{2}} {\sum }_{i = 1}^{N - 1} \frac{1}{{𝒱}_{ik}} {( \frac{\partial {𝒳}_{i}}{\partial 𝒢} )}_{𝒫 k}^{2}} .\end{matrix} \qquad ( 21 )$$

In accordance with the present invention, the respective form for a type 2 essential weight factor (i.e., an essential weight factor rendered to include type 2 deviation variability) may be represented as by Equations 22.

$${𝒲}_{{𝒢}_{dk}} = \frac{{ℛ}_{{𝒢}_{d}}}{\sqrt{{𝒱}_{{𝒢}_{d}}}} \sqrt{{[ \frac{- 1}{{𝒱}_{d}} {( \frac{\partial {𝒳}_{d}}{\partial {𝒢}_{d}} )}^{2} + {\sum }_{j = 1}^{N} \frac{1}{{𝒱}_{j}} {( \frac{\partial {𝒳}_{j}}{\partial {𝒢}_{d}} )}^{2} ]}_{𝒫 k}} . \qquad ( 22 )$$

Referring back to both considerations #2 and #3, with regard to the tailoring of weight factors, in accordance with the present invention, respectively rendered deviations may be considered in general forms expressed by Equations 23 for path coincident deviations,

δ_{G}_{ₖ}≈Gₖ− [symbol] or [symbol] −Gₖ, (23)

or expressed by Equations 24 for path-oriented projections,

δ_{G}_{ₖ}= [symbol] −Gₖ or Gₖ− [symbol] . (24)

The mapped observation samples, Gₖ, as included in Equations 24, may be represented, as the quotient of the dependent variable sample divided by the skew ratio, as a function of both the dependent variable, X_{dk}, and independent variable data samples, Xᵢₖ or Xⱼₖ, as well as the respectively determined dependent variable measure, [symbol] or [symbol] , e.g.:

Gₖ [symbol] Gₖ( [symbol] X₁ₖ, . . . , X_{d}_{ₖ}, . . . , X_{N,k}), (25)

wherein

[symbol]

= [symbol] (X₁ₖ, . . . , Kᵢ_{ₖ}, . . . , X_{N-1,k}). (26)

In accordance with the present invention there may be one or more independent variables. For a two-dimensional system the value of N in Equations 25 and 26 would be two, providing for one dependent variable and only one independent variable (which could may or may not be represented by an inverse function.) Increasing the number of considered dimensions, as designated by the value of N, will increase the specified number of independent variables. For considering coupled variable pairs as might be associated with rendering forms of bivariate coupling, including forms of hierarchical regressions, Equations 25 and 26 may include more than two variables with variables not of said coupled variable pairs being represented as constant when included in the sum of squares of respectively weighted reduction deviations. And, for transcendental functions the dependent variable, [symbol] can certainly be included as a function of itself.

In accordance with the present invention, there are at least four differences between the path coincident deviations rendered by Equations 23 and the path-oriented projections as expressed by Equations 24. These are:
1. Because of opposite orientation, i.e. from the fitting function (or path extention)to the data-point v.s. from the data-point to the fitting function, or a designated extension point, the sign of the deviations is not the same. The path coincident deviations represent an estimate of the deviations of the data from an unknown true or expected function location, while the projections represent the deviation of an optimized function related location from the data. In accordance with the present invention, the directed displacement and associated sign convention, as in Equations 23 and 24, may be reversed and alternately included in correspondence with considered convention without affect upon the magnitude or square of the resulting deviations, provided that in considering certain forms of weighted deviations, the same convention is maintained throughout the generating of the associated weight factors.
2. The dependent variable cannot be evaluated as a function of unknown true or expected independent variables, hence for errors-in-variables applications, the path coincident deviations being evaluated with respect to sampled data can only represent an approximation, while, in accordance with the present invention, the precision of the evaluations of mappings in correspondence with the path of respective projections are limited only by analytical representation and computational accuracy to a locus of points which can be considered to satisfy restraints of the likelihood estimator.
3. The variability of path coincident deviations is determined in correspondence with the considered variability in the deviations of the dependent variable measurements, while the variability of the respective projections will correspond to that of representing the path definition and should be generated as a function of the variability in the deviations of the independent variables. And,
4. By including the type 1 dependent component deviation variability rendering essential weight factors, the maximum likelihood estimator for the path coincident deviation representations is more likely to converge quickly to a single value, independent of original fitting parameter estimates, but since the dependent variable cannot be evaluated as a function of unknown true or expected independent variables, the results, at least for sparse data, may or may not be statistically representative of an appropriate fit.

In accordance with the present invention, for path coincident deviations, said type 1 deviation variability, [symbol] , should be rendered to include an estimate for a non-skewed variability corresponding to a respective representation for a dependent variable sample measurement. For projections, type 2 deviation variability, [symbol] should be included as an estimate of the dispersion in a determined value for a representation of a dependent variable with said representation for a dependent variable assumed to be characterized by a non-skewed uncertainty distribution and with said dispersion excluding the direct addition of the variability in said non-skewed representation of the dependent variable.

A check on the mean and deviation of the type 2 variability from the assumed value for the type 1 variability might provide at least some feel for the accuracy of the estimate. The respective projection estimator should provide for more statistically accurate convergence, but due to the fact that the dependent component variability is not included, the respective estimates may not be uniquely defined. Instead, they will be confined to a locus of possible fits. In accordance with the ₚresent invention, the best way of deducing a respective best estimate might be by establishing a search criteria, and searching over said locus for a best fit.

Unique, and in accordance with the present invention, a best search criteria might include searching for a fit for which the sums of the squares of determined reduction deviations being rendered as path coincident deviations, but being weighted in correspondence with the type 2 variability, represent minimum values, and/or for which, said sum of squares of determined reduction deviations as so weighted, can be most nearly rendered as a replacement for the same being weighted in correspondence with type 1 variability. Other criteria that might be alternately considered might include searching for minimum or maximum values for alternate sums, sums of alternately rendered squared deviations, or even sums of products and products of sums of deviations.

For completely general application, in accordance with the present invention, the calligraphic [symbol] may alternately represent any path designator which is considered typical of a residual, characteristic deviation, or projection, which is assumed, considered, mapped, transformed, or normalized to be represented by a homogeneous non-skewed error distribution or which is assumed, considered, mapped, transformed, or normalized to be represented by a homogeneous non-skewed error distribution when normalized on the square root of a respective dependent coordinate deviation variability, [symbol] and/or when multiplied by a considered skew ratio, [symbol] .

In accordance with the present invention, the implementing of the analytic code of Equations 17, 18, or 21, in the formulating of tailored weight factors, and the implementing of essential weight factors type 2 as exemplified by Equations 22 or essential weight factors type 1, as may be alternately rendered, provide novel weighting of reduction deviations, which may be subject to orthogonal variable uncertainties and/or constraints, including novel weighting of normal deviations and normal data-point projections and novel weighting for alternately defined deviation paths being associated with errors-in-variables processing.

Now consider systems with more than two degrees of freedom. Even though multidimensional error deviations being restricted to a single coordinate might be approximated by an effective variance, actual error deviations are not so restricted, and mathematics is not equipped to describe line path deviations relative to more than two dimensions by a single equation. Hence, without exact representation of origin, likelihood of displacement of a single event can only be rendered in correspondence with one degree of freedom or less. Under very limited circumstances, path coincident deviations might perhaps satisfy such a requirement, but the origin or true value would remain completely unknown, and the likelihood of representing an origin value even close to the true mean value would diminish greatly with the number of undetermined fitting parameters, and each additional degree of freedom. Projections, including data-point projections, on the other hand, seem to require at least some form of two-dimensional representation. To alleviate the dilemma, at least to some degree, in accordance with the present invention, any one or combinations of four alternate approaches might be considered. These are:
1. Bicoupled variable measurements can be considered in hierarchical order, and for many applications, respective bivariate regressions can be rendered independently.
2. By rendering function definitions consistent with the order in which data is taken, essential weight factors can be rendered to combine a limited number of squared bivariate reduction deviations in rendering a multivariate sum for the simultaneous evaluating of respective coordinate related fitting parameter estimates.
3. Rendering data inversions in correspondence with two-dimensional segments over which the data samples that are included in each respective segment have been selected from an ensemble of observation samples in a manner to establish assumed constant values over the segment for all respective samples of the remaining independent variables which comprise the segment (Ref. U.S. Pat. No. 7,383,128.) And,
4. By implementing coordinate rotations, the effective variance as well as any related path-oriented deviations can be rendered to represent respective two-dimensional orientations being considered for multidimensional systems. Such a rotation would require combining all independent variable component contributions into a single representation as the square root of the sum of the squares of those respective contributions.

By restricting the deviation variability to values to a type 1 variability, corresponding to dependent component data sample measurements, conversion, if there is any, will be trained to a unique solution which will be based upon the supposition, and circular definition, that the answer you will find will be the true value you need in order to find the statistically represented value you are looking for. This supposition is invalid unless data completely matches the requirements of the statistical model employed, which is not often the case.

In stead, by assuming a type 2 deviation variability to be a function of the answer you are looking for and employing essential weight factors, in accordance with the present invention, you may only be able to establish a locus of solutions, all of which should satisfy the statistical requirements characteristic of the data, but which most often will not include the unique solution which would be established by restricting the deviation variability to values corresponding to the dependent component of the data sample measurements. Unique statistically accurate inversions, being considered for nonlinear applications, cannot generally be isolated by typical maximum likelihood estimators. Accurate results may require discriminating a “best fit” over a locus statistically sound data inversions.

In accordance with the present invention, there are at least two alternate methods that can be implemented to generate loci of data inversions which may satisfy statistical requirements. These are:
1. generating a plurality of successive data inversions, and
2. solving for only one fitting parameter in correspondence with a plurality of specified values for any remaining fitting parameters being restricted to plurality of points along a line or contained within a grid work of respective points. Each involves establishing a criteria in order to search for a “best fit” . Each not only involves a consideration of variations in all fitting parameters, but also variations in assuming an inherent bias that will undoubtedly associated with each degree of freedom that is represented by the ensemble of data samples.

One method, suggested in accordance with the present invention, that may provide reasonably accurate results over a sufficiently dense line or grid work involves searching for minimum values for negative products comprising sums of positive deviations multiplied by sums of negative deviations. This method includes searching for maximum of absolute values for products comprising sums of positive deviations multiplied by sums of negative deviations, or alternately, searching for maximum values for products comprising sums of positive deviations multiplied by the absolute value of sums of negative deviations, which in accordance with the present invention are substantially the same.

A second method to be considered for conducting such a search in accordance with the present invtion involves Comparing respective type 1 and type 2 essential weight factors or, because the only difference between the two types of essential weight factors lies in the representation of the dependent component variabilities, at least comparing associated dependent component variabilities in some form. If a unique statistically valid solution is to be rendered, it should at least approximate a condition whereby the type 2 variability as representative of independent variable measurements and associated fitting function should be consistent with the type 1 or dependent component variability.

### Comparison with Prior Art

The term “errors-in-variables” has been coined by many to refer to observations which reflect errors in both dependent and independent variable sampling. In 1966, York suggested an approach wherein uncertainties in variable measurements might be based upon the “experimenter's estimates” (Ref. Derek York, “Least-Squares Fitting of a Straight Line,” Canadian Journal of Physics, 44, pp. 1079-1086, 1966.) He attempted to allow (or at least imply allowance) for the heterogeneous representation of individual sample weighting when, as he put it: “errors in the coordinates vary from point to point with no necessarily fixed relation to each other.” York proposed what he refers to as “an exact treatment of the problem”. Unfortunately, he along with others that followed has not considered the effects of transverse translation of nonlinearities and heterogeneous probability densities on respective probabilities of observation occurrence being imposed during least-squares or maximum likelihood optimizing. What York actually came up with was a model for multivariate errors-in-variables line regression analysis as restricted to the assumptions of non-skewed, statistically independent, homogeneous distributions of measurement error. Considering the limit of the York model as the errors in the measurement of the independent variables approach zero would yield the same form as Equations 6 of the present disclosure, with the mean squared deviations being allowed to vary independently, which in accordance with the present invention, will only establish maximum likelihood as restricted to the explicit form of Equation 3.

Within the space of a year and a half after the publication of “Least-squares Fitting of a Straight Line” by York, Clutton-Brock published his work on “Likelihood Distributions for Estimating Functions when Both Variables are Subject to Error” (Ref. Technometrics 9, No. 2, pp. 261-269 1967.) By assuming small errors in the measurement of the system variable, herein represented as [symbol] , and implementing a residual deviation to include normalization on the square root of effective variance, Clutton-Brock attempted to characterized a general first order approximation, providing a nonlinear model for errors-in-variables maximum likelihood estimating. The model of Clutton-Brock, as applied to line regression analysis, is completely consistent with the York line regression. For assumed statistically independent homogeneous sampling and at least proportionate representation of uncertainty, both the York and alternate least-squares renditions in which residual deviations are defined as normalized on square root of effective variance should provide generally adequate line regression analysis.

Equation 27 provides a typical multidimensional approximation of “effective variance,” u_{d}, which can be considered compatible with the two-dimensional models considered by both York and Clutton-Brock:

$${υ}_{d} = {\sum }_{v = 1}^{N} {[ {σ}_{v} \frac{\partial {𝒳}_{d}}{\partial {𝒳}_{v}} ]}_{P}^{2} . \qquad ( 27 )$$

The [symbol] represents variables corresponding to each of the considered degrees of freedom. The subscript v designates the respective variable. The [symbol] represents the currently considered dependent variable, and the subscript d designates which variable is so considered. The σᵥ represents the standard deviation corresponding to the measurement of the respective variable degree of freedom. The subscript P indicates evaluation with respect to the undetermined fitting parameters and thus incorporates the effective variance as here defined to be included in the minimizing process.

A classic geometric derivation of line regression analysis is presented in a 1989 publication by Neri, Saitta, and Chiofalo (ref. “An accurate and straightforward approach to line regression analysis of error-affected experimental data” Journal of Physics E: Scientific Instruments. 22, pp. 215-217, 1989.) In this derivation, the effective variance is presented, not as a weight factor, which would necessarily be held constant during maximizing or minimizing operations, but as a form of geometric conversion factor which repositions and redefines the vectors which correspond to normalized residual deviations to reflect a mean orientation related to the distribution of errors in the respective variables.

Considering the above mentioned work of Neri, Saitta, and Chiofalo, along with their several predecessors, it might be suggested that dividing a residual by the square root of effective variance will geometrically transform the residual to correspond to a mean orientation between the line and the respective data point, thereby becoming an inherent part of a representative single component reduction deviation, comprising a representation for the vector sum of both dependent and independent sample deviations. As such, and thus considered in accordance with the present invention, the “effective variance” should not be categorized as a weight factor, but rather an integral part of a transformed single component deviation. Therefore, and in agreement with the works of York and Clutton-Brock, the “effective variance” so used must be considered variant during minimizing or maximizing operations. With exception of the methods of inversion and approach in derivation, the model described by Neri, Saitta, and Chiofalo is not significantly different from the line regression model which is described in the work of York.

Consider a typical effective variance type approximation for two-dimensional normal component reduction deviations, δ_{E}_{_{d}}, as related to multidimensional slope-constant (or linear) fitting function applications by Equations 28,

$${δ}_{{E}_{d}} \approx \frac{{X}_{d} - {𝒳}_{d}}{\sqrt{{\sum }_{v = 1}^{N} {( {σ}_{v} \frac{\partial {𝒳}_{d}}{\partial {𝒳}_{v}} )}^{2}}} , \qquad ( 28 )$$

with a sum of squared deviations normalized on effective variance being oriented for two-dimensional deviations and mapped onto the dependent coordinate axis without including essential weighting for errors-in-variables maximum likelihood estimating, by Equation 29,

$${ξ}_{{E}_{d}} \approx {\sum }_{k = 1}^{K} {( \frac{{X}_{d} - {𝒳}_{d}}{\sqrt{{\sum }_{v = 1}^{N} {( {σ}_{v} \frac{\partial {𝒳}_{d}}{\partial {𝒳}_{v}} )}^{2}}} )}_{{P}_{k}}^{2} . \qquad ( 29 )$$

The sans serif subscript, E, suggests normalization on effective variance; the sans serif X_{d} represents sample measurements for the dependent variable being designated by the subscript d; and the calligraphic [symbol] represents the system dependent variable being evaluated as a function of respective independent variable sample measurements. The [symbol] subscript designates a specific data sample. (Note that, in accordance with the present invention, the terminology “slope-constant” is herein applied to regressions in which the dependent variable is a linear function of respective independent variables. Note also that, in accordance with the present invention, the terminology “slope-constant regression analysis” and “multivariate slope-constant regression analysis” is herein considered to include bivariate line regression analysis.) The approximation sign is included in Equations 28 and 29 due to the limitation of being unable to express path coincident deviations in direct correspondence with expected values for errors-in-variables applications.

Note that as the errors in the sampling of independent variables approach zero, the form of the inversion, as provided by Equations 28 and 29, will be the same as that provided by Equations 3 through 6 and thus must satisfy the restraints of the maximum likelihood estimator, which is expressed by Equation 3 and which does not necessarily guarantee representation for nonlinear or heterogeneous data sampling.

In accordance with the present invention, a reduction deviation comprises a path designator and a respectively mapped observation sample. The path designator represents the dependent portion of the reduction deviation as a normalized dependent function of at least one independent variable. The mapped observation sample represents the considered dependent variable which is similarly normalized. For an example, unit-less variable related effective variance type path designators, E, can be rendered as the function portion of the reduction deviations of Equation 28, as in Equation 30,

$${E}_{d} = \frac{{𝒳}_{d}}{\sqrt{{\sum }_{v = 1}^{N} {𝒱}_{v} \frac{\partial {𝒳}_{d}^{2}}{\partial {𝒳}_{v}}}} . \qquad ( 30 )$$

and corresponding representation for the respectively mapped dependent observation sample is provided by Equation 31:

$${E}_{d} = \frac{{X}_{d}}{\sqrt{{\sum }_{v = 1}^{N} {𝒱}_{v} \frac{\partial {𝒳}_{d}^{2}}{\partial {𝒳}_{v}}}} . \qquad ( 31 )$$

The dependent component deviation variabilities, type 1 and type 2, [symbol] and [symbol] may be approximated in correspondence with Equations 32 and 33 respectively:

$$\begin{matrix}{𝒱}_{{E}_{dk}} = {𝒱}_{dk} , \\ and & ( 32 ) \\ {𝒱}_{{E}_{dk}} = \frac{1}{{\sum }_{v = 1}^{N} {𝒱}_{v} \frac{\partial {𝒳}_{d}^{2}}{\partial {𝒳}_{v}}} . & ( 33 )\end{matrix}$$

Assuming the deviations of dependent variable samples, X_{dk}, as individually considered to be characterized by non-skewed uncertainty distributions, said distributions being proportionately represented by a corresponding datum variability, [symbol] the non-skewed form for the dependent variable sample deviation would be equal to the deviation, X_{dk}− [symbol] . A skew ratio for the respective deviations would be expressed as the ratio of the non-skewed dependent variable sample deviations to the assumed normal component reduction deviations:

$$\begin{matrix}{ℛ}_{{E}_{d} k} = {( \frac{{X}_{d} - {𝒳}_{d}}{{δ}_{{E}_{d}}} )}_{𝒫 k} \\ = {( \frac{{X}_{d} - {𝒳}_{d}}{\frac{{X}_{d} - {𝒳}_{d}}{\sqrt{{\sum }_{v = 1}^{N} {𝒱}_{v} \frac{\partial {𝒳}_{d}^{2}}{\partial {𝒳}_{v}}}}} )}_{𝒫 k} \\ = {( \sqrt{{\sum }_{v = 1}^{N} {𝒱}_{v} \frac{\partial {𝒳}_{d}^{2}}{\partial {𝒳}_{v}}} )}_{𝒫 k} .\end{matrix} \qquad ( 34 )$$

In accordance with the present invention, the skew ratios and, as necessary, variabilities are evaluated in correspondence with successive estimates for the fitted parameters, [symbol] being held constant during successive optimization steps of the maximum likelihood estimating process.

In accordance with the present invention, a normal deviation may be defined as a displacement normal to the fitting function, as expressed in coordinates normalized on the considered sample variability. The normal deviation, so defined, may perhaps be rendered to correspond to the shortest distance between a data point and the fitting function. It should be noted, however, that in regions of curvature, there may be more than one normal to the fitting function that will pass through a respective data point.

Traditionally, maximum likelihood estimating, as well as statistics on the whole, has been based upon the concept of deviations of data from true or expected values. It is often assumed that normalization of squared deviations on effective variance may be sufficient. Such is not necessarily the case. Even though arbitrary sums of non-skewed error distributions can be statistically considered to be represented by Gaussian distributions, and even though the uncertainty in all of the included sample measurements may be considered to be represented by non-skewed error distributions due to the fact that, for a nonlinear function, a deviation normalized on effective variance does not represent an actual displacement between the true or expected value and the respective sample data point, it may require additional normalization, and alternate expressions or approximations may certainly be considered.

In accordance with the present invention, a possibly more valid but apparently unexplored concept is based upon the deviations of candidate fitting functions from sample measurements rather than deviations of measurements from a best fit. Both may be defined to represent equivalent displacement magnitude whether considered positive or negative. When squared and included to represent a sum of squared deviations, without respective weighting, they will be the same. The difference lies in representing the variability of the dependent component error deviations. The variability of assumed path coincident or considered residual deviations will correspond directly to a variability in the measurement of the sampled data point, which is dependent upon the accuracy of observation sampling and recording. In accordance with the present invention, the variability of a projection or a dependent coordinate mapping of the same can alternately be considered to exclude the variability in the measurement of the dependent variable. This exclusion will establish undetermined, but statistically valid, data inversions from which to consider the selection of a preferred fitting function.

In accordance with the present invention the definition of path-oriented displacements and respective projections can be broadened to include mappings of projections along normal lines to the considered fitting function, or transverse paths between data points and lines normal to said fitting function, or any analytically described deviation paths which might be characteristic of the geometry associated with displacement of data points from said fitting function, said projections not necessarily emanating from or passing through said data points.

In accordance with the present invention, minimizing an appropriately weighted component of a geometrical configuration which may be assumed similar to that associated with an error deviation constitutes minimizing the error deviation.

In accordance with the present invention, essential weighting of path-oriented displacements can be implemented to establish weighting of squared path coincident deviations and/or respective projections for applications which involve linear, or nonlinear, and/or heterogeneous sampling of data, thus providing means for the normalization and weighting of normal, transverse, or alternate displacements.

In addition, in accordance with the present invention, by combining alternately considered dependent variable representations of projections and/or path coincident displacements, additional restraints can be imposed to provide for improved solution set screening and/or the improved evaluation of biased offsets.

U.S. Pat. No. 7,383,128 suggests use of a composite weight factor comprising the product of a coefficient and a “fundamental weight factor,” said fundamental weight factor being rendered without consideration of any form of skew ratio. The fundamental weight factor is based upon likelihood of a multidimensional residual error deviation from the true or expected location, assuming said likelihood to be related to the N^{th} root of an associated N dimensional deviation space. The concept may be valid as considered for a limited number of application, but generally, in light of the fact that said true or expected location is indeterminate, it must be recognized as unreliable or spurious. Similarly spurious composite weight factor, Cw, may be rendered, in accordance with the present invention by replacing said fundamental weight factor by an alternate weight factor, w, rendered to include representation of a skew ratio. (Ref. U.S. Pat. No. 7,383,128.)

In accordance with the present invention spurious weight factors may be defined, for path coincident deviations, as the inverse of the N^{th} root of the square of the product of partial derivatives of the locally represented path designator [symbol] multiplied by a local skew ratio, [symbol] and normalized on the square root of the respectively considered deviation variability, [symbol] , said partial derivatives being taken with respect to each of the independent variables as normalized on square roots of respective local variabilities, or as alternately rendered as locally representative of non-skewed homogeneous error distributions:

$$\begin{matrix}{W}_{{G}_{k}} = {\vert {\prod }_{i = 1}^{N - 1} \frac{\partial {ℛ}_{G} 𝒢 / \sqrt{{𝒱}_{G}}}{\partial {𝒳}_{i} / \sqrt{{𝒱}_{i}}} \vert}_{{𝒫}_{k}}^{- \frac{2}{N}} \\ = {\vert {\prod }_{i = 1}^{N - 1} \frac{{ℛ}_{{G}_{k}} \sqrt{{𝒱}_{ik}}}{\sqrt{{𝒱}_{{G}_{k}}}} {( \frac{\partial 𝒢}{\partial {𝒳}_{i}} )}_{k} \vert}_{𝒫}^{- \frac{2}{N}} .\end{matrix} \qquad ( 35 )$$

And, in accordance with the present invention, spurious weight factors, [symbol] may be defined, for path-oriented data-point projections with deviation variability type 2, as the inverse of the N^{th} root of the square of the product of partial derivatives of the locally represented path designator [symbol] multiplied by a local skew ratio, [symbol] and normalized on the square root of the respectively considered dependent component deviation variability, [symbol] , and taken with respect to each of the independent variables as normalized on square roots of respective local variabilities, or as alternately rendered as locally representative of non-skewed homogeneous error distributions.

$$\begin{matrix}{W}_{{𝒢}_{k}} = {\vert {\prod }_{i = 1}^{N - 1} \frac{\partial {ℛ}_{𝒢} 𝒢 / \sqrt{{𝒱}_{𝒢}}}{\partial {𝒳}_{i} / \sqrt{{𝒱}_{i}}} \vert}_{{𝒫}_{k}}^{- \frac{2}{N}} \\ = {\vert {\prod }_{i = 1}^{N - 1} \frac{{ℛ}_{{𝒢}_{k}} \sqrt{{𝒱}_{ik}}}{\sqrt{{𝒱}_{{𝒢}_{k}}}} {( \frac{\partial 𝒢}{\partial {𝒳}_{i}} )}_{k} \vert}_{𝒫}^{- \frac{2}{N}} .\end{matrix} \qquad ( 36 )$$

Equations 35, as representative of weighting for deviations related to an estimated true or expected value, must be recognized as only an approximation for errors-in-variables application. On the other hand, Equations 36 become invalid unless there are errors in more than a single variable. One might note that in the real world, whether it be in the sampling of data or the manipulating of data, there is no such thing as error-free data, hence for all practical purposes, even when the errors seem to be insignificant, all coordinate samples should be able to be represented as error affected.

The products which are included in Equations 35 and 36 and in similar representations of U.S. Pat. Nos. 5,619,432; 5,652,713; 5,884,245; and 7,107,048 might be consistent with representing likelihood of multi-coordinate deviation displacement from explicit expected values by a root value of slope related deviation space, but said products are not consistent with the likelihood associated with assumed path-oriented data-point projections, as rendered in accordance with the present invention. Both concepts must be considered as spurious, except as limited to two degrees of freedom.

Although Equation 35 and 36, along with other similar space related representations, may provide appropriate solutions for a number of applications, there seem to be two basic concerns:
1. Speaking generally, in accordance with the preferred embodiment of the present invention, path related deviations for systems of more than two dimensions should be considered as independently related to each of the independent orthogonal coordinates. For example, consider the intersection of a line with a two-dimensional surface in a three-dimensional coordinate system comprising coordinates (x, y, z) with an intersection at the origin point (xₒ, yₒ, zₒ) designated by the subscript o, where z is a function of x and y. The equations for the normal line to the surface would be:

$$\frac{x - {x}_{o}}{{( \frac{\partial z}{\partial x} )}_{o}} = \frac{y - {y}_{o}}{{( \frac{\partial z}{\partial x} )}_{o}} = \frac{z - {z}_{o}}{- 1} . \qquad ( 37 )$$

In accordance with the present invention, attempts to represent a deviation path for more than two dimensions without at least considering a two-dimensional orientation may be overly optimistic and, consequently, invalid for other than linear applications. To compensate for this anomaly, at least for multivariate applications, a form of sequential or hierarchical regressions may be employed which will limit regressions to two dimensions; however for certain applications, coordinate related sampling may be independent, and hence, for such an application, no unique bivariate hierarchical order can be represented.
2. As the number of parameters and associated degrees of freedom increase, the likelihood of rendering a proper solution set decreases. For many applications, implementation of a form of hierarchical regressions may be both feasible and consistent with the current state of the art. Assuming there is an order in which coordinate related sample measurements are taken, a sequence of bicoupled regressions may be established, being based upon a concept of antecedent measurement dispersions, where the dependent variable of the first regression and each subsequent regression is a function of only one independent variable, and where the independent variable of each subsequent regression is the dependent variable that was or will be determined by the preceding regression, with the dispersion accommodating variability being tracked from regression to regression. Implementing a technique of sequential or hierarchical regressions with essential weighting, as rendered in accordance with the present invention for alternate deviation paths, may improve performance of the present invention by reducing both the number of degrees of freedom being simultaneously evaluated and the number of associated fitting parameters corresponding to each level of evaluation.

In accordance with the present invention, by implementing essential weighting of bicoupled component related paths, alternately formulated estimators can be established for both bivariate and multivariate hierarchical level applications. In the U.S. Pat. No. 7,383,128, provision is considered for handling unquantifiable dependent variable representations and representing multivariate observations as related to two-dimensional segment inversions. In that U.S. Patent, a form of inversion conforming data sets processing is suggested for the considered data inversions. In accordance with the present invention, inversions associated with essential weighting of path related deviations may more likely provide results.

Note that Equations 35 and 36 are not only different from Equations 17 and 21 in concept of design, but without including representation for a skew ratio other than unity, they would not even provide equivalent results when considered for two-dimensional applications. Both the concepts of essential weighting and the concept of including representation of a skew ratio as part of said weighting were originally described in renderings of the U.S. Pat. No. 7,383,128.

concepts and items of this disclosure which are introduced by and in accordance with the present invention in order to transform observation sampling measurements to an accessible and usable form in order facilitate representation and prediction of characteristic behavior include:
1. Generating a locus of data inversions over an expanse of fitting parameter values while solving for only one fitting parameter by utilizing an inversion method involving essential weighting of squared reduction deviations and a memory comprising an applications program for generating said locus of data inversions in correspondence with said inversion method and implementing said essential weighting, said memory being rendered for access by a control system operating on a data processing system.
2. Conducting a search over a locus of data inversions to establish a preferred inversion by comparing type 1 and type 2 dependent component variabilities and a memory comprising an applications program for implementing said search over said locus of data inversions, said memory being rendered for access by a control system operating on a data processing system.
3. Conducting a search over a locus of data inversions comparing products of sums of positive deviations multiplied times sums of negative deviations and a memory comprising an applications program for implementing said search over said locus of data inversions, said memory being rendered for access by a control system operating on a data processing system.
4. An automated data processing system comprising a memory, a control system, and means for activating said control system for rendering said data processing in accordance with the present invention, said memory comprising an applications program for executing said rendering. And,
5. Expanding said automated data processing for implementing two-dimensional segment inversions with consider means for the handling of unquantifiable dependent variable representations in correspondence with likelihood of occurrence.

concepts which are rendered in part with the present invention which were originally described in renderings of the Pending U.S. patent application Ser. No. 11/802,533 to facilitate representation and prediction of characteristic behavior include:
1. The introduction of the concept of skewed reduction deviations being geometrically related to dependent component deviations, and the implementing of skew ratios in the rendering of weight factors compensating for said skew ratios by said skew ratios being held constant during said rendering.
2. a memory comprising an applications program for implementing said skew ratios in the rendering of said weight factors, said memory being rendered for access by a control system operating on a data processing system.
3. The rendering of weight factor generators to provide representation for weight factors to be implemented in rendering the weighting of squared reduction deviations.
4. The implementation of essential weight factors as provided to compensate for nonlinearities of independent components as particularly related to compensating for measurement variability as well as skew in respective path designators, said essential weight factors being included in and held constant during the process of optimizing respective sums of weighted squared reduction deviations and a memory comprising an applications program for generating and implementing said essential weight factors, said memory being rendered for access by a control system operating on a data processing system.
5. The rendering of common regressions to represent the summing of squared reduction deviations with weighting to compensate for the simultaneous including of alternate variables being represented as respective dependent variables and a memory comprising an applications program for implementing and rendering said common regressions, said memory being rendered for access by a control system operating on a data processing system.
6. Implementing a search over a locus of successive data inversions for at least one preferred approximating form and a memory comprising an applications program for implementing and rendering said said search, said memory being rendered for access by a control system operating on a data processing system. And,
7. An automated data processing system comprising a memory, a control system, and means for activating said control system for rendering said data processing in accordance with the present invention, said memory comprising an applications program for executing said rendering.

### SUMMARY OF THE INVENTION

In view of the foregoing, it is an object of the present invention to generate loci of likely data inversions of combined sums of weighted function and inverse function reduction deviations and to provide method and automated means for abstracting statistically accurate function related information from said loci and, thereby, transform errors-in-variables observation sampling measurements to viable means for predicting associated behavior.

It is an object of the present invention to establish essential weighting in the formulating of the sums of squared reduction deviations, said sums being transformed by an applications program effected by a control system to a contained parametric form, thereby providing representation for display and prediction of characteristic behavior, containment for said parametric form being a memory, a single computer or network of computers, a machine with memory, or an item of tangible composition which can be implemented, interpreted, or acted upon to modify, quantify, establish prediction of, or render response or recognizable form for said characteristic behavior, particularly in correspondence with non-uniform or sparsely represented observation sampling measurements as well as statistically representative data samples.

It is an object of the present invention to provide a control system or substantial means for rendering a computer as a control system for generating a locus of data inversions over an expanse of fitting parameter values while solving for only one fitting parameter at a time by utilizing an inversion method involving essential weighting of squared reduction deviations and to provide a memory comprising an applications program for generating said locus of data inversions in correspondence with said inversion method and implementing said essential weighting, said memory being rendered for access by a control system operating as part of an automated data processing system.

It is an object of the present invention to provide a control system, or means for rendering a computer as a control system, for conducting a search over a locus of data inversions to establish a preferred inversion by comparing alternate forms for representing weight factors or dependent component variabilities or forms for representing comparisons of sums comprising representations of weight factors or dependent component variabilities, and to provide a memory comprising an applications program for implementing said search over said locus of data inversions, said memory being rendered for access by a control system operating as part of automated data processing system.

It is an object of the present invention to establish a criteria for representing corresopondence between two alternate types of dependent component variability and implementing a search over a locus of data inversions for indication of a data inversion along said locus, for which said two alternate types of dependent component variability might be considered as equivalent or at least compatible.

It is an object of the present invention to provide a control system, or means for rendering a computer as a control system, for conducting a search over a locus of data inversions which might include comparing products of sums of positive deviations multiplied times sums of negative deviations, and to provide a memory comprising an applications program for implementing said search over said locus of data inversions, said memory being rendered for access by a control system operating as part of an automated data processing system.

It is an object of the present invention to provide a control system, or means for rendering a computer as a control system, for generating a locus of successive data inversions and implementing a search over said locus for at least one preferred approximating form, and to provide a memory comprising an applcations program for implementing and rendering said search, said memory being rendered for access by a control system operating on an automated data processing system.

It is an object of the present invention to establish, render, and provide means for representing path-oriented deviations in the form of skewed reduction deviations being geometrically related to dependent component deviations and being mapped onto a dependent coordinate axis as considered functions of at least one independent variable, and to provide a memory with accessible representation for a plurality of observation sampling measurements and respective analytic form, to be acted upon by said control system for rendering respective data inversions.

It is an object of the present invention to provide means to implement representations of skew ratios in the rendering of weight factors in order to compensate for skew in related reduction deviations and to provide a memory comprising an applications program for rendering and implementing said weight factors, said memory being rendered for access by a control system operating as part of an automated data processing system, said skew ratios being held constant during the rendering of said weight factors, said weight factors including direct proportion of respective said skew ratios, divided by the square root of respective type dependent component deviation variability.

It is an object of the present invention to provide weight factor generators or at least one weight factor generator and/or alternate means to generate and provide essential weight factors for implementing weighting of squared deviations, as represented by normal or alternate path mappings, being considered for representation of either or both path coincident deviations and/or path-oriented data-point projections.

It is an object of the present invention to provide automated forms of data processing and corresponding processes which will include weighting by essential weight factors, being substantially representative of the product of tailored weight factors and the square of respective normalization coefficients, and being held constant during optimizing manipulations, said normalization coefficients comprising skew ratios divided by the square root of a specified type of respective dependent component deviation variability, said essential weight factors substantially being rendered to include direct proportion of said skew ratio divided by the square root of respective type dependent component deviation variability by holding said normalization coefficients constant during the formulation of said tailored weight factors.

It is an object of the present invention to provide optional weighting of mapped dependent sample coordinates in correspondence with each considered sample and each pertinent, or alternately considered, degree of freedom.

It is an object of the present invention to provide option for rendering dispersion in determined measure as a function of the variabilities of orthogonal measurement sampling uncertainty to establish respective representation for at least one form of essential weighting of squared path-oriented data-point projection mappings.

It is an object of the present invention to provide alternate means for the handling of otherwise unquantifiable dependent variable representations in correspondence with likelihood of occurrence by rendering data inversions to include essential weighting of squared reduction deviations.

It is a further object of the present invention to render an automated data processing system comprising a memory, a control system, and means for activating said control system for rendering said data processing in accordance with the present invention, said memory comprising an applications program for executing said rendering.

It is also an object of the present invention to generate reduction products as processing system output to represent or reflect corresponding data inversions and to provide means for producing data representations which establish descriptive correspondence of determined parametric form in order to establish values, implement means of control, or characterize descriptive correspondence by generated parameters and product output in forms including memory, registers, media, machine with memory, printing, and/or graphical representations.

The foregoing objects and other objects, advantages, and features of this invention will be more fully understood by reference to the following detailed description of the invention when considered in conjunction with the accompanying graphics, drawings, and command code listings.

### BRIEF DESCRIPTION OF THE GRAPHICS, DRAWINGS AND COMMAND CODE LISTINGS

In order that the present invention may be clearly understood, it will now be described, by way of example, with reference by number to the accompanying drawings and command code listings, wherein like numbers indicate the same or similar components as configured for a corresponding application and wherein:

FIG. 1 illustrates an example of extracting a preferred analytical fit by a search over loci of successive inversions of simulated sparse errors-in-variables data for a best fit to the exponential function Y=AX^{E} in accordance with the present invention.

FIG. 2 presents a rendition of the sparse errors-in-variables simulation of data which was used in accordance with the present invention to generate the loci represented in FIG. 1.

FIG. 3 presents a rendition of sparse errors-in-variables simulation of three-dimensional data which has been rendered to consider the feasibility of searching for qualifying representations a locus of successive data inversions in accordance with the present invention.

FIG. 4 depicts an example of a data processing system being rendered to include components for generating and searching over inversion loci in accordance with the present invention.

FIG. 5 depicts an example of two-dimensional path-oriented data-point projections and associated dependent coordinate mappings in accordance with the present invention.

FIG. 6 depicts an exemplary flow diagram which might be considered in rendering forms of path-oriented deviation processing in accordance with the present invention

FIG. 7 presents a view of a monitor display depicting provisions to establish reduction setup options in accordance with the present invention.

FIG. 8 illustrates part 1 of a QBASIC path designating subroutine, being implemented for generating dependent coordinate mappings of considered deviation paths in accordance with the present invention.

FIG. 9 illustrates part 2 of a QBASIC path designating subroutine, being implemented for generating path function derivatives with respect to fitting parameters in accordance with the present invention.

FIG. 10 illustrates part 3 of a QBASIC path designating subroutine, being implemented for generating path function derivatives with respect to independent variables in accordance with the present invention.

FIG. 11 illustrates part 4 of a QBASIC path designating subroutine, being implemented for generating weight factors in accordance with the present invention.

FIG. 12 illustrates exemplary QBASIC command code for establishing projection intersections in accordance with the present invention.

FIG. 13 illustrates exemplary QBASIC command code for establishing projection intersections with improved accuracy in accordance with the present invention.

FIG. 14 illustrates a simulation of ideally symmetrical three-dimensional data, with reflected random deviations being rendered with respect to a considered fitting function for comparison of inversions being rendered in accordance with the present invention.

FIG. 15 provides an example of adaptive path-oriented deviation processing being implemented to include generating and searching over loci of successive data inversion estimates with a feasibility of encountering a preferred description of system behavior, in accordance with the present

### A DETAILED DESCRIPTION OF THE INVENTION

There exists a well-known discrepancy in the representing of maximum likelihood by means which establish minimum values as related to deviations of data from an unknown point on an unknown function. This discrepancy is due to the fact that maximum likelihood must be based upon deviations from a true value, and a true value for the origin of such a deviation cannot be determined with respect to the unknown function. In accordance with the present invention, an alternate approach would be to consider a valid form of likelihood estimating, by establishing optimum values related to deviations of fitting function estimates from the known locations of the considered data samples. The tradeoff is that, by implementing this alternate approach, there is an entire locus of fitting functions which can be rendered to satisfy the demands of likelihood without specifying a unique function for which the required likelihood might be considered to be a maximum.

In accordance with the present invention, neither approach, as considered alone, can be deemed as sufficient, but search can be made for maximum likelihood corresponding to the sum of the weighted squares of path coincident reduction deviation from fitting functions being defined over said locus. Therefore, the major objective of the present invention is to generate loci of likely data inversions estimates from combined sums of weighted function and inverse function reduction deviations and to provide method and automated means for abstracting statistically accurate function related information from said loci, thereby transforming errors-in-variables observation sampling measurements to viable and substantial means for predicting associated behavior.

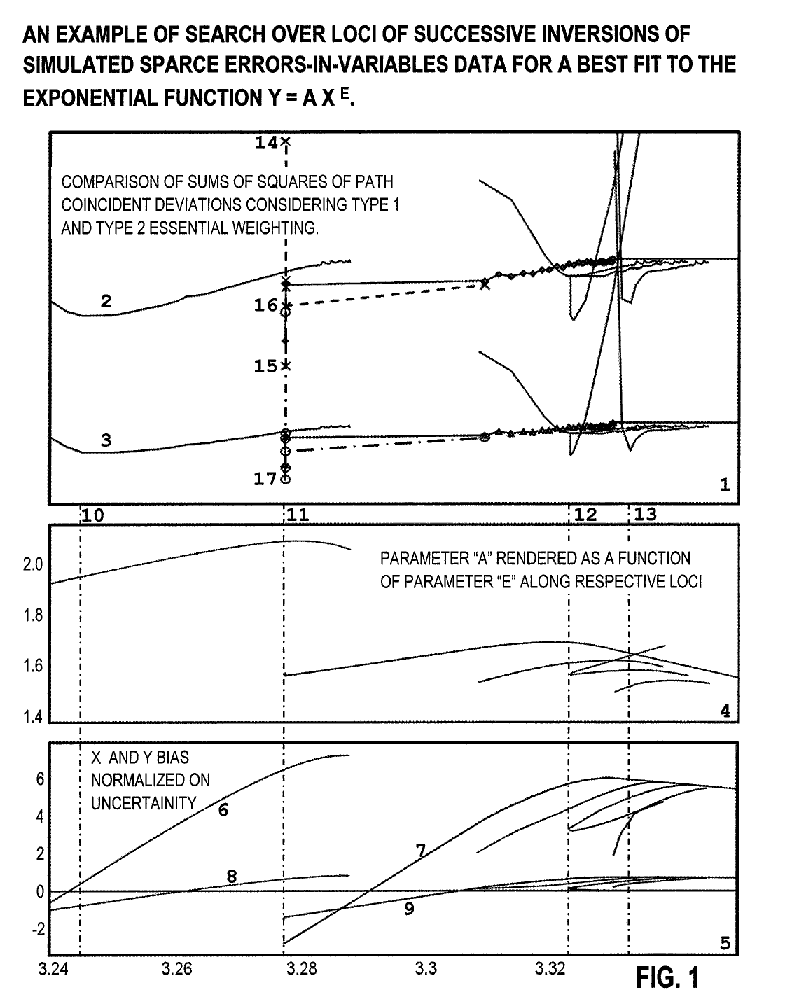

Referring now to FIG. 1: This figure illustrates an example of extracting a preferred analytical fit by a search over loci of successive inversions of simulated sparse errors-invariables data for a best fit to the exponential function Y=AX^{E}. The data was generated by implementing the QBASIC command code file, Locus.txt which is included in Appendix A (or in the compact disk appendix File folder entitled Appendix A). The figure includes three sets of figures. These are:
1. A comparison of sums of squares of path coincident deviations as determined along each respective loci, 1, with loci rendered in correspondence with type 1 essential weight factors, 2, being grouped in the lower portion, and with loci rendered in correspondence with type 2 essential weight factors, 3, being grouped above;
2. A graphical representation of the exponential term coefficient, A, being rendered as a function of the exponent, E, in correspondence with the successive inversions along each of said loci, 4;
3. A representation of the bias, 5, with the loci corresponding to bias in the independent variables, 6 and 7, being shown above those corresponding to bias in the dependent variable below , 8 and 9.

In accordance with the present invention, assuming an appropriate representation of initial parameters, statistically valid data inversion loci may be rendered by implementing a form of calculus of variation to establish said loci in correspondence with the sum of squared path-oriented data-point projections being weighted with essential weighting type 2. Although it may not be possible to establish path coincident deviations relative to unknown expected values, it is quite justifiable to render them in correspondence with pre-determined values corresponding to said loci of data inversions, and it is also justifiable to assume that they can be considered to be a minimum at the point on the locus that corresponds to said expected value, provided that the weighting of type 1 and type 2 essential weighting will yield the same result. The dotted vertical lines, 10, 11, 12, and 13, extending down from the uppermost figure through the figures below discriminate points where the fitting parameters and associated X and Y coordinate measurement bias correspond to minimum values for the sum of the weighted squares of path coincident deviations along the respective loci. Note that minimum values occur for both types of essential weighting at each of these locations, but that, at the second location from the left, corresponding to the dotted line 11, there are some unique features.

The sum of squared deviations with type 2 weighting dropped from 109.26 at iteration 1, 14, to 91.13 at iteration 4, 15, and it took 24 iterations at the same value for E to recover to a value of 96.00 and move on to consecutive iterations. Notice a similar trend with the sum corresponding to type 1 weighting by dropping from 95.49 at iteration 1, 16, to values 81.96 and 81.95 at iterations 4 and 5, 17, recovering 23 iterations later; thereby indicating that a likely fit for this simulation might be expressed by the equation:

Y+25631.65≈1.577797(X+1.495149)¹²⁷⁷⁵⁴⁶. (38)

Equations that must be considered also as the possible fits corresponding to Lines 10, 12, and 13, can be respectively rendered as: 10,

Y+13700.9≈1.955601(X−0.258504)^{3.24529}; (39)

12,

Y−2660.137≈1.584183(X−1.754109)^{3.322958}; (40)

and 13,

Y−6982.918≈1.537118(X−1.973226)¹³³²⁵⁵³. (41)

Further examination of FIG. 1 along with the examples of Equations 38 through 41 indicate that both Equation 38 and Equation 40 are compatible with conditions for possible fits; however, Equation 38 includes a positive bias, while Equation 40 includes a negative bias, indicating that the actual best fit lies somewhere between the two, with a variation in the value of the exponent between 3.28 and 3.32. Further search might be made by generating alternate loci between the two lines, 11 and 12, until a single function can be distinguished as a best fit.

In addition to the bias associated with the data, consider that each of Equations 38 through 41 may also be affected by a reduction bias. A reduction bias may be defined as that bias which is associated solely to the processing techniques and may include discrepancies that might result from using only first order approximations, not accounting for point density or neglecting bias that might be associated with curvature. These discrepancies may be accounted for by implementing more sophisticated modeling; however, attempts have been made in accordance with the present invention to at least consider the following:
1. searching for sums of representations for deviations and squared deviations (See the related QBASIC code: SearchForAlternateDeviations.txt found in the compact disk appendix File entitled Appendix B.)
2. checking the significance of curvature as related to a respective component of bias (See the related QBASIC code: CheckEffectsOfCurvatureRelatedToBowInFunction.txt found in Appendix B.)
3. checking the affects of point density on likelihood (See the related QBASIC code: Check-AffectsOfPointDensity.txt found in said Appendix B.) and
4. searching for minimum deviations and squared deviations from true normal intercept from respective data (See the related QBASIC code: SearchForMinimumDeviationsFromTrueIn-tersept.txt. found in Appendix B.)
   These four files may require being given a shorter name with a .bas extension in order to be executed as QBASIC program files. They will also require the DATA folder from Appendix A to be transferred to the C:\ drive with the .txt extensions removed.

In accordance with the present invention none of these four QBASIC program files seem to render significant reduction in the effects due to bias, and hence, unless they prove to be important for some specific application may not be required in the processing of data. In considering the overall effects of reduction bias, the method referred to in U.S. Pat. No. 6,181,976 as “characteristic form iterations” might be adapted to compensate for higher order nonlinear distortions.

In accordance with the present invention, time will tell whether or not further innovations such as working with subsets of data or considering statistically represented extremes in bias can determine a best fit within the set of reasonably likely fits and related inversion loci that might be associated with a single set of data.

The six loci displayed in FIG. 1 are listed in the loci folder of Appendix A under the file names 10.txt, 11A.txt, 11B.txt, 12A.txt, 12B.txt, and 13.txt. Each of these files contains listings of the loci corresponding to the respective dotted line of FIG. 1, with the exception that there are two loci associated with each of lines 11 and 12. The locus entitled 11B.txt includes representation of intermediate iterations between the pertinent iterations listed in file 11A.txt. The loci corresponding to the line 12 are filed as 12A.txt and 12B.txt. Columns in the files are not labeled, but are as follows:
Column 1, a plus or minus sign, indicating whether the sum of squared reduction deviations with type 1 essential weighting is respectively increasing or decreasing;
Column 2, the iteration number count;
Column 3, the nomenclature ISF, indicating that the following number provides a rough estimate of the variation in significant figures between iterations;
Column 4, an indication of significant figure variation between iterations; (This parameter is used to note a tendency toward conversion. Adding one or two to its value will generally give an idea of variation in the parameter with the least agreement between iterations. The Locus.txt command iteration will be terminated if the value of this parameter does not increase after approximately 15 iterations. This is not necessarily a valid criteria in searching for start or continuation of an inversion locus. This iteration count may need to be reset by pressing r during execution, or if need be, the maximum count can be changed within the code.)
Column 5, the parameter A in the equation Y=AX^{E};
Column 6, the parameter E in the same equation;
Column 7, the bias that is to be subtracted from the dependent variable;
Column 8, the bias that is to be subtracted from the independent variable;
Column 9, the sum of squares of the path coincident reduction deviations weighted by type 2 essential weight factors;
Column 10, the sum of squares of the path coincident reduction deviations weighted by type 1 essential weight factors;

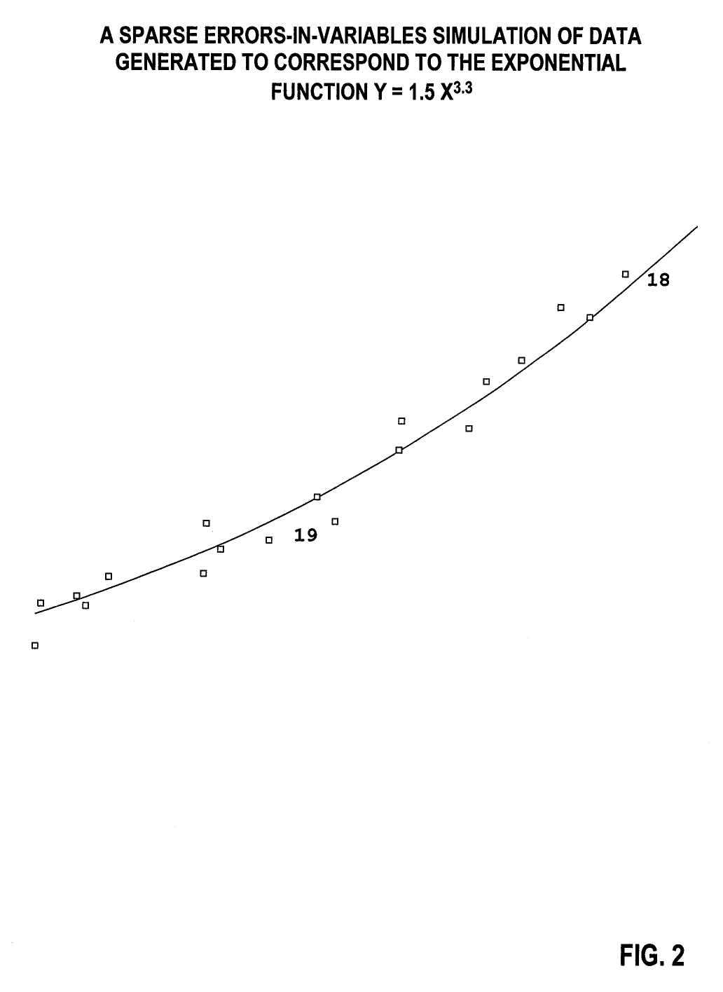

Referring now to FIG. 2: This figure illustrates the example of the sparse errors-invariables simulation of data which was used to generate the loci which was presented in FIG. 1. Still referring to FIG. 2, these data were generated to correspond to the exponential function, Y=AX^{E}. Values 1.5 and 3.3 were used respectively as the coefficient, A, and the exponent, E, to generate a base function of Y=1.5X^{3.3}, which is represented by the solid line, 18, in the figure. Simulated measurement error deviations in the presumed measurements of X and Y, as represented by the square symbols, □, 19, were rendered by means of a random number generator and combined with the function to represent error affected data as shown in the figure. The data were processed utilizing various methods in correspondence with the Locus.txt processing code of Appendix A, as rendered in QBASIC for activation of an automated control system. The results determined by neglecting bias, and utilizing miscellaneous methods were as follows:
1. For linearized least squares without weighting:
A=0.972333756696479, E=3.415783926875221;
2. For linearized least squares with composite weighting as described in U.S. Pat. No. 7,383,128: A=0.9698334251849314, E=3.416462480479572;
3. Effective variance method: A=0.9837736245298065, E=3.4128455279595;
4. Utilizing methods described in U.S. Pat. Nos. 5,619,432, 6,181,976, and 7383128, considering errors in the dependent variable only: A=1.136145356910593, E=3.374849202950343;
5. Utilizing methods described in U.S. Pat. Nos. 5,619,432, 6,181,976, and 7,383,128, considering errors in the independent variable only: A=0.5266369981025205, E=3.579248949686232.

None of these methods directly provide for the evaluation of an associated bias, and in accordance with the present invention, at least when considering the representation of sparse data, and as can be seen by comparing the above results to the base equation, Y=1.5x^{3.3}, or to the results presented by Equations 38 through 41, the bias can have a profound affect on the answer.

In accordance with the present invention there are at least three ways to establish representation for a bias in correspondence with a point along the locus. These include:
1. rendering successive inversions while solving for bias in variable measurements and while holding combinations of the fitting parameters constant.
2. implementing an effective variance method to approximate bias corresponding to the remaining fitting parameters; and
3. providing for successive estimates by averaging or interpolating between prior ones. In accordance with the present inventions, any one of several methods may be utilized or combined to generate initial estimates which will be compatible with the generating of an inversion locus for two-dimensional applications.

### Example 1

Consider the following steps for utilizing the exemplary QBASIC code of Appendix A as means of rendering initial parameters and generating at least a start condition for rendering a respective locus of likely data inversions:
1. Render a processing system for operations of DOS QBASIC.
2. Install the DOS operation code and either load the code directly from the QBASIC system, or change the name Locus.txt to Locus.bas so as to render the extension compatible with a QBASIC system manager. (The code may not be compatible with newer systems.)
3. Remove the .txt extensions and transfer the simulation data, from the data folder of Appendix A to a C: drive.
4. Execute the Locus.txt or Locus.bas operational code by pressing F5 followed by an “Enter”
5. Select file E. by pressing “E” followed by “.” (Omit the quotation marks.)
6. Select option “7” to simulate data.
7. Press “1” to simulate data for variable X 1.
8. Press “1” to select simulation of random error deviation in variable X1.
9. Press “2” to specify the desired uncertainty reference.
10. Press “1” followed by “Enter” to specify homogeneous uncertainty.
11. Press “Enter” two times to continue.
12. Press “2” to simulate data for variable X2, and repeat steps 8 through 11 to simulate random homogeneous uncertainty in X2.
13. Press “Enter” to view the reference uncertainty for variable X1.
14. Press “Enter” to view the reference uncertainty for variable X2.
15. Press “1” to initiate rendition (or preliminary rendition) of initial estimates.
16. Press “4” to generate initial estimates. (Note that the method used here by option 4 to generate initial estimates requires prior initial estimates to provide weighting. For this example, linearized regression is first employed to establish preliminary estimates without weighting. Press “c” to continue without including weighting. Press “Enter” to include composite weighting and continue one step at a time. Press “d” to render approximately thirty successive iterations. Also note that the method used here to generate the initial estimates is not generally valid for other than single exponential terms, such as Y=AX^{E}.)
17. Press “d” to include weighting and render approximately thirty successive iterations.
18. Press “c” to continue. (At this point, assuming an appropriate initial estimate has been rendered, a choice can be made as to what process might be used. The preferred selection in accordance with the present invention is provided by pressing zero, “0”. This selection configures the operating system to generate a locus and search that locus for a preferred inversion. Various results can be considered in correspondence with the requirements of the data.)
19. Press “0” to select the preferred reduction. (Unfortunately the search will be limited to values of A that are less than 0.9698334251849314 and values of E greater than 3.416462480479572 corresponding to the values determined by the initial estimates and by neglecting the affects of bias.)
20. Press “Enter” to continue.
21. Press “f 3” “Enter” “f” “4” Enter” to specify that X1 and Y1 offsets are to be held constant during the inversion processing.
22. To continue from here, you could press “Enter”, and the results would be the same as those listed under item 6 of the miscellaneous methods mentioned previously. To obtain somewhat more realistic results, it is necessary to go back and to modify the initial estimates and to include additional estimates for representing the variable offsets and/or associated bias.
   Press “x” to return to the selection menu.
23. The extreme cases can be represented when the errors are considered to be associated with either the dependent or independent variable only.
   Press “*” to compute alternate estimates for non-offset parameters for errors in the dependent variable only.
24. Note the display, and see that the offset values are presumed to have already been determined, then:
   Press “Enter” to continue. If not then repeat step 21.
25. When a safety stop appears press F5 to view.
26. Press “Enter” to continue.
27. Press “y” to store the results as modified initial estimates.
28. Press “8” to use the effective variance method to estimate approximate offsets.
29. Press “f′ “1” “Enter” “f” “2” “Enter” “f” “3” “Enter” “f” “4” “Enter” to set the mode for evaluating just the offset values.
30. Press “Enter” to render the respective inversion.
31. Press F5 when the safety stop reappears.
32. Press “Enter” to continue.
33. Press “y” to store the results as initial estimates for offsets.
34. Press “*” to compute non-offset parameters.
35. Press “f” “1” “Enter” “f” “2” “Enter” “f” “3” “Enter” “f” “4” “Enter” to set the mode for evaluating just the non-offset values.
36. Press “Enter” to render the respective inversion.
37. Press F5 when the safety stop reappears.
38. Press “Enter” to continue.
39. Press “y” to store the results as initial estimates for offsets.
40. Repeat the steps 28 through 39 to establish the following as initial estimates: A=1.858812117254613, E=3.245150690336042, Offset in X1=−19267.3051912505, Offset in X2=−0.6748213854764781. (Note that the reference uncertainty for X1 is set at 20943, and for X1 is set for 0.60648. These values correspond reasonably well with these initial estimates for offsets, thus creating an extreme starting point for the considered initial estimates. With these estimates in place, a locus of inversions can be rendered over the range that includes the data as represented.)

In accordance with the present invention, Steps 28 through 39 can be repeated as needed to render suitable initial estimates, and if necessary, the asterisk, “*”, in steps 23 and 34 may be replaced by a pound sign, “#”, to render initial estimates which should correspond more closely to a more likely bias of an opposite sign or signs.
41. Press zero, “0”, to execute the generating of statistically representative successive data inversions and search over those inversions for inversions which might represent a minimum value for the sum of squares of weighted path conforming reduction deviations.
42. Insure that the Parameters “A” and “B” are to be evaluated, and press “Enter” to continue.
43. The Inversion Loci Generating Data Processor will then generate a plurality of successive data inversions along the prescribed locus. The resultant estimates are represented in memory and implemented to generate representations for sums of weighted and squared reduction deviations. Said sums are compared along said locus to hopefully encounter minimum (or associated extreme) values corresponding to a best fit. Two sums that appear to be most significant are the sums of squares of path coincident reduction deviations weighted with essential weight factors type 1 and type 2, being designated within the QBASIC code as SUMDELF and SUMDELQ, respectively. When a minimum value for SUMDELQ is encountered, the system will pause with a statement that “A SMALLEST VALUE FOR SUMDELQ# HAS BEEN ENCOUNTERED. PRINT PRESS <C> TO, OR ANY OTHER KEY TO [C]ONTINUE.” You will notice that a minimum for SUMDELF occurred just after iteration 117 and that a minimum for SUMDELQ occurred before iteration 141. In accordance with the preferred embodiment of the present invention, these two minimum values should occur between the same iterations. To return to generating the same locus, press any key; however, if the two minimum values do not occur between the same two iterations, the search for appropriate offsets should be continued.
44. Press “c” to continue to search for more accurate offsets.
45. You are now in a safety stop mode. Press “F5” to continue execution.
46. The following numbers should appear on the monitor:
   A=1.635642153599988, E=3.278835091010047, with offsets −19267.3051912505 and −0.6748213854764781.
   Press “Enter” to continue.
47. Press “y” to store the current parameters as initial estimates for the next phase and return to the selection menu of the “reduction choice selector”.
48. Re-compute the offsets by pressing the “8” and repeating steps 29 through 39.
   The new estimates for respective offsets are rendered as −19465.40020498729 and −0.6801883800774177.
   Press “y” to store the results as initial estimates for offsets.
49. Repeat steps 41 to 48 to generate the next approximation for parameters A and E, i.e.,

### A=1.621950782882215 and E=3.281113317346064.

Note that minimums for SUMDEEV and SUMDELQ both occur between iterations 9 and 13, indicating an approximation for the fitting parameters.
50. Repeat steps 47, 48, and 49 to continue iterations for a next approximation as needed.
   The next iteration for this particular example will yield:
   A between 1.608386971890781 and 1.60701391924904, and E between 3.28338854916288 and 3.28357496324708, with constrained (not statistically represented) bias offsets of −19133.79211040316 and −0.6652141417755281, which demonstrate that the offsets required for data to actually fit the simulation function will most likely fall within one standard deviation of the uncertainty, as considered for both the dependent and the independent variables. Such a large bias is not unlikely to be associated with sparsely represented data.

In accordance with the present invention, the method exemplified by the above steps 1 through 50 is not limited to a specific form for the fitting function or the associated data, whether it be real or simulated.

In accordance with the present invention, steps 3 through 12 provide for the simulation of data and are not required for the reduction of pre-existing data.

In accordance with the present invention, portions or essence or alternate renditions characterizing similar form or substance, as rendered by the above 50 steps or as might be provided or modified to establish similar data reduction processing of similar or alternately rendered or acquired data, along with any additional steps or alternate renditions which might provide additional capabilities for full or more adequate automation of the associated processing method, can be rendered in substantially represented form by means of a data processing system comprising a computer and control system, or a computerized control system, with memory for storing data for access by an application program being executed on said processing system, said application program being stored in said memory, said control system comprising means for accessing, processing, and representing information; and said control system comprising means for activating said application program, said memory being affected by means for transfer and/or storage of similar or alternately rendered or acquired data, and said memory comprising means for handling intermediate representation and storage of initial estimates, successive approximations, weight factors, inversions, and inversion loci, being generated, retrieved, and implemented in rendering and distinguishing a characteristic fit to the considered data.

### End of Example 1:

Referring back to FIG. 1 with reference to Appendix A, the following steps were used in rendering the initial parameters used in generating the inversion locus associated with the minimum points 15 and 17.

### Example 2

1. Initiate execution by pressing “F5” “Enter”.
2. Select data file E.
3. Press “71121” “Enter” “Enter” “2121” “Enter” “Enter” to generate a respective form of simulated data.
4. Press “Enter” “Enter” “Enter” to view respective uncertainty and restore the selection menu.
5. Press “151” “Enter” to enter a locus start point for the independent variable.
6. Enter the preferred start point for X. The number that was entered for this example, was 1.62 estimated from step 49 of Example 1.
7. Press “Enter” “2” to enter a locus start point for the dependent variable.
8. Enter the preferred start point for Y. The number that was entered for this example, was 3.28, from the same source.
9. Press “Enter” “3” to enter an estimate of the dependent coordinate bias. The number that was entered for this example was -29619, which is minus the uncertainty in the simulated measurements of Y multiplied by the square root of 2. The minus sign was gleaned from the sign attached to the bias of Example 1.
10. Press “Enter” “4” to enter an estimate of the independent coordinate bias. The number that was entered for this example, was −0.8579298, which is minus the uncertainty in simulated measurements of X multiplied by the square root of 2. The minus sign was again gleaned from the sign attached to the bias of Example 1.
11. Press “Enter” “Enter” after the values have been entered to exit the parameter input mode.
12. Press zero, “0”, to generate the respective locus.
13. Press “Enter” “Enter” to generate the data File 11A.txt or press “A” “Enter” to generate the data file 11B.txt. The loci will be rendered as a data representation and stored in the file “C:\DATA\”+RTIME$+“_”+FUNREF$+“txt”, where the numeric form, RTIME&, is established immediately after pressing F5 at the beginning of the routine. The number RTIME&=2589 was used to set the random number generator for both Example 1 and Example 2. For this exemplary QBASIC code, this storage is only temporary. Only the last one stored will remain. It can however, be transferred to alternate storage to be acted upon by an applications program either to render display as might be similar to or exemplified by FIG. 1, or to substantiate further action. End of Example 2

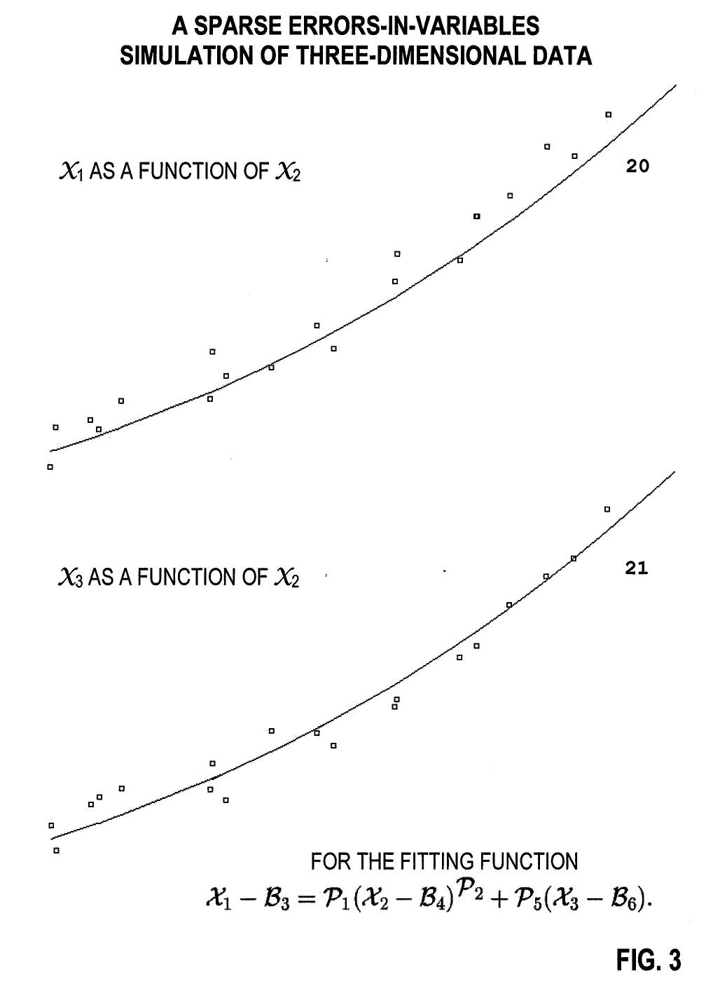

Referring now to FIG. 3, In accordance with the present invention, the concept herein described for rendering a search over a locus of successive data inversions for two-dimensional data may also be applied to data of multi dimensions. FIG. 3 depicts a simulation of sparse three-dimensional data of the form; X₁−B₃=P₁(X₂−B₄)^{P2}+P₅(X₃−B₆), which was used in generating a three-dimensional locus of successive data inversions, the essence of which is included in the file 3D.txt of the loci folder of Appendix A.

This small excerpt rendered in the file 3D.txt of the loci folder demonstrates the feasibility of implementing a search over inversion loci for more than two dimensions. (Note that the first eight columns of the file generated for this three-dimensional example are the same as were described for those of two dimensions, but for the three dimensions, Column 9 will contain a parameter associated with a second independent variable, and Column 10 represents the bias that is to be subtracted from said second independent variable. Columns 11 and 12 of the three-dimensional file contain the respectively weighted, type 2 and type 1, sums of squared reduction deviations.)

The steps rendered in generating said 3D.txt file are described in the following example.

### Example 3

Consider the following steps for utilizing the exemplary QBASIC code of Appendix A as means of rendering initial parameters and generating the locus of successive data inversions provided in file 3D.txt:
1. Render a processing system for operations of DOS QBASIC.
2. Install the DOS operation code and either load the code directly from the QBASIC system or change the name Locus.txt to Locus.bas so as to render the extension compatible with a QBASIC system manager.
3. Transfer the data simulation file, from the data folder of Appendix A to a C: drive.
4. Execute the Locus.txt or Locus.bas operational code by pressing F5 followed by an “Enter”.
5. Select file 3D. by pressing “3D” followed by “.”.
6. Press “Enter” “71121” “Enter” “Enter” to select random data for variable X₁.
7. Press “2121” “Enter” “Enter” to establish random data also for variable X₂.
8. Press “3121” “Enter” “Enter” to also establish random data for variable X₂.
9. Press “Enter” “Enter” “Enter” to display respective variable measurement uncertainties.
10. Press “Enter” “14DD” “Enter” “Enter” “Enter” to establish preliminary initial estimates.
11. Press “151” “Enter” then the number 1.62 from Example 2 as a value for A.
12. Press “Enter” “2” “Enter” then the number 3.28 from Example 2 as a value for E.
13. Press “Enter” “3” “Enter” then number -29619 from Example 2 as a value for the bias correction of the dependent variable, X₁.
14. Press “Enter” “4” “Enter” then number −0.8579298 from Example 2 as a value for the bias correction of the independent variable, X₂. Leave the initial value for the independent variable X₂ as rendered by step 10 above; and for this set of initial estimates we will assume zero for the bias in X₂.
15. For this example, press “Enter” “15” “Enter” and enter 100 to increase the number of acceptable iterations between an increase in significant figures. 16. Press “Enter” “Enter” “Enter” to restore the option selection menu.
17. Press zero, “0”, “Enter” “Enter” to initiate the processing.
18. The system will pause after each encounter of a minimum value for SUMDELQ#. Press “C” to move on to the termination phase, or “Enter” to continue iterating. (Press enter each time, to represent the results that are contained in the file. Pres “C” to continue iterating along the locus.)
19. When a safety stop appears press F5 to view.
20. Press “Enter” to continue.
21. Another safety stop will appear. Press F5 to view.
22. Press “Enter” “Enter” “Enter”.
23. The graph you view will correspond to the last increase in significant figures prior to exit. it will not correspond to the best fit, unless stop was made by pressing “C” at the appropriate point. Press “E” to end. The locus will be stored in the RTIME$ designated 3D.txt data file under DATA file on the C: drive.
   Note that qualifying inversions occurred between iterations 29 and 43, and also between iterations 68 and 74, rendering approximate estimate for P₁ between 1.32 and 1.16, approximate estimate for P₂ between 3.32 and 3.35, and approximate estimate for P₅ between 0.0716 and 0.0804. Actual values for the parameters being used in the base function to generate the simulation were; P−1=1.5, P−2=3.3,

P−5=0.0038. End of Example 3.

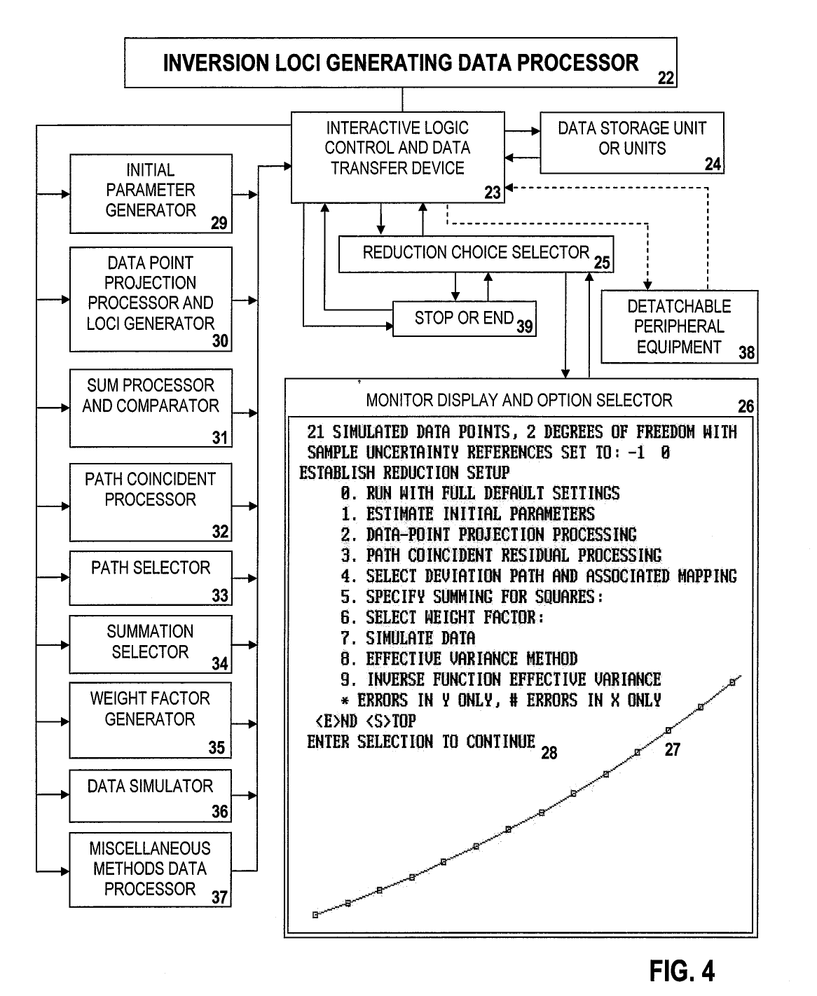

Referring now to FIG. 4, in accordance with the present invention, the Inversion Loci Generating Data Processor, 22 as depicted in FIG. 4, represents an example of a multipurpose data processing system comprising a control system with means for accessing, processing, and representing information, and, foremost, providing the capabilities of:
1. generating loci of data inversions which may be assumed to satisfy the demands of likelihood, and
2. conducting a search over said loci for inversions which establish feasible representation for sums of squares of weighted deviations of errors-in-variables data samples from a respective fitting function, and thereby rendering said fitting function as a suitable description of behavior pattern of said errors-in-variables data by means including:
1. the rendering and storing of representations for essential weight factors of two different forms;
2. the accessing and implementing of said essential weight factors;
3. the representing and implementing initial estimates;
4. the rendering of results and of intermediate results in substantial storage to be acted upon by respective application programmings.

Other capabilities of such a processing system, being rendered in accordance with the present invention, as here exemplified, may also include:
1. providing statistically accurate estimates'for fitting functions when errors are assumed to be limited to a single variable;
2. providing statistically accurate estimates for fitting functions when evaluations involve only single fitting parameters; and
3. rendering data inversions for the purpose of comparing alternate approaches.

In accordance with the present invention, three alternate methods may be employed for rendering said loci. These are:
1. rendering said loci along a converging series of successive inversion estimates,
2. rendering said loci along a non-converging series of successive inversion estimates, and
3. rendering a series of inversion evaluations over a pre-determined grid of possible fitting function values.

In accordance with the present invention, the QBASIC code, Locus.txt of Appendix A, has been prepared as a tool to evaluate concepts and methods related to the present invention, in order that the useful concepts might be incorporated into a more elaborate and user friendly system. It is here represented only as a example to demonstrate viable capabilities of the present invention. The example of an inversion loci generating data processor, 22, as rendered in FIG. 4 and as supported by the QBASIC operational code Locus.txt of Appendix A, includes representation of an interactive logic control and data transfer device, 23; data storage, 24; a reduction choice selector, 25; a monitor for display and option selection, 26; means for rendering graphical display, 27; a keyboard for rendering response to an option selection query, 28; an initial parameter generator, 29; a data-point projection processor, 30; a sum processor and comparator, 31; a path coincident data processor, 32; a path selector, 33; a summation selector, 34, and respective summation generator; a weight factor selector and respective weight factor generator, 35; a data simulator, 36; and a miscellaneous methods data processor, 37.

The data transfer device, under logic control, 23, retrieves data as it is represented from a source and transfers it to a data representation in memory, 24, where it can be acted upon by the interactive logic control and data transfer system, 23, and effective processing system as specified by current option selections. The data may be real or simulated. It may represent actual sampling measurements or be gleaned from some form of observations. In accordance with FIG. 4, representation of the data is passed to the monitor display and option selector, 26 rendering a graphical representation, 27, along with specifics that describe the data.

Once the data is made available for processing, the reduction choice selector, 25, provides for the selection of available options, 28. The order of option selection depends upon both the form of the data and the type of reduction to be rendered. Once the data is rendered in an appropriate form for the considered reduction, if iteration is to be implemented, characteristic initial estimates may be required.

The initial parameter generator, 29, in conjunction with the logic control and data transfer device, 23, provides for the input, or the generating and storing of representations of at least preliminary initial estimates for fitting parameters. More involved estimates may be modified or generated by additional input or processing and transferred to replace current representation for initial estimates. Stored estimates are rendered for access by the processing system along with successively updated estimates to establish necessary iterations during inversion processing. Selections for rendering initial estimates include:
1. inputting estimates,
2. retrieving estimates from a file,
3. generating estimates, and
4. in accordance with the present invention, rendering successive processing utilizing alternate techniques to extend the range of characteristic estimates to at least include data inversions which might encompass a preferred representation.
   This item 4 may not necessarily be explicitly included in part with the initial parameter generator, 29, but may be implemented in conjunction with optional data simulations and/or processing.

The data-point projection processor, 20, provides for the processing of path-oriented deviations in correspondence with type 2 deviation variability, being included in rendering tailored weight factors and/or respective essential weight factors, in accordance with the present invention.

The sum processor and comparator, 31, provides for the generating and storing of sums of squared path coincident deviations, alternately weighted with type 1 and type 2 essential weight factors in a comparative search for minimum values along a respective locus of successive inversion iterations, in accordance with the present invention, with the generating of said locus, or loci, being rendered by at least some form of path coincident deviation or data-point projection reduction processing being rendered in consideration of type 2 variability. (It is here noted that the sums can be either be generated and compared at the time the loci is generated, or the loci can be stored with access to the data for later investigations by an alternate applications program.)

The sum processor and comparator, 31, can also provide for the generating and comparison of sums of other forms of squared deviations, including forms related to the effective variance as might be considered along the respective loci in conjunction. The path coincident processor, 32, provides for the processing of path-oriented deviations in correspondence with type 1 deviation variability, being included in rendering a deviation normalization coefficient and/or respective essential weight factors in accordance with the present invention.

An optional path selector, 33, may provide for the selection of alternate path-oriented deviations and associated skew ratios.

The summation selector, 34, provides an option for summing over the various dependent and independent variables. According to the preferred embodiment of the present invention, for errors-in-variables, summing should be rendered over both dependent and independent variables and all combinations of the same. If errors are considered to affect only the dependent variable, then summations should be rendered only over deviations in the dependent variable. If errors are considered to affect only the independent variable, then summations should be rendered only over deviations in the independent variable. Selections should be made accordingly.

In accordance with the present invention, unless data is completely representative of a linear function, with non-skewed homogeneous errors in a single variable, weight factors are crucial in rendering a statistically accurate data inversion. In accordance with the present invention, two general types of weight factors should be considered. These are referred to as type 1 and type 2 essential weight factors. Type 1 can be used to represent the weighting of any data, whether errors are limited to one variable or included in several. Type 2 is more general, but requires that errors be accounted for in all variable. Type 1 assumes path coincident deviation being measured from known expected values to respective known data measurement points. Type 2 assumes data-point projections being measured from the known location of the data to known points being related to successive approximations of undetermined functions. In addition to these two types of weight factors, the selections made available by the weight factor generator, 35, as rendered for example in the Locus.txt code of Appendix A, also include degenerate and spurious forms of the same along with alternate normalizations, that might have at one time at least been considered for the weighting of squared deviations.

In accordance with the present invention, the data simulator, 36, may be implemented to serve at least two alternate functions:
1. It can be used to specify creation of data which can be processed to evaluate setup and reduction procedures corresponding to a specific type of fitting function; and
2. It can be used to select specific forms of known uncertainty to be added to base simulations of data and thereby provide for the processing of the resulting data by considered methods which will render characteristic initial estimates, which will allow passage from unstable convergence to stable convergence along a locus of successive, consecutive, and stable inversion estimates, extending said locus to encompass a preferred representation.

The miscellaneous methods data processor, 37, may be provided by allowing selection of various combinations of data reduction options, not only for the purpose of comparison, but to provide a variety of reduction techniques for rendering appropriate values for initial estimates. In addition to rendering errors-in-variables processing of reduction deviations, in accordance with the present invention, the option of including a miscellaneous methods data processor may hereby be considered in part with the present invention. Miscellaneous Processing options which may prove useful include linear regressions and transformations which convert nonlinear regressions to linear regressions, weighted linear and nonlinear regressions, and regressions which implement or adapt effective methods. In accordance with the present invention, the inversion loci generating data processor may be rendered to include provision for rendering any miscellaneous processing options. Referring to the monitor display and option selector, 26, selection 8 provides for effective variance processing; selection 9 provides for inverse function effective variance processing; selection * provides errors in Y only processing, and selection # provides for errors in X only data processing.

In addition to incorporate components, the inversion loci generating data processor includes means for rendering product in the form of a removable memory or a detachable peripheral, 38, being rendered in accordance with the present invention as containment comprising one or more loci or abstracted data representation being rendered for storage or transport as a library, or merely descriptive correspondence of a determined parametric composition being represented and stored, or rendered and stored for transport, in the form and embodiment of product output by said data processing system to provide for characterization of the behavior of sampled data as related to a plurality of observation sampling measurements.

Upon completion of the desired reduction, termination is provided by a selection to “stop or end” 39. The stop provides an interrupt without requiring steps to initiate for the next processing effort. The end provides termination.

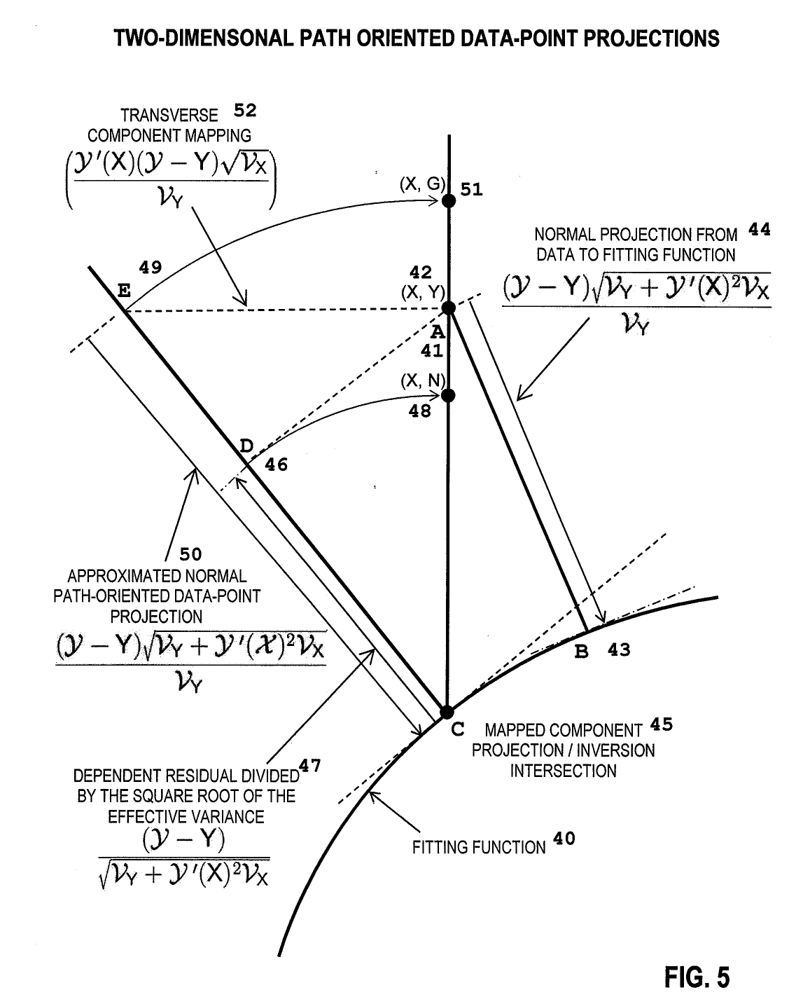

Referring now to FIG. 5 in accordance with the present invention, path-oriented data-point projections are rendered to represent various likely considered paths relating a sampled data point to respective function related locations. FIG. 5 illustrates a two-dimensional fitting function, 40, along with associated data at point A, 41, with coordinates (X, Y), 42. Point B, 43, represents the intersection of a normal data-point projection, 44, from the data at point A, 42, as projected precisely normal to the curve. Point C, 45, represents the mapped location of projected components onto a respective dependent variable coordinate. Point D, 46, establishes the relative placement of the path with respect to the fitting function for dependent residuals normalized on the square root of effective variance, 47, as a function of the independent variable sample. If we were to assume a linear fitting function, then the quadrilateral formed by the points A B C and D, would become a rectangle, and the coordinates (X, N), 48, would merge on to the coordinates (X, Y), 42, and the dependent variable being normalized on the square root of effective variance, 47, would become an true representation of the normal path, 44. Thus, the closer the data approaches linearity, the more accurate the effective variance method becomes. Point E, 49, establishes the relative placement of the mapped path origin with respect to the fitting function for approximated normal path-oriented data-point projections, 50, mapped to the coordinates (X, G), 51, as a function of the intersecting projection slope and independent variable observation samples. And in accordance with the present invention, the distance between the data-point coordinates (X, Y), 42, at A, 41, and the point E, 49, represents a transverse component mapping, 52, which is actually projected from the data sample to point E, 49, along a transverse coordinate, and which may also be represented in consideration of path-oriented deviations. In accordance with the present invention, paths may be alternately represented to characterize particularly unique restraints that might be associated with system observation sample displacements. And, in accordance with the present invention, by implementing essential and/or alternate composite weighting, unique deviation paths may be singularly represented or combined with alternate paths to establish an appropriate maximum likelihood estimator which will characterize considered observation sample data.

Still referring to FIG. 5, in accordance with the present invention, an expression for approximate normal path-oriented data-point projections [symbol] , 50, can be rendered for multivariate path deviations by Equations 42.

$${δ}_{{𝒩}_{d}} {𝒩}_{d} - {N}_{d} = \frac{( {𝒳}_{d} - {X}_{d} ) \sqrt{{\sum }_{v = 1}^{N} {𝒱}_{v} \frac{\partial {𝒳}_{d}^{2}}{\partial {𝒳}_{v}}}}{{𝒱}_{d}} . \qquad ( 42 )$$

In accordance with the present invention, Equations 42 may be alternately rendered in correspondence with the actual intercept of the normal projection, 44, with the fitting function, 40, by determining the coordinates of said actual interception. For example: The slope of the normal projection may be represented as minus the inverse of the derivative of [symbol] with respect to the independent variable, [symbol] . Rendering the line normal to the fitting function passing through the normalized data point (Xᵢₖ, Yₖ) will yield:

$${𝒴}_{⊥} = - \frac{{𝒳}_{i}}{{𝒴}^{′} ( {𝒳}_{i} )} \frac{{𝒱}_{Y}}{{𝒱}_{{X}_{i}}} + {Y}_{k} + \frac{{X}_{ik}}{{𝒴}^{′} ( {X}_{ik} )} \frac{{𝒱}_{{Y}_{k}}}{{𝒱}_{Xik}} . \qquad ( 43 )$$

Combining the equation for the normal line with the fitting function to establish the respective [symbol] and [symbol] coordinates corresponding to the intersection of the normal line with the fitting function will yield two equations to be solved simultaneously in correspondence with each data point:

$$\begin{matrix}{𝒴}_{k} - {Y}_{k} = - \frac{( {𝒳}_{ik} - {X}_{ik} )}{{𝒴}^{′} ( {𝒳}_{ik} )} \frac{{𝒱}_{{Y}_{k}}}{{𝒱}_{Xik}} , \\ and & ( 44 ) \\ \frac{{𝒳}_{ik} - {X}_{ik}}{{𝒱}_{Xik}} = - {𝒴}^{′} ( {𝒳}_{ik} ) \frac{𝒴 ( {𝒳}_{ik} ) - {Y}_{k}}{{𝒱}_{{Y}_{k}}} . & ( 45 )\end{matrix}$$

To establish respective form for essential weight factors in accordance with the present invention, unit-less variable related normal path designators, [symbol] can be rendered as the function portion of the respective projection, as considered in Equation 46:

$${𝒩}_{d} = \frac{{𝒳}_{d} \sqrt{{\sum }_{v = 1}^{N} {𝒱}_{v} \frac{\partial {𝒳}_{d}^{2}}{\partial {𝒳}_{v}}}}{{𝒱}_{d}} . \qquad ( 46 )$$

A corresponding representation for the respectively mapped observation sample is provided by Equation 47:

$${N}_{d} = \frac{{X}_{d} \sqrt{{\sum }_{v = 1}^{N} {𝒱}_{v} \frac{\partial {𝒳}_{d}^{2}}{\partial {𝒳}_{v}}}}{{𝒱}_{d}} . \qquad ( 47 )$$

The dependent component deviation variabilities, type 1 and type 2, [symbol] and [symbol] may be approximated in correspondence with Equations 48 and 49 respectively:

$$\begin{matrix}{𝒱}_{{N}_{dk}} = {𝒱}_{dk} , \\ and & ( 48 ) \\ {𝒱}_{{𝒢}_{d}} = {( - {𝒱}_{d} \frac{\partial {𝒳}_{d}^{2}}{\partial {𝒳}_{d}} + {\sum }_{l = 1}^{N} {𝒱}_{l} \frac{\partial {𝒳}_{d}^{2}}{\partial {𝒳}_{l}} )}_{𝒫 k} . & ( 49 )\end{matrix}$$

In accordance with the present invention, there are alternate expressions for generating representation for the dispersions or considered variability in representing a determined value for [symbol] as a function of orthogonal error affected observations (ref. U.S. Pat. No. 7,107,048.)

Assuming the deviations of dependent variable samples, X_{dk}− [symbol] as individually considered to be characterized by non-skewed uncertainty distributions, said distributions being proportionately represented by a corresponding datum variability, [symbol] a skew ratio for both path coincident deviations and path-oriented data-point projections can be expressed as the ratio of the dependent variable sample deviations to the path coincident deviations:

$$\begin{matrix}{ℛ}_{{𝒩}_{ dk}} = {ℛ}_{{N}_{dk}} \\ = {( \frac{{X}_{d} - {𝒳}_{d}}{{δ}_{{N}_{d}}} )}_{𝒫 k} \\ = {[ \frac{{𝒱}_{d} ( {X}_{d} - {𝒳}_{d} )}{( {X}_{d} - {𝒳}_{d} ) \sqrt{{\sum }_{v = 1}^{N} {𝒱}_{v} \frac{\partial {𝒳}_{d}^{2}}{\partial {𝒳}_{v}}}} ]}_{𝒫 k} \\ = {( \frac{{𝒱}_{d}}{\sqrt{{\sum }_{v = 1}^{N} {𝒱}_{v} \frac{\partial {𝒳}_{d}^{2}}{\partial {𝒳}_{v}}}} )}_{𝒫 k} .\end{matrix} \qquad ( 50 )$$

In accordance with the present invention the skew ratios and, as necessary, variabilities are evaluated in correspondence with successive estimates for the fitted parameters, [symbol] being held constant during successive optimization steps of the maximum likelihood estimating process.

In accordance with the present invention, by incorporating the dependent component deviation variability type 1 of Equations 48, along with the skew ratio of Equations 50 and tailored weight factors of the form given by Equations 18, an expression for the essential weighting of squared normal path coincident deviations can take the form of Equations 51:

$${𝒲}_{{N}_{dk}} \frac{{ℛ}_{{N}_{d}}}{\sqrt{{𝒱}_{{N}_{d}}}} \sqrt{{[ \frac{- 1}{{𝒱}_{d}} {( \frac{\partial {𝒳}_{d}}{\partial {N}_{d}} )}^{2} + {\sum }_{j = 1}^{N} \frac{1}{{𝒱}_{j}} {( \frac{\partial {𝒳}_{j}}{\partial {N}_{d}} )}^{2} ]}_{𝒫} k} = \sqrt{\begin{matrix}\frac{\frac{- {ℛ}_{{N}_{d}}^{2}}{{𝒱}_{d} {𝒱}_{{N}_{d}}}}{{[ \frac{- \sqrt{{\sum }_{v = 1}^{N} {{𝒱}_{v} ( \frac{\partial {𝒳}_{d}}{\partial {𝒳}_{v}} )}^{2}}}{{V}_{d}} ]}_{𝒫 k}^{2}} + \\ {\sum }_{j = 1}^{N} \frac{\frac{{ℛ}_{{ }_{d}}^{2}}{{𝒱}_{j} {𝒱}_{{N}_{d}}}}{{[ \begin{matrix}\frac{( \frac{\partial {𝒳}_{d}}{\partial {𝒳}_{j}} ) \sqrt{{\sum }_{v = 1}^{N} {{𝒱}_{v} ( \frac{\partial {𝒳}_{d}}{\partial {𝒳}_{v}} )}^{2}}}{{𝒱}_{d}} + \\ ( \frac{{𝒳}_{d} {\sum }_{v = 1}^{N} {𝒱}_{v} ( \frac{\partial {𝒳}_{d}}{\partial {𝒳}_{v}} \frac{{\partial }^{2} {𝒳}_{d}}{\partial {χ}_{j} \partial {𝒳}_{v}} )}{{𝒱}_{d} \sqrt{{\sum }_{v = 1}^{N} {{𝒱}_{v} ( \frac{\partial {𝒳}_{d}}{\partial {𝒳}_{v}} )}^{2}}} )\end{matrix} ]}_{𝒫 k}^{2}}\end{matrix}} = \frac{{( \frac{{𝒱}_{d}}{\sqrt{{\sum }_{v = 1}^{N} {𝒱}_{v} \frac{\partial {𝒳}_{d}^{2}}{\partial {𝒳}_{v}}}} )}_{𝒫 k}^{2}}{{\sum }_{i} {\sqrt{{𝒱}_{ik} {𝒱}_{{N}_{dk}}} [ {( \frac{\partial {𝒳}_{d}}{\partial {𝒳}_{i}} )}_{k} + \frac{{𝒳}_{{ }_{dk}} {\sum }_{v = 1}^{N} {{𝒱}_{vk} ( \frac{\partial {𝒳}_{d}}{\partial {𝒳}_{v}} \frac{{\partial }^{2} {𝒳}_{d}}{\partial {χ}_{i} \partial {𝒳}_{v}} )}_{k}}{{\sum }_{v = 1}^{N} {{𝒱}_{vk} ( \frac{\partial {𝒳}_{d}}{\partial {𝒳}_{v}} )}_{k}^{2}} ]}_{𝒫}} , \qquad ( 51 )$$

wherein the summation over all variables, as signified by the subscript j, has been replaced by a summation over just the independent variables, as signified by the subscript i.

A form for rendering the weighted sum of squared normal path coincident deviations, as rendered to include essential weighting in accordance with the present invention, is provided by Equation 52:

$${ξ}_{{N}_{d}} {\sum }_{k = 1}^{K} \frac{\begin{matrix}{( \frac{{𝒱}_{d}}{\sqrt{{\sum }_{v = 1}^{N} {𝒱}_{v} \frac{\partial {𝒳}_{d}^{2}}{\partial {𝒳}_{v}}}} )}_{𝒫 k}^{2} \\ {( \frac{( {X}_{d} - {𝒳}_{d} ) \sqrt{{\sum }_{v = 1}^{N} {𝒱}_{v} \frac{\partial {𝒳}_{d}^{2}}{\partial {𝒳}_{v}}}}{{𝒱}_{d}} )}_{𝒫 k}^{2}\end{matrix}}{{\sum }_{i} {\sqrt{{𝒱}_{ik} {𝒱}_{{N}_{dk}}} [ \begin{matrix}{( \frac{\partial {𝒳}_{d}}{\partial {𝒳}_{i}} )}_{k} + \\ \frac{{𝒳}_{dk} {\sum }_{v = 1}^{N} {{𝒱}_{vk} ( \frac{\partial {𝒳}_{d}}{\partial {𝒳}_{v}} \frac{{\partial }^{2} {𝒳}_{d}}{\partial {𝒳}_{i} \partial {𝒳}_{v}} )}_{k}}{{\sum }_{v = 1}^{N} {{𝒱}_{vk} ( \frac{\partial {𝒳}_{d}}{\partial {𝒱}_{v}} )}_{k}^{2}}\end{matrix} ]}_{𝒫}} . \qquad ( 52 )$$

Referring back to FIG. 5, in accordance with the present invention, essential weight factors, [symbol] for weighting the squares of normal path-oriented data-point projections, 44, or approximations of the same, 50, can take the form of Equations 53:

$${𝒲}_{{𝒩}_{dk}} \frac{{( \frac{{𝒱}_{d}}{\sqrt{{\sum }_{v = 1}^{N} {𝒱}_{v} \frac{\partial {𝒳}_{d}^{2}}{\partial {𝒳}_{v}}}} )}_{𝒫 k}^{2}}{{\sum }_{i} {\sqrt{{𝒱}_{ik} {𝒱}_{{𝒩}_{dk}}} [ {( \frac{\partial {𝒳}_{d}}{\partial {𝒳}_{i}} )}_{k} + \frac{{𝒳}_{dh} {\sum }_{v = 1}^{N} {{𝒱}_{vk} ( \frac{\partial {𝒳}_{d}}{\partial {𝒱}_{v}} \frac{{\partial }^{2} {𝒳}_{d}}{\partial {𝒳}_{i} \partial {𝒳}_{v}} )}_{k}}{{\sum }_{i} \sqrt{{𝒱}_{ik} {𝒱}_{{𝒩}_{dk}}} \begin{matrix}{( \frac{\partial {𝒳}_{d}}{\partial {𝒳}_{i}} )}_{k} + \\ \frac{{𝒳}_{dh} {\sum }_{v = 1}^{N} {{𝒱}_{vk} ( \frac{\partial {𝒳}_{d}}{\partial {𝒳}_{i} \partial {𝒳}_{v}} )}_{k}}{{\sum }_{v = 1}^{N} {{𝒱}_{vk} ( \frac{\partial {𝒳}_{d}}{\partial {𝒳}_{v}} )}_{k}^{2}}\end{matrix}} ]}_{𝒫}} . \qquad ( 53 )$$

Note that the sans serif N in Equations 51 is replaced in Equations 53 by a calligraphic [symbol] to indicate inclusion of type 2 deviation variability. A respective sum of weighted squares of normal path-oriented data-point projections is expressed by Equation 54:

$${ξ}_{{𝒩}_{d}} ( 54 ) {\sum }_{k = 1}^{K} \frac{\begin{matrix}{( \frac{{𝒱}_{d}}{\sqrt{{\sum }_{v = 1}^{N} {𝒱}_{v} \frac{\partial {𝒳}_{d}^{2}}{\partial {𝒳}_{v}}}} )}_{𝒫 k}^{2} \\ {( \frac{( {X}_{d} - {𝒳}_{d} ) \sqrt{{\sum }_{v = 1}^{N} {𝒱}_{v} \frac{\partial {𝒳}_{d}^{2}}{\partial {𝒳}_{v}}}}{{𝒱}_{d}} )}_{Pk}^{2}\end{matrix}}{{\sum }_{i} {\sqrt{{𝒱}_{ik} {𝒱}_{dk}} [ {( \frac{\partial {𝒳}_{d}}{\partial {𝒳}_{i}} )}_{k} + \frac{{𝒳}_{dk} {\sum }_{v = 1}^{N} {{𝒱}_{vk} ( \frac{\partial {𝒳}_{d}}{\partial {𝒳}_{v}} \frac{{\partial }^{2} {𝒳}_{d}}{\partial {𝒳}_{i} \partial {𝒳}_{v}} )}_{k}}{{\sum }_{v = 1}^{N} {{𝒱}_{vk} ( \frac{\partial {𝒳}_{d}}{\partial {𝒳}_{v}} )}_{k}^{2}} ]}_{𝒫}} .$$

It is advised that second order derivatives, as included in representation of essential weight factors, be retained; however, in order to simplify form with disregard to associated ramifications, in accordance with the present invention, said essential weight factors may be alternately rendered with their exclusion.

Referring back to FIG. 5, in consideration of the formulation of the sum of squared deviations, as normalized on effective variance being related to a respectively normalized deviation, 47, or as alternately rendered by the mapping of normal projections from the data to the fitting function, 44, or approximations thereof, 50, consider the following:
1. Although the effective variance normalization allows for the combining of random deviation components to render an assumed representation of the displacement between the data point and the assumed true value, there is no valid approximation which will establish said true value. Hence, the validity of that approach must be considered with some reservation.
2. Still, considering said squared deviations as normalized on effective variance and being implemented to include essential weighting, in accordance with the present invention, assuming that an appropriate hierarchical order can be established and that ordered bivariate regressions can be generated, reasonably accurate inversions may be anticipated; however, for these and for other applications being considered in accordance with the present invention, an alternate approach might be advised.
3. Referring back to Equations 33, it is apparent that the normal to a multivariate function should be separately represented in corresponding with each independent orthogonal axis. Although the resulting error deviation may represent a combination of contributing errors from each independent axis, there can only be one data-point projection which, with respect to all considered dimensions, will be mutually normal to the fitting function. Hence, in accordance with the present invention, the validity of Equations 51 and 53, as summed over multiple degrees of freedom, is also questionable.

Perhaps, due to the bivariate restrictions on normal displacements, a more fitting representation for multivariate path deviations might be presented in the somewhat incoherent form of Equation 55, as an RMS sum of contributing components:

$${δ}_{{𝒩}_{d}} {𝒩}_{d} - {N}_{d} = \frac{( {𝒳}_{d} - {X}_{d} ) \sqrt{( {\sum }_{v = 1}^{N} {𝒱}_{v} \frac{\partial {𝒳}_{d}^{2}}{\partial {𝒳}_{v}} ) + {𝒱}_{d} ( N - 1 )}}{{𝒱}_{d}} . \qquad ( 55 )$$

In accordance with the present invention, for whichever deviation path is selected for data modeling, the respective weight factors as generated should accommodate the square of a skew ratio normalized on reduction type variability, said weight factors, as generated for bivariate applications in accordance with the present invention, being rendered to at least approximately correspond to said skew ratio divided by the square root of said reduction type variability, with deviation in the correspondence between said weight factor and said skew ratio divided by said square root, being a function of variations in the associated fitting function slope. In accordance with the present invention, for linear applications, said weight factors may be rendered equal to said skew ratio normalized on said square root of said respective reduction type variability.

In accordance with the present invention, skew ratios are not considered to be variant during calculus related optimizing manipulations, but are rendered by known values or successive approximations. In accordance with the present invention, skew ratios are expressed as the ratios of dependent variable sample deviations to the considered path coincident deviations. In accordance with the present invention, reduction type variability may either represent a type 1 deviation variability, associated with the sampling of the currently considered dependent variable, or the dispersion or a type 2 deviation variability, associated with representing said currently considered dependent variable coordinate as related to respective orthogonal observation samples, as a function of currently assumed estimates or successive approximations for a fitting function.

Referring back to FIG. 5, in accordance with the present invention, preferred performance may be achieved, at least for the applications considered herein, by the selection of a transverse component deviation mapping, 51. In accordance with the present invention, an expression for multivariate component deviation mappings, δ_{T}_{_{d}}, can be rendered for transverse deviation paths by merely replacing the representation of effective variance under the radical of Equation 46 by a type 2 deviation variability, as illustrated in Equation 56:

$${δ}_{{𝒯}_{d}} = {𝒯}_{d} - {T}_{d} = \frac{( {𝒳}_{d} - {X}_{d} ) \sqrt{( {\sum }_{v = 1}^{T} {𝒱}_{v} \frac{\partial {𝒳}_{d}^{2}}{\partial {𝒳}_{v}} ) + {𝒱}_{d}}}{{𝒱}_{d}} \qquad ( 56 )$$

The respective skew ratios are expressed as the ratios of the dependent variable sample deviations to the path coincident deviations, as:

$${ℛ}_{{𝒯}_{dk}} = {ℛ}_{{T}_{dk}} = {[ \frac{{𝒱}_{d}}{\sqrt{( {\sum }_{v = 1}^{T} {𝒱}_{v} \frac{\partial {𝒳}_{d}^{2}}{\partial {𝒱}_{v}} ) - {𝒱}_{d}}} ]}_{𝒫 k} \qquad ( 57 )$$

In consideration of Equations 33, renditions for the normal projection from the data-point to the fitting function, 44, as portrayed in FIG. 5, would be limited to bivariate representations, either in the form of hierarchical regressions or in the form of bivariate path-oriented component addends which, appropriately normalized and weighted, can be included in a multidimensional sum of squared deviations. Note that the normal projection from data to fitting function, 44, is entirely and accurately represented as a function of two degrees of freedom. However, the intersection does not represent a true or expected value. If a third or higher degree of freedom were to be included, the same said normal projection could either be independently represented in correspondence with each respective independent variable degree of freedom or rendered by a coordinate rotation to establish a two-dimensional deviation to include the square root of the sums of weighted squares of deviations in the associated independent variables. Hence, by including essential weighting in correspondence with each respective degree of freedom, each corresponding representation for said normal projection can be included in the associated likelihood estimator. Due to the fact that, as the number of parameters to be evaluated increases, the likelihood of abstracting a valid solution set decreases, hierarchical regressions should, if at all possible, be incorporated, but the ability to include multiple variable regressions as necessary may alternately be incorporated by the implementation of appropriately rendered path-oriented deviations along with the associated essential weighting, as rendered for bicoupled applications in accordance with the present invention.

Referring again to FIG. 5, in accordance with the present invention, a sum of squared deviations for bicoupled path-oriented data-point projections can be rendered in the form of Equation 58:

$${ξ}_{} {\sum }_{d = 1}^{N} {ℰ}_{{d}_{}} , \qquad ( 58 )$$

wherein the calligraphic [symbol] designates the summation in correspondence with a considered set of bivariate deviation paths. Here consider the alternate representations for nomenclature as rendered in the following examples:
1. For the normal approximation to the path-oriented data-point projection length, 50, the sum of weighted squared deviations can be rendered as:

$${ℰ}_{𝒩} {\sum }_{d = 1}^{N} {\sum }_{k = 1}^{N} {\sum }_{i} \frac{\begin{matrix}{( \frac{{𝒱}_{d}}{{𝒱}_{d} + {𝒱}_{i} \frac{\partial {𝒳}_{d}^{2}}{\partial {𝒳}_{i}}} )}_{𝒫 k}^{2} \\ {( \frac{{X}_{d} - {𝒳}_{d} \sqrt{{𝒱}_{d} + {𝒱}_{i} \frac{\partial {𝒳}_{d}^{2}}{\partial {𝒳}_{i}}}}{{𝒱}_{d}} )}_{Pk}^{2}\end{matrix}}{\sqrt{{𝒱}_{i} {𝒱}_{{𝒩}_{d}}} {( \frac{\partial {𝒳}_{d}}{\partial {𝒳}_{i}} + \frac{{𝒳}_{d} {𝒱}_{i} \frac{\partial {𝒳}_{d}}{\partial {𝒳}_{i}} \frac{{\partial }^{2} {𝒳}_{d}}{\partial {𝒳}_{i}^{2}}}{{𝒱}_{d} + {𝒱}_{i} \frac{\partial {𝒳}_{d}^{2}}{\partial {𝒳}_{i}}} )}_{𝒫 k}} . \qquad ( 59 )$$

(An exact form for the weighted sum of the squares of normal path-oriented projections from data to fitting function, 44, may be rendered in correspondence with Equation 59 by representing the dependent and independent variables, [symbol] and [symbol] in correspondence with Equations 44 and 45.)
2. For the dependent residual normalized on the square root of effective variance, 47, being considered as a path orient data-point projection, the sum of weighted squared deviations can be rendered as

$${ℰ}_{E} {\sum }_{d = 1}^{N} {ξ}_{{E}_{d}} {\sum }_{d = 1}^{N} {\sum }_{k = 1}^{K} {\sum }_{i} \frac{{( \sqrt{{𝒱}_{d} + {𝒱}_{i} \frac{\partial {𝒳}_{d}^{2}}{\partial {𝒳}_{i}}} )}_{𝒫}^{2} {( \frac{( {X}_{d} - {𝒳}_{d} )}{\sqrt{{𝒱}_{d} + {𝒱}_{i} \frac{\partial {𝒳}_{d}^{2}}{\partial {𝒳}_{i}}}} )}_{Pk}^{2}}{\sqrt{{𝒱}_{i} {𝒱}_{{E}_{d}}} {( \frac{\partial {𝒳}_{d}}{\partial {𝒳}_{i}} - \frac{{𝒳}_{d} {𝒱}_{i} \frac{\partial {𝒳}_{d}}{\partial {𝒳}_{i}} \frac{{\partial }^{2} {𝒳}_{d}}{\partial {𝒳}_{i}^{2}}}{{𝒱}_{d} + {𝒱}_{i} \frac{\partial {𝒳}_{d}}{\partial {𝒳}_{i}}} )}_{𝒫 k}} . \qquad ( 60 )$$

3. For transverse component mapping, 52, of path-oriented data-point projections, the sum of weighted squared deviations can be rendered as

$${ℰ}_{𝒯} {\sum }_{d = 1}^{N} {ξ}_{{𝒯}_{d}} {\sum }_{d = 1}^{N} {\sum }_{k = 1}^{K} {\sum }_{i} \frac{\begin{matrix}{( \frac{{𝒱}_{d}}{\sqrt{{𝒱}_{i} \frac{\partial {𝒳}_{d}^{2}}{\partial {𝒳}_{i}}}} )}_{𝒫 k}^{2} \\ {( \frac{( {X}_{d} - {𝒳}_{d} ) \sqrt{{𝒱}_{i} \frac{\partial {𝒳}_{d}^{2}}{\partial {𝒳}_{i}}}}{{𝒱}_{d}} )}_{Pk}^{2}\end{matrix}}{\sqrt{{𝒱}_{i} {𝒱}_{{𝒯}_{d}}} {( \frac{\partial {𝒳}_{d}}{\partial {𝒳}_{i}} + \frac{{𝒳}_{d} {𝒱}_{i} \frac{\partial {𝒳}_{d}}{\partial {𝒳}_{i}} \frac{{\partial }^{2} {𝒳}_{d}}{\partial {𝒳}_{i}^{2}}}{{𝒱}_{i} \frac{\partial {𝒳}_{d}^{2}}{\partial {𝒳}_{i}}} )}_{𝒫 k}} \qquad ( 61 )$$

In accordance with the present invention, an alternate formulation for essential weighting of path-oriented deviations may be rendered by replacing the included tailored weight factors by a modified form. Said modified form, or modified tailored weight factor, would be alternately defined as the square root of the sum of the squares of the partial derivatives of each of the independent variables, as normalized on square roots of respective local variabilities or as alternately rendered as locally representative of non-skewed homogeneous error distributions, said partial derivatives being taken with respect to the locally represented path-oriented deviation δ, multiplied by a local skew ratio, [symbol] and normalized on the square root of the respectively considered deviation variability.

For example and in accordance with the present invention, Equations 59 through 61 may be alternately rendered as by Equations 62 through 64:

For the normal approximation to the path-oriented data-point projection length, 50, the sum of weighted squared deviations can be alternately rendered as

$${ℰ}_{𝒩} {\sum }_{d = 1}^{N} {ξ}_{{𝒩}_{d}} {\sum }_{d = 1}^{N} {\sum }_{k = 1}^{K} {\sum }_{i} \frac{\begin{matrix}{( \frac{{𝒱}_{d}}{\sqrt{{𝒱}_{d} + {𝒱}_{i} \frac{\partial {𝒳}_{d}^{2}}{\partial {𝒳}_{i}}}} )}_{𝒫 k}^{2} \\ {( \frac{( {X}_{d} - {𝒳}_{d} ) \sqrt{{𝒱}_{d} + {𝒱}_{i} \frac{\partial {𝒳}_{d}^{2}}{\partial {𝒳}_{i}}}}{{𝒱}_{d}} )}_{Pk}^{2}\end{matrix}}{\sqrt{{𝒱}_{i} {𝒱}_{{𝒩}_{d}}} {( \frac{\partial {𝒳}_{d}}{\partial {𝒳}_{i}} + \frac{( {𝒳}_{d} - {X}_{d} ) {𝒱}_{i} \frac{\partial {𝒳}_{d}}{\partial {𝒳}_{i}} \frac{{\partial }^{2} {𝒳}_{d}}{\partial {𝒳}_{i}^{2}}}{{𝒱}_{d} + {𝒱}_{i} \frac{\partial {𝒳}_{d}^{2}}{\partial {𝒳}_{i}}} )}_{𝒫 k}} . \qquad ( 62 )$$

(An exact form for the alternately weighted sum of the squares of normal path-oriented projections from data to fitting function, 44, can often be rendered in correspondence with Equation 62 by representing the dependent and independent variables, [symbol] and [symbol] in correspondence with Equations 44 and 45.)

For the dependent residual normalized on the square root of effective variance, 47, and being considered as a path-oriented data-point projection, the sum of weighted squared deviations can be alternately rendered as

$${ℰ}_{E} {\sum }_{d = 1}^{N} {ξ}_{{E}_{d}} {\sum }_{d = 1}^{N} {\sum }_{k = 1}^{K} {\sum }_{i} \frac{\begin{matrix}{( \sqrt{{𝒱}_{d} + {𝒱}_{i} \frac{\partial {𝒳}_{d}^{2}}{\partial {𝒳}_{i}}} )}_{𝒫 k}^{2} \\ {( \frac{( {X}_{d} - {𝒳}_{d} )}{{𝒱}_{d} + {𝒱}_{i} \frac{\partial {𝒳}_{d}^{2}}{\partial {𝒳}_{i}}} )}_{Pk}^{2}\end{matrix}}{\sqrt{{𝒱}_{i} {𝒱}_{{E}_{d}}} {( \frac{\partial {𝒳}_{d}}{\partial {𝒳}_{i}} - \frac{( {𝒳}_{d} - {X}_{d} ) {𝒱}_{i} \frac{\partial {𝒳}_{d}}{\partial {𝒳}_{i}} \frac{{\partial }^{2} {𝒳}_{d}}{\partial {𝒳}_{i}^{2}}}{{𝒱}_{d} + {𝒱}_{i} \frac{\partial {𝒳}_{d}^{2}}{\partial {𝒳}_{i}}} )}_{𝒫 k}} . \qquad ( 63 )$$

For transverse component mapping, 52, of path-oriented data-point projections, the sum of weighted squared deviations can be alternately rendered as

$${ℰ}_{𝒯} {\sum }_{d = 1}^{N} {ξ}_{{𝒯}_{d}} {\sum }_{d = 1}^{N} {\sum }_{k = 1}^{K} {\sum }_{i} \frac{\begin{matrix}{( \frac{{𝒱}_{d}}{\sqrt{{𝒱}_{i} \frac{\partial {𝒳}_{d}^{2}}{\partial {𝒳}_{i}}}} )}_{𝒫 k}^{2} \\ {( \frac{( {X}_{d} - {𝒳}_{d} ) \sqrt{{𝒱}_{i} \frac{\partial {𝒳}_{d}^{2}}{\partial {𝒳}_{i}}}}{{𝒱}_{d}} )}_{Pk}^{2}\end{matrix}}{\sqrt{{𝒱}_{i} {𝒱}_{{𝒯}_{d}}} {( \frac{\partial {𝒳}_{d}}{\partial {𝒳}_{i}} + \frac{( {𝒳}_{d} - {X}_{d} ) {𝒱}_{i} \frac{\partial {𝒳}_{d}}{\partial {𝒳}_{i}} \frac{{\partial }^{2} {𝒳}_{d}}{\partial {𝒳}_{i}^{2}}}{{𝒱}_{i} \frac{\partial {𝒳}_{d}^{2}}{\partial {𝒳}_{i}}} )}_{𝒫 k}} . \qquad ( 64 )$$

Without further investigation, it would not be advisable to specify which of the two forms, i.e. the unmodified or the modified forms, of essential weighting might provide the best results. It currently appears that the unmodified form, as incorporated in Equations 59 through Equations 61, might be preferred over the modified form as, incorporated into Equations 62 through 64.

In accordance with the present invention, the examples presented in Equations 59 through 64, as well as other applications of essential weighting as rendered to accommodate path-oriented data-point projections, may be alternately rendered to accommodate path coincident deviations by replacing the type 2 deviation variability with type 1. And, in accordance with the present invention, the considered deviation paths may be alternately rendered as necessary to satisfy specific system restraints. Irregardless of the selected form for the deviation path, the dependent and independent variables, [symbol] and [symbol] may be alternately rendered in correspondence with Equations 44 and 45 to establish representation for an appropriate intersection of a normal data-point projection with the currently considered fitting function estimate, thus establishing true representation for at least normal data-point projections.

Still referring to FIG. 5 in consideration of the formulation and implementation of bicoupled path-oriented data-point projections, the sum of the squares of transverse deviations, 49, as exemplified in FIG. 5, or multivariate renditions of the same, may be alternately rendered to represent associated dependent-independent observation sample pairs in accordance with the present invention.

There are a multitude of different algorithms available to provide data inversions for maximum likelihood solutions. Whatsoever inversion techniques might be employed to provide forms of errors-in-variables processing in accordance with the present invention will require at least some form of essential weighting of squared deviations.

For exemplary purposes of the present' disclosure and in accordance with the present invention, at least one form of errors-in-variables data inverting can be implemented to compensate effects of coordinate bias, as inseparably connected to respective coordinate offsets, by adapting a linear processing method previously implemented by the present inventor. (ref. U.S. Pat. Nos. 5,619,432; 5,652,713; 5,884,245; 6,181,976 B1; 7,107,048; and 7,383,128.) The method includes providing inversions by linearizing with respect to and solving for successive corrections to establish successive approximations. The processing involves including a first order Taylor series approximation to represent the residuals or data-point projections, which are then included in representing the sum of squared deviations. Linear inversions are subsequently rendered to evaluate the corrections which are added to current estimates to establish said successive approximations.

The method may be enhanced by means including increasing the number of fitting parameters as needed to represent all pertinent and/or bias reflective coordinate offsets. The number of addends in the sum of squared deviations may be increased to include alternately considered selections for the dependent variable, thus compensating also for added bias related terms that may be of concern. It may be necessary to provide pre-estimates for and fix any fitting parameters that cannot be independently determined. Also, in accordance with the present invention, it may be advantageous to replace at least one considered offset and related bias with a mean value for the same, as rendered in correspondence with the available data and appropriate essential weighting, said mean value being rendered as a function of respective estimates for the remaining fitting parameters.

Consider an ideal fitting function which is descriptive of a system of N variable degrees of freedom with error assumed in the measurement, Xᵥ, of each variable, [symbol] including the dependent variable, [symbol] which is expressed as a function, [symbol] , of the independent variables, Xᵢ, determined fitting parameters, [symbol] and coordinate offsets, [symbol] and [symbol] , including respective coordinate sample bias, as shown by Equation 65,

$${X}_{d} = {ℱ}_{d} ( {𝒳}_{v} = {ℬ}_{v} , {𝒫}_{p} ) + {ℬ}_{d} , \qquad ( 65 )$$

wherein [symbol] will not be included as a function element for other than transcendental functions. Assuming evaluation of the dependent variable bias and respective coordinate offset is being established by alternate restraints, the mapped observation samples can take the form:

G_{d}=G_{d}(X_{d}− [symbol] , Xᵥ−Bᵥ, Pₚ), (66)

wherein the subscript v will include only the system variables which are implemented to define the mapped observation samples as related to the prescribed deviation path. In accordance with the present invention and depending upon the specific application and corresponding reduction processing, any combination of fitting parameters comprising the makeup of the mapped observation samples may be represented by parameter estimates and held constant during minimizing or maximizing operations. In accordance with the preferred embodiment of the present invention, all included parameters may be held constant as prescribed by Equation 67:

G_{d}=G_{d}(X_{d}− [symbol] , Xᵥ− [symbol] [symbol] ). (67)

A respective path designator for path-oriented deviations would take the form:

[symbol]

= [symbol] (Xᵥ−Bᵥ, Pₚ). (68)

In accordance with the preferred embodiment of the present invention, at least one mapped dependent component observation coordinate offset and sample bias can be considered as a function of the finalized fitting function and the associated data samples, and hence should, if possible, be replaced by a mean value, to be thus alternately included during optimization manipulations. In accordance with the present invention, fitting parameters can be held constant during optimizing operations when they are alternately represented by estimates or restraints.

Now assume a weighted set of path related deviations consistent with the example of Equations 69 and 70, such that:

δ_{d}=√ [symbol] [ [symbol] (Xᵥ− [symbol] −ΔBᵥ, [symbol] +ΔPₚ)−G(Xᵥ− [symbol] , [symbol] )], (69)

$$\begin{matrix}{δ}_{d} = \sqrt{{𝒲}_{d}} [ 𝒢 ( {X}_{v} - {ℬ}_{v} - Δ {B}_{v} , {𝒫}_{p} + Δ {P}_{p} ) - {G}_{d} ( {X}_{v} - {ℬ}_{v} , {𝒫}_{p} ) ] , \\ or & ( 69 ) \\ {δ}_{d} = \sqrt{{𝒲}_{d}} [ 𝒢 ( {X}_{v} - {ℬ}_{v} - Δ {B}_{v} , {𝒫}_{p} + Δ {P}_{p} ) - {G}_{d} ( {X}_{v} - {ℬ}_{v} - Δ {B}_{v} , {𝒫}_{p} + Δ {P}_{p} ) ] , & ( 70 )\end{matrix}$$

wherein the determined bias and fitting parameters are represented by current estimates, [symbol] and [symbol] , and the undetermined fitting parameters have been replaced by current estimates plus undetermined corrections to estimates, [symbol] +ΔPₚ and [symbol] +ΔBᵥ, such that the expected value for the fitting parameters is respectively approximated as the corrections added to corresponding estimates. By rendering first order Taylor series expansion of each residual around the respective estimates, the weighted residuals will take the linear form as approximated by Equations 71,

$${δ}_{d} = \sqrt{{𝒲}_{d}} [ \begin{matrix}{𝒢}_{d} ( {X}_{v} - {ℬ}_{v} , {𝒫}_{p} ) - \\ {G}_{d} ( {X}_{d} - {ℬ}_{d} , {X}_{v} - {ℬ}_{v} , {𝒫}_{p} )\end{matrix} ] + \sqrt{{𝒲}_{d}} {( Δ {B}_{d} \frac{\partial {𝒢}_{d}}{\partial {B}_{v}} - {\sum }_{v = 1}^{N} Δ {B}_{v} \frac{\partial {𝒢}_{d}}{\partial {B}_{v}} + {\sum }_{p = 1}^{P} Δ {P}_{p} \frac{\partial {𝒢}_{d}}{\partial {P}_{p}} )}_{X , ℬ , 𝒫} + \sqrt{{𝒲}_{d}} {( Δ {B}_{d} \frac{\partial {G}_{d}}{\partial {B}_{v}} - {\sum }_{v = 1}^{N} Δ {B}_{v} \frac{\partial {G}_{d}}{\partial {B}_{v}} + {\sum }_{p = 1}^{P} Δ {P}_{p} \frac{\partial {G}_{d}}{\partial {P}_{p}} )}_{X , ℬ , 𝒫} . \qquad ( 71 )$$

or Equations 72,

$${δ}_{d} = \sqrt{{𝒲}_{d}} [ {𝒢}_{d} ( {X}_{v} - {ℬ}_{v} , {𝒫}_{p} ) - {G}_{d} ( {X}_{d} - {ℬ}_{d} , {X}_{v} - {ℬ}_{v} , {𝒫}_{p} ) ] + \sqrt{{𝒲}_{d}} {( Δ {B}_{d} \frac{\partial {𝒢}_{d}}{\partial {B}_{v}} - {\sum }_{v = 1}^{N} Δ {B}_{v} \frac{\partial {𝒢}_{d}}{\partial {B}_{v}} + {\sum }_{p = 1}^{P} Δ {P}_{p} \frac{\partial {𝒢}_{d}}{\partial {P}_{p}} )}_{X , ℬ , 𝒫} + \sqrt{{𝒲}_{d}} {( Δ {B}_{d} \frac{\partial {G}_{d}}{\partial {B}_{v}} - {\sum }_{v = 1}^{N} Δ {B}_{v} \frac{\partial {G}_{d}}{\partial {B}_{v}} + {\sum }_{p = 1}^{P} Δ {P}_{p} \frac{\partial {G}_{d}}{\partial {P}_{p}} )}_{X , ℬ , 𝒫} . \qquad ( 72 )$$

In accordance with the present invention, the mapped observation samples should be considered as constants, and hence, the form of Equations 69 and 71 would be preferred over the form of Equations 70 and 72. In accordance with the present invention, the corresponding weighted sum of squared deviations can be assumed to take one of several alternate forms, depending upon assumptions related to reduction considerations and explicit nature of the essential weight factors. At least six alternate forms are rendered in general form by Equation 73:

$$ξ = \sum {{\sum }_{k = 1}}^{K} {𝒲 [ \begin{matrix}( {𝒢}_{d} - {G}_{d} ) + \{ Δ {B}_{d} \frac{\partial {𝒢}_{d}}{\partial {B}_{d}} \} - \\ {\sum }_{v = 1}^{N} Δ {B}_{v} \frac{\partial {𝒢}_{d }}{\partial {B}_{v}} + {\sum }_{p = 1}^{P} Δ {P}_{p} \frac{\partial {𝒢}_{d }}{\partial {P}_{p}}\end{matrix} ]}_{{X}_{k} , ℬ , 𝒫}^{2} . \qquad ( 73 )$$

The leading summation sign in Equation 73 is included to indicate and allow for optional summations, as might be specified over dependent and independent variables. It may either be omitted or replaced with one or two summations to be taken over dependent and/or independent variables. Summations over alternately represented dependent variables will establish restraints for the evaluation of combined bias and coordinate offsets. Summations over independent variables will allow for dependent-independent variable pair representations to allow for the included weight factors to be rendered in a form consistent with multiple bivariate path-oriented deviations, as exemplified in FIG. 5, or multivariate representations of the same. The essential weight factor, [symbol] may take a form characteristic of either path coincident deviations or path-oriented data-point projections.

Minimizing Equation 73 with respect to the delta parameters ΔPₚ and ΔBᵥ will provide correction values for the same, which can be added to the successive estimates to provide new estimates for successive approximations. In the limit as the corrections approach zero, the higher order Taylor series terms will vanish and estimates should approach a statistically accurate inversion.

In accordance with the preferred embodiment of the present invention, the [symbol] represents a coordinate offset and respective bias which is already included in the dependent variable sample, and which is most aptly considered as an inherent characteristic of the dependent variable function and, thus, preferably excluded from the minimizing process. The extra term, the ΔB_{d}, which is enclosed in braces within Equation 73 serves to render the exclusion, and may be included, or it may be omitted when such an exclusion is not desired or not feasible. It can be omitted when the respective correction for offset and bias are pertinent or if they are to be replaced either by a mean value or an appropriate estimate. In accordance with the present invention, a mean value may be rendered by including the weighted mean offset and bias, B̅_{d}, as generated in terms of parametric representation for fitting parameters by Equation 74:

$$\overline{{B}_{d}} \approx \frac{{\sum }_{k = 1}^{K} {{𝒲}_{{X}_{dk}} ( {X}_{dk} - {𝒳}_{dk} + {ℬ}_{d} )}_{Pk}}{{\sum }_{k = 1}^{K} {𝒲}_{{X}_{dk}}} , \qquad ( 74 )$$

wherein the included weight factor, [symbol] is represented by an essential weight factor with a skew ratio equal to the square root of [symbol] :

$${𝒲}_{{N}_{dk}} \sqrt{{[ \frac{- 1}{{𝒱}_{d}} + {\sum }_{j = 1}^{N} \frac{1}{{𝒱}_{j}} {( \frac{\partial {𝒳}_{j}}{\partial {𝒳}_{d}} )}^{2} ]}_{ 𝒫 k}} . \qquad ( 75 )$$

Note that representation for the individual contributions to bias and offset are to be included in the optimization processing as functions of the remaining and included fitting parameters. Note also that such optimization is doable for at least one offset value. Placing such restraints on one offset value should be sufficient to allow for bias evaluation on the remaining combined coordinate offset and bias values, provided that said remaining offset and bias values are not directly coupled one to another.

In accordance with the present invention, for at least one considered representation for a dependent variable, e.g. [symbol] Equation 73 may be alternately rendered in the form of Equation 76 to replace the respective bias and offset by a mean value:

$$ξ = \sum {{\sum }_{k = 1}}^{K} 𝒲 [ \begin{matrix}{𝒢}_{d} ( {𝒳}_{dk} + {ℬ}_{d} - \overline{{B}_{d}} , … ) - \\ {G}_{d} + \{ Δ {B}_{d} \frac{\partial {𝒢}_{d}}{\partial {B}_{d }} - Δ {B}_{d} \frac{\partial {𝒢}_{d}}{\partial \overline{{B}_{d}}} \frac{\partial \overline{{B}_{d}}}{\partial {B}_{d}} \}\end{matrix} ] + \sum {{\sum }^{K}}_{k = 1} {𝒲 [ \begin{matrix}\{ {\sum }_{v = 1}^{N} Δ {B}_{v} \frac{\partial {𝒢}_{d}}{\partial \overline{{B}_{d}}} \frac{\partial \overline{{B}_{d}}}{\partial {B}_{v }} - Δ {B}_{v} \frac{\partial {𝒢}_{d}}{\partial {B}_{v}} \} + \\ \{ {\sum }_{p = 1}^{P} Δ {P}_{p} \frac{\partial {𝒢}_{d}}{\partial {P}_{p}} - Δ {P}_{p} \frac{\partial {𝒢}_{d}}{\partial \overline{{B}_{d}}} \frac{\partial \overline{{B}_{d}}}{\partial {P}_{p}} \}\end{matrix} ]}_{{X}_{k} , ℬ , 𝒫}^{2} , \qquad ( 76 )$$

and wherein the partial derivatives of B̅_{d}, taken with respect to the fitting parameters B and P, may be rendered respectively as:

$$\begin{matrix}\frac{\partial \overline{{B}_{d}}}{\partial {B}_{v}} = \frac{- {\sum }_{k = 1}^{K} {𝒲}_{{X}_{dk}} \frac{\partial {𝒳}_{dk}}{\partial {B}_{v}}}{{\sum }_{k = 1}^{K} {𝒲}_{{X}_{dk }}} , \\ and & ( 77 ) \\ \frac{\partial \overline{{B}_{d}}}{\partial {P}_{v }} = \frac{- {\sum }_{k = 1}^{K} {𝒲}_{{X}_{dk }} \frac{\partial {𝒳}_{dk}}{\partial {P}_{v }}}{{\sum }_{k = 1}^{K} {𝒲}_{{X}_{dk}}} . & ( 78 )\end{matrix}$$

In accordance with the present invention, substituting a mean value for a coordinate offset and bias will also necessitate a modification to the weight factors to include the partial derivatives of the representation for the mean value with respect to the considered independent variables. Assuming a mean value as given by Equation 74, those derivatives may be expressed by Equation 79:

$$\frac{\partial \overline{{B}_{d}}}{\partial {X}_{v }} = \frac{- {\sum }_{k = 1}^{K} {𝒲}_{{X}_{dk}} \frac{\partial {𝒳}_{dk}}{\partial {X}_{v}}}{{\sum }_{k = 1}^{K} {𝒲}_{{X}_{dk}}} . \qquad ( 79 )$$

Presentation of the reduction algorithm can be simplified by the following substitutions:

$$\begin{matrix}{α}_{p} = {[ \sqrt{𝒲} \frac{\partial {𝒢}_{d}}{\partial {P}_{p}} ]}_{{X}_{k } , ℬ , 𝒫} ; & ( 80 ) \\ {β}_{v} = {[ \sqrt{𝒲} \frac{\partial {𝒢}_{d}}{\partial {B}_{v}} ]}_{{X}_{k} , ℬ , 𝒫} , & ( 81 ) \\ γ = \sqrt{𝒲} {( {𝒢}_{d} - {G}_{d} )}_{{X}_{k} , ℬ , 𝒫} , & ( 82 )\end{matrix}$$

wherein the missing d, i, and k subscripts on αₚ, βᵥ, γ, and [symbol] are either optional or understood. An optional d subscript would designate system variables being rendered as the dependent variable. Replacing a sans serif d subscript by a bold d subscript would indicate an optional replacement of the respective coordinate offset and bias by a mean value. An optional i subscript, if included, would designate dependent-independent variable pair weight factors, and the understood missing k subscript designates the respective observation sample. In accordance with the present invention, the weight factors, [symbol] as included in Equations 80 through 82, may be replaced with any essential weight factor which corresponds to both the data and the fitting function. An additional subscript, such as [symbol] or G, might be also included on the essential weight factor, [symbol] to designate path coincident deviations or path-oriented data-point projections, or subscripts [symbol] and G may be replaced with any alternate designators, such as E and E, [symbol] and N, or other symbolic representation to specify any alternately considered path. For options which include replacement of offsets and related bias by mean values, the coordinate oriented weight factors [symbol] and corresponding mean values, B̅_{d}, need to be computed in advance, utilizing successive estimates for the non-replaced fitting parameters. The correspondingly represented sum of weighted squared deviations will take the parametric form of Equation 83,

$${ξ}_{{𝒢}_{d }} = \sum {\sum }_{k = 1}^{K} {( γ + {β}_{d} Δ {B}_{d} - {\sum }_{v = 1}^{N} {β}_{v} Δ {B}_{v} + {\sum }_{p = 1}^{P} {α}_{p} Δ {P}_{p} )}^{2} . \qquad ( 83 )$$

Minimizing the sum with respect to the parametric representation for corrections to the fitting parameters will yield the equations:

$$\begin{matrix}\frac{\partial {ξ}_{\partial {𝒢}_{d}}}{\partial Δ P} = \sum {\sum }_{k = 1}^{K} 2 α ( \begin{matrix}γ + {β}_{d} Δ {ℬ}_{d} - {\sum }_{v = 1}^{N} {β}_{v} Δ {B}_{v} + \\ {\sum }_{p = 1}^{P} {α}_{p} Δ {P}_{p}\end{matrix} ) {( \frac{\partial {ξ}_{\partial {𝒢}_{d}}}{\partial Δ P} )}_{Δ 𝒫} , \\ and & ( 84 ) \\ \frac{\partial {ξ}_{\partial {𝒢}_{d}}}{\partial Δ B} = \sum {\sum }_{k = 1}^{K} 2 β ( \begin{matrix}γ + {β}_{d} Δ {ℬ}_{d} - {\sum }_{v = 1}^{N} {β}_{v} Δ {B}_{v} + \\ {\sum }_{p = 1}^{P} {α}_{p} Δ {P}_{p}\end{matrix} ) {( \frac{\partial {ξ}_{\partial {𝒢}_{d}}}{\partial Δ B} )}_{Δ ℬ} , & ( 85 )\end{matrix}$$

which lead to

$$\begin{matrix}\sum {\sum }_{k = 1}^{K} α γ + Δ ℬ \sum {\sum }_{k = 1}^{K} α {β}_{d} Δ {ℬ}_{d} - Δ ℬ \sum {\sum }_{k = 1}^{K} {\sum }_{v = 1}^{N} {αβ}_{v} {Δℬ}_{v} + Δ 𝒫 \sum {\sum }_{k = 1}^{K} {\sum }_{p = 1}^{P} α {α}_{p} Δ {𝒫}_{p} = 0 , \\ and & ( 86 ) \\ \sum {\sum }_{k = 1}^{K} β γ + Δ ℬ \sum {\sum }_{k = 1}^{K} β {β}_{d} Δ {ℬ}_{d} - Δ ℬ \sum {\sum }_{k = 1}^{K} {\sum }_{v = 1}^{N} {ββ}_{v} Δ {ℬ}_{v} + Δ 𝒫 \sum {\sum }_{k = 1}^{K} {\sum }_{p = 1}^{P} β {α}_{p} Δ {𝒫}_{p} = 0 , & ( 87 )\end{matrix}$$

which can be expressed in matrix form as

$$( 88 )$$

$$\sum [ \begin{matrix}{\sum }_{k = 1}^{K} {α}_{1}^{2} & … & {\sum }_{k = 1}^{K} {α}_{1} {α}_{P} & {\sum }_{k = 1}^{K} {α}_{1} {β}_{1} & … & {\sum }_{k = 1}^{K} {α}_{1} {β}_{N} \\ … & … & … & … & … & … \\ {\sum }_{k = 1}^{K} {α}_{P} {α}_{1} & … & {\sum }_{k = 1}^{K} {α}_{P}^{2} & {\sum }_{k = 1}^{K} {α}_{P} {β}_{1} & … & {\sum }_{k = 1}^{K} {α}_{P} {β}_{N} \\ {\sum }_{k = 1}^{K} {β}_{1} {α}_{1} & … & {\sum }_{k = 1}^{K} {β}_{1} {α}_{P} & {\sum }_{k = 1}^{K} {β}_{1}^{2} & … & {\sum }_{k = 1}^{K} {β}_{1} {β}_{N} \\ … & … & … & … & … & … \\ {\sum }_{k = 1}^{K} {β}_{N} {α}_{1} & … & {\sum }_{k = 1}^{K} {β}_{N} {α}_{P} & {\sum }_{k = 1}^{K} {β}_{N} {β}_{1} & … & {\sum }_{k = 1}^{K} {β}_{N}^{2}\end{matrix} ] \{ \begin{matrix}Δ {𝒫}_{1} \\ … \\ {Δ𝒫}_{P} \\ Δ {ℬ}_{1} \\ … \\ Δ {ℬ}_{N}\end{matrix} \} = {\sum }_{d = 1}^{N} \{ \begin{matrix}{\sum }_{k = 1}^{K} {α}_{1} γ \\ … \\ {\sum }_{k = 1}^{K} {α}_{P} γ \\ {\sum }_{k = 1}^{K} {β}_{1} γ \\ … \\ {\sum }_{k = 1}^{K} {β}_{N} γ\end{matrix} \} .$$

(In accordance with the present invention, the words “minimize”, “minimized”, or “minimizing”, when used with reference to minimizing a sum with respect to fitting parameters to render a data inversion, refer likewise to maximizing the negative of said sum with respect to said fitting parameters to render a same or similar data inversion.) The order of the matrix equation will depend upon the number of fitting parameters that are to be evaluated. In accordance with the present invention, offsets and related bias that can be assumed negligible may either be included or omitted to establish respective inversions. Also, in accordance with the present invention, at least one of the included offsets and related bias terms, as it occurs in Equation 88, or possibly one for each coupled pair, may be alternately replaced by a mean value which can be represented as a function of the remaining fitting parameters, thus eliminating said at least one coordinate offset and associated bias from the rendition of maximum likelihood and, thereby, reducing the number of fitting parameters to be evaluated and reducing the complexity of the matrix equation by an order of one.

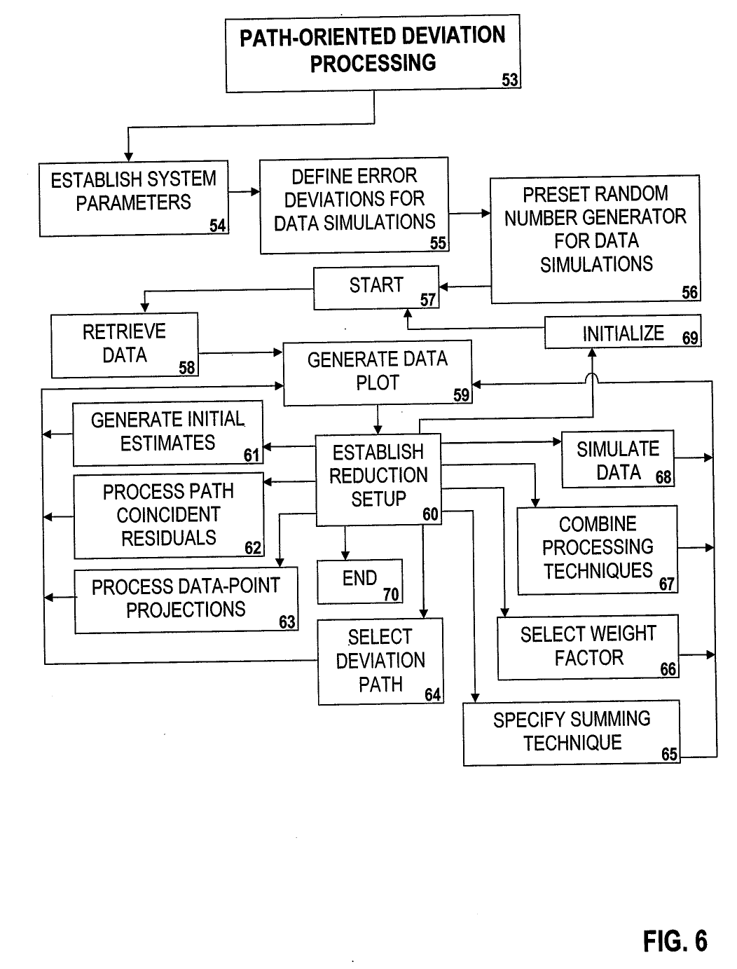

Referring now to FIG. 6 with reference to the compact disk appendix File entitled Appendix C: in accordance with the present invention FIG. 6 represents a flow diagram providing for forms of path-oriented deviation processing, 53, in correspondence with the QBASIC command code files, Errinvar.txt, Search.txt, Einv.txt, and Srch.txt, found in the said Appendix C. Files Errinvar.txt and Search.txt were copied from the compact disk appendix of the Pending U.S. patent application Ser. No. 11/802,533 into files with .txt extensions. The files Einv.txt, and Srch.txt are modifications of the same. In accordance with the present invention, said command code provides for various option selections including:
1. the rendering of exemplary deviation paths being mapped on to dependent variable coordinates in accordance with the present invention;
2. the rendering of respectively considered skew ratios in accordance with the present invention, said skew ratios comprising ratios of dependent component deviations divided by estimated representation for respective said deviation paths, said dependent component deviations being considered as characterized by non-skewed uncertainty distributions;
3. the formulating and rendering of respectively defined essential weight factors in correspondence with deviation paths and respective skew ratios, in accordance with the present invention;
4. the formulating and rendering of exemplary composite weight factors, being rendered to include representation of tailored weighting, in accordance with the present invention;
5. the formulating and rendering of alternate weight factors, being rendered in accordance with the present invention, rendering of said alternate weight factors comprising implementation of said skew ratios;
6. the rendering of projection mapping data sets in correspondence with points of intersection of normal path-oriented data-point projections with the respective fitting function; and
7. the rendering of combined processing techniques in accordance with the present invention. In accordance with the present invention, FIG. 6 illustrates an exemplary flow diagram which might be considered for rendering the operations of path-oriented deviation processing, 53, with processing steps and option selections considered in the following order:
1. Establish system parameters, 54.
2. Define error deviations for data simulations, 55.
3. Preset random number generator for data simulations, 56.
4. Start, 57.
5. Retrieve data, 58.
6. Generate data plot, 59.
7. Establish reduction setup, 60.
8. Generate initial estimates, 61.
9. Process path coincident residuals, 62.
10. Process data-point projections, 63.
11. Select deviation path, 64.
12. Specify summing techniques, 65.
13. Select weight factor, 66.
14. Combine processing techniques, 67.
15. Simulate data, 68.
16. Initialize, 69.
17. End, 70.

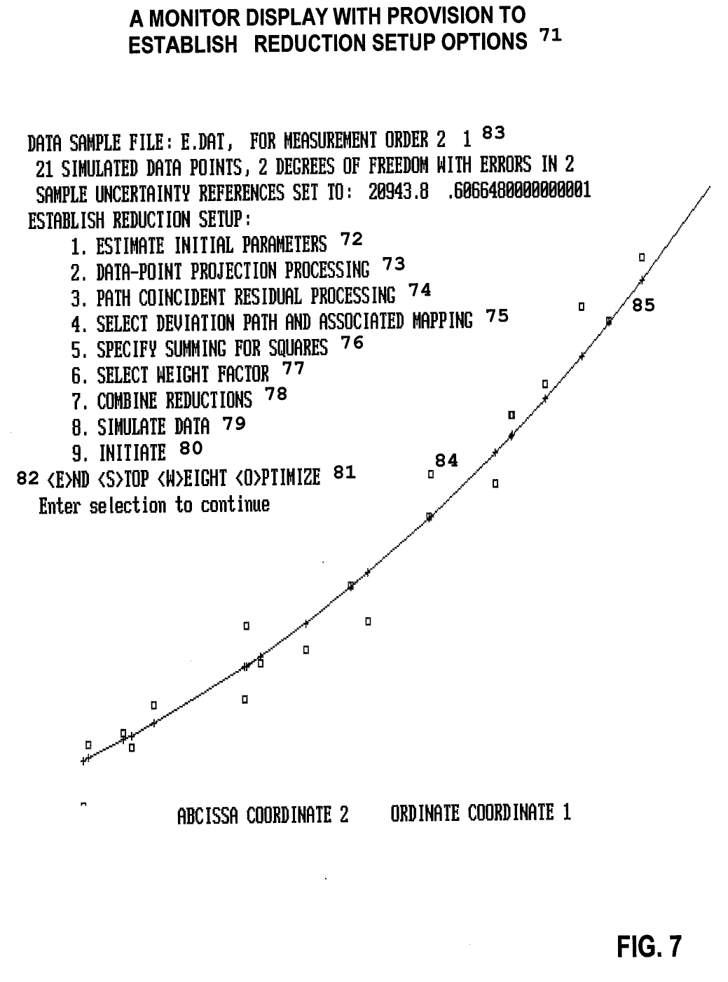

Referring now to FIG. 7 in conjunction with the component 60 of FIG. 6, being implemented to establish reduction setup, FIG. 7 depicts a monitor display, 71, different from that shown in FIG. 4, with provision to establish reduction setup by depressing numeric characters to access options including: option to generate initial estimates, 72; option to process data-point projections, 73; option to process path coincident residuals, 74; option to select a deviation path, 75; option to specify summing techniques, 76; option to select weight factor, 77; option to combine processing techniques, 78; option to simulate data, 79; and option to initialize, 80.

The reduction setup is alternately affected by depressing alpha characters to access options as follows: Said option to select a weight factor, 77, may be alternately selected by depressing a “W”.
An option to optimize, 81, can be initiated buy depressing an “O”.
The option to end or stop, 82, is accessed by depressing an “E” or “S”.

In addition to these option selections, FIG. 7 presents a brief summary, 83, of the form of data that is being prepared for reduction, along with a plot of the data, 84, and, if the data is simulated, FIG. 7 also includes a plot, 85, of the function from which it was simulated. Unless initial estimates are provided as input or stored in a computer file, the procedure with which to estimate initial parameters, 72, may need to be provided by the user in the form of an appropriate command code. Specification of deviation path, 75, summing techniques, 76, and weight factors for either single or combined reductions, 78, need to be set up prior the selection of either data-point projection processing, 73, or path coincident residual processing, 74. The option to optimize, 81, provides for evaluating or approximating the actual location for the intersection of the normal data-point projection with the current or successively approximated estimate for the fitting function.

Referring further to the QBASIC command code of Appendix C in consideration of the selection of a deviation path and associated mapping, 75, the provided path selection rendered by the said command code includes:
1. a transverse path considering a determined designator,
2. a transverse path considering a path variation,
3. a normal path considering a determined designator,
4. a normal path considering a path variation,
5. a residual path normalized on the square root of effective variance considering a determined designator,
6. a residual path normalized on the square root of effective variance considering a path variation, and
7. a coordinate oriented path.

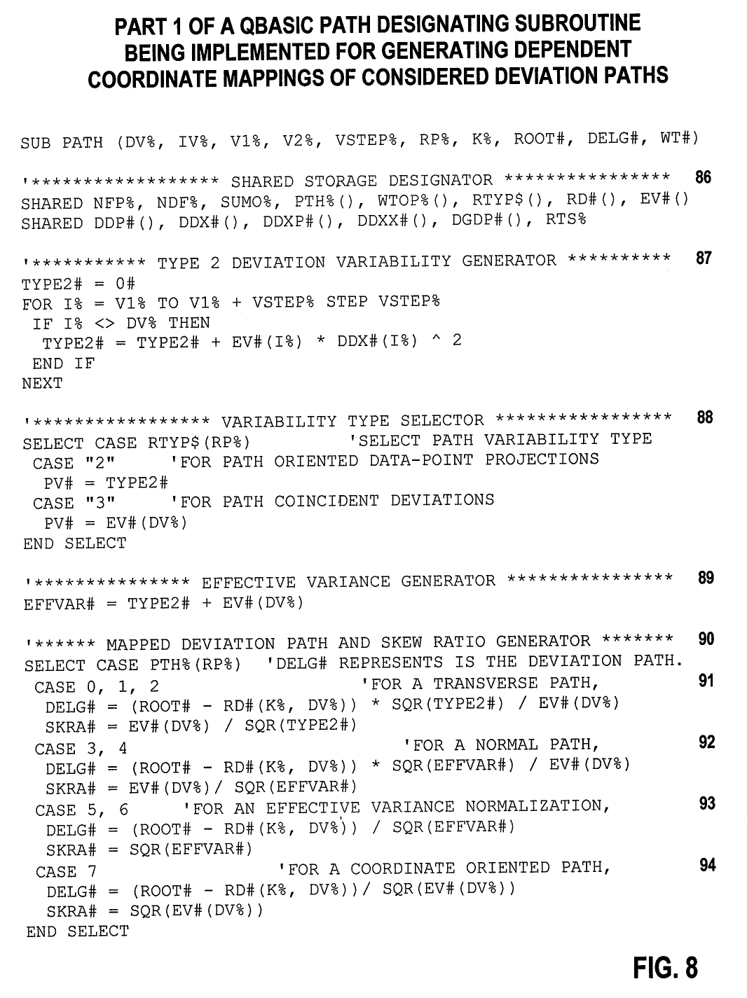

Referring now to FIG. 8, with further reference to the QBASIC command code of Appendix C, FIG. 8 illustrates part 1 of a QBASIC path designating subroutine comprising: a shared storage designator, 86; a type 2 deviation variability generator, 87; a variability type selector, 88; an effective variance generator, 89; a mapped deviation path and skew ratio generator, 90; and code for rendering path and skew representation for a transverse path, 91; for a normal path, 92; for an effective variance type normalization, 93; and for a coordinate oriented path, 94. Input to the subroutine designates the currently selected dependent and independent variables, DV % and IV %, as considered between designated variables V1% and V2%. VSTEP % is either set to one, or it specifies the number of variables of listed order between ordered pairs of dependent and independent variables. For hierarchical regressions, pairs are ordered in correspondence with the order in which the data is presumed to have been taken. For simultaneous errors-in-variables regressions with bicoupled variable representation in accordance with the present invention, VSTEP % will be set to one, and pairs of dependent and independent variables will be considered in the paired order by multiple passes through dependent and independent variable representations. V2% is set to accommodate the total number of variables to be simultaneously considered, and variables are paired without consideration of order. RP % designates the current reduction path setup. K % designates the specific sample observation; and root# is the function evaluated for the current root and dependent variable. Output parameters are DELG#, the designated path length, and the weight factor, WT#.

Shared input parameters respectively include the number of fitting parameters, NFP %; the number of degrees of freedom, NDF %; the reduction summing selection, SUMO %; the path option selection, PTH %( ) the weight factor selection, WTOP %( ) the reduction type selection, RTYP$( ) the available data samples, RD#( ); an effective observation sample variability, EV#( ); the first derivatives of the dependent variable taken with respect to the fitting parameters, DDP#( ) the first derivative of the dependent variable taken with respect to the independent variables, DDX#( ) the second derivative of the dependent variable, taken first with respect to the independent variables and second with respect to the fitting parameters, DDXP#( ) and the second derivative of the dependent variable taken with respect to all combinations of pairs of variables, DDXX#( ) The first derivative of the path designator taken with respect to the fitting parameters, DGDP#( ), is provided as a shared output parameter. RTS % is an input/output reduction type selector, which can be interactively modified during processing by depressing a keyboard “r”.

The type 2 deviation variability generator, 87, provides the type 2 deviation variability for the evaluation of essential weighting for the square of path-oriented data-point projections.

The variability type selector, 88, sets the path-oriented deviation variability for the selected data processing: type 1 for path coincident deviations and type 2 for path-oriented data-point projections.

The effective variance generator, 89, combines the type 1 deviation variability with the type 2 deviation variability to render the effective variance.

Note that the form of the type 2 deviation variability and the effective variance, whether rendered in bivariate or multivariate form, depends upon the number of variables being considered from V1% to V2% with a step of VSTEP %.

Referring back to FIG. 7 in consideration of the leading summation signs of Equation 76 and in Equations 83 through 88, in accordance with the present invention, said leading summation sign is included to indicate and allow for optional summing for the squares of considered deviations, 76. Referring to the QBASIC command code of Appendix A through C, options that provide for the selection of summing include:
1. summing over dependent and independent variables,
2. summing only over dependent variables,
3. summing only over independent variables.

4. not summing over dependent or independent variables,
5. simple sequential summing over ordered pairs, and
6. sequential summing over ordered dependent and independent variables.

In accordance with the present invention, sum over options are provided to accommodate alternate reduction techniques, being rendered in accordance with the present invention, including the following:
1. The option of summing over dependent and independent variables provides for rendering residual and path-oriented displacements and respective weight factors as a function of all combinations of bicoupled variables. (Assuming the normal deviation between the function and the data point to be the same for all orthogonal variable pairs, by implementing essential weighting, sums of all squared normal deviations can be combined, irrespective of which variable is being rendered as the dependent variable).
2. The option of summing only over dependent variables allows for the representation of alternate variables as dependent variables and provides for a multivariate representation of weight factors and residuals.
3. The option of summing only over independent variables provides for rendering path-oriented displacements and respective weight factors as a function of variable pairs in correspondence with a single variable being considered as the dependent variable.
4. The option of not summing over dependent or independent variables provides for a multivariate representation of weight factors and residuals in correspondence with a single dependent variable.
5. The option of simple sequential summing over ordered pairs provides the option of rendering bivariate residual and path-oriented displacements and respective weight factors as a function of sequential pairs, arranged in appropriate order to provide for a series of hierarchical regressions; and
6. The option of sequential summing over ordered dependent and independent variables provides for the rendering of bivariate residual and path-oriented displacements and respective weight factors as a function of sequential pairs arranged in appropriate order to provide for a series of hierarchical regressions, with both elements of each set of sequential pairs being alternately rendered as the dependent variable.

Referring again to FIG. 8 and considering the QBASIC command code of Appendix C, it is the parameter SUMO % that specifies the selected type of summing for the respective data inversion, and in accordance with the current example of the present invention, it is the designated output storage parameters, DELG#, WT#, and DGDP#( ), with values generated by the QBASIC PATH subroutine, that respectively quantify the path-oriented deviations and provide the weight factors and derivatives needed for said inversion.

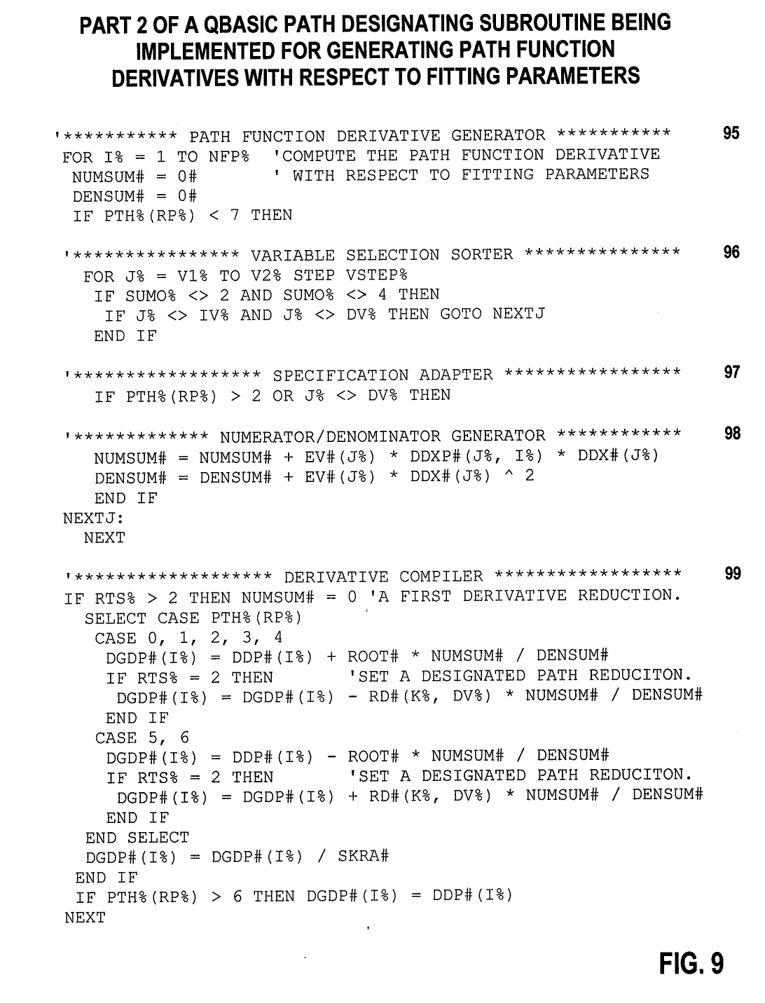

Referring now to FIG. 9 in conjunction with Equations 80 through 82 and the matrix Equation 88, in accordance with the present invention, the inversion technique employed by the QBASIC command code of Appendices A through C will most likely require representation of the first derivatives of either the path designator or the mapped path-oriented deviation (or designated path) in order to manipulate the inversion. FIG. 9 illustrates part 2 of the QBASIC path designating subroutine as a continuation of FIG. 8. Said part 2 comprises means for rendering said first derivatives.

With regard to said derivatives, most of the equations of this disclosure that describe the essential weight factor and respective sum of squared deviations contain a ratio which includes second order derivatives. This ratio can be expressed as a numerator divided by a denominator and correspondingly reduced to a form which is compatible with a bivariate weight factor consideration, as in Equation 89:

$$\frac{numerator}{denominator} = \frac{{\sum }_{v = 1}^{N} {{𝒱}_{vk} ( \frac{\partial {𝒳}_{d}}{\partial {𝒳}_{v}} \frac{{\partial }^{2} {𝒳}_{d}}{\partial {𝒳}_{i} \partial {𝒳}_{v}} )}_{k}}{{\sum }_{v = 1}^{N} {{𝒱}_{vk} ( \frac{\partial {𝒳}_{d}}{\partial {𝒳}_{v}} )}_{k}^{2}} \frac{{{𝒱}_{ik} ( \frac{\partial {𝒳}_{d}}{\partial {𝒳}_{i }} \frac{{\partial }^{2} {𝒳}_{d}}{\partial {𝒳}_{i}^{2}} )}_{k}}{{𝒱}_{dk} + {{𝒱}_{ik} ( \frac{\partial {𝒳}_{d}}{\partial {𝒳}_{i}} )}_{k }^{2}} . \qquad ( 89 )$$

In accordance with the present invention, a ratio similar to that of Equation 89 may be rendered in correspondence with the derivatives of either the designated path or path designator, taken with respect to associated fitting parameters. Said similar ratio may be expressed in the form of Equation 90:

$$\frac{numerator}{denominator} = \frac{{\sum }_{v = 1}^{N} {{𝒱}_{vk} ( \frac{\partial {𝒳}_{d}}{\partial {𝒳}_{v}} \frac{{\partial }^{2} {𝒳}_{d}}{\partial P \partial {𝒳}_{v }} )}_{k}}{{\sum }_{v = 1}^{N} {{𝒱}_{vk} ( \frac{\partial {𝒳}_{d}}{\partial {𝒳}_{v}} )}_{k}^{2}} \frac{{{𝒱}_{ik} ( \frac{\partial {𝒳}_{d}}{\partial {𝒳}_{i}} \frac{{\partial }^{2} {𝒳}_{d}}{\partial P \partial {𝒳}_{i }} )}_{k}}{{𝒱}_{dk} + {{𝒱}_{ik} ( \frac{\partial {𝒳}_{d}}{\partial {𝒳}_{i}} )}_{k}^{2}} . \qquad ( 90 )$$

FIG. 9 illustrates part 2 of a QBASIC path designating subroutine, comprising a path function derivative generator, 95; a variable selection sorter, 96; a specification adapter, 97; a numerator and denominator generator, 98; and a derivative compiler, 99. The path function derivative generator, as rendered for this example, is set up to provide a variety of alternate derivative selections, including both derivatives with respect to fitting parameters, as required for inversion operations and derivatives with respect to independent variables for the rendering of weight factors. The explicit form of the derivatives will depend upon the design of the selected path, which is designated for alternately considered reduction passes by the path option selection input parameter, PTH %( ) A variable selection sorter, 96, is provided to establish the components to be included in rendering said numerator and denominator in accordance with the selected form for the summing of squared deviation, which is designated by the sum over option input parameter, SUMO %. For sum over options 2 and 4, derivatives with respect to all variables will be included in the rendition. For other sum over options, only derivatives taken with respect to the considered dependent and independent variables are included. The specification adapter, 97, adapts the respective numerator and denominator to coincide with the path specifications, and the derivatives are rendered by the derivative compiler, 99, in correspondence with the selected path option. It should be noted that by setting the reduction type selector, RTS % greater than two, the numerator in Equation 90 NUMSUM# will be set to zero, providing for a first derivative approximation. Under the condition that the second derivative terms of Equation 90 vanish faster than the first terms, the ratio of said Equation 90 need not be included to invert the data.

In accordance with the present invention, alternate inversion techniques may be implemented. Normally, the value for the reduction type selector is set to one or two, in correspondence with the selected path, reflecting the selection of a corresponding reduction as assumed to be provided by either Equation 71 or 72. An alternate selection may be made by an interactive selection during processing. The preferred form, as considered in accordance with the present invention, is to assume that the mapped observation sample should be treated as a constant, and that the more appropriated renditions correspond to RTS

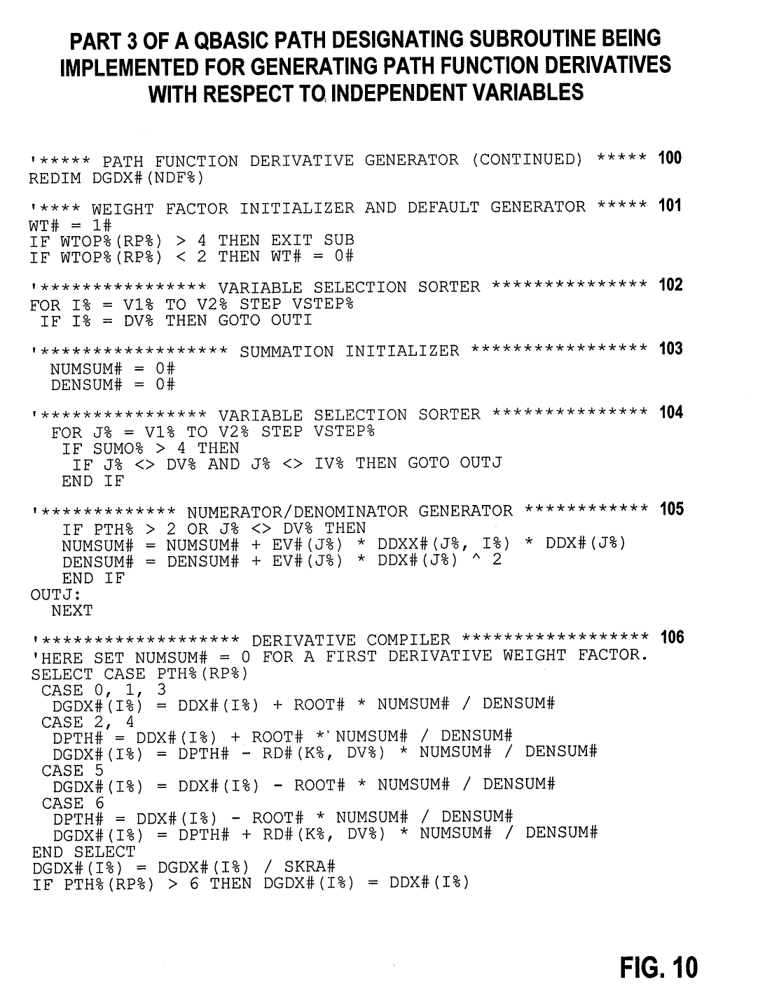

Referring now to FIG. 10, illustrating part 3 of a QBASIC path designating subroutine, comprising a continued representation of the path function derivative generator, 100: said path function derivative generator is implemented for generating path function derivatives with respect to independent variables, in accordance with the present invention, comprising a weight factor initializer and default generator, 101; a dependent variable selection sorter, 102; a summation initializer, 103; an independent variable selection sorter, 104; a numerator and denominator generator, 105; and a derivative compiler, 106.

The portion of the path function derivative generator included in FIG. 10, being rendered for this example, is set up to provide derivatives with respect to independent variables for the rendering of weight factors associated with various deviation paths. The explicit form of the derivatives will depend upon the design of the selected path, which is designated for alternately considered reduction passes-by the path option selection input parameter, PTH %( ) Two variable selection sorters, 102 and 104, for sorting through dependent and independent variables, are separated by a summation initializer, 103, initializing the summations for the numerator/denominator generator, 105. Derivatives taken with respect to the independent variables are formulated by the derivative compiler, 106, in correspondence with the selected paths. Note that derivatives with respect to independent variables, as rendered in the command code of FIG. 10, do not include derivatives of mean values for offset and related bias, as provided by Equation 79. In accordance with the present invention, these additional derivatives may be provided by user supplied routines once a fitting function is decided upon. Formulation for rendition of these additional derivatives will be apparent to those skilled in the art. Note also that the comment included in the beginning code of the derivative compiler, 106, states: “Here set NUMSUM#=0 for a first derivative weight factor”. Under the condition that the second derivatives within Equation 89 are not significant, or possibly to just simplify the reduction process, the ratio provided by Equation 89 may be excluded in the rendering of weight factors.

Referring again to the QBASIC command code of Appendicies A through C, in accordance with the present invention, options therein provided for the selection of weight factors include:
1. essential weighting,
2. cursory weighting,
3. skew ratio weighting,
4. squared skew ratio weighting, and
5. no weighting.

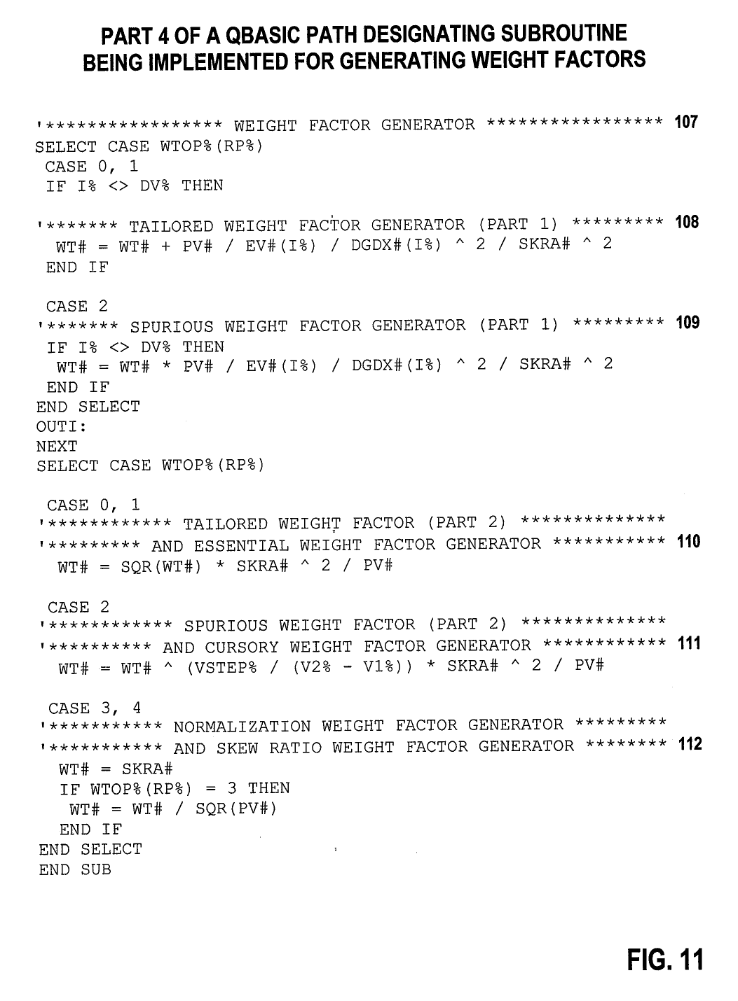

Referring now to FIG. 11 with further reference to the QBASIC command code of Appendix C, FIG. 11 illustrates part 4 of a QBASIC path designating subroutine, comprising a weight factor generator, 107, said weight factor generator comprising: a tailored weight factor generator (part 1), 108; a spurious weight factor generator (part 1), 109; a tailored weight factor (part 2) and essential weight factor generator, 110; a spurious weight factor (part 2) and cursory weight factor generator, 111; and a normalization weight factor and a skew ratio weight factor generator, 112.

In accordance with the present invention, the tailored weight factor generator (part 1), 108, as rendered in FIG. 11, comprises means for initiating the rendering representation for any of four alternate forms for tailored weighting, depending upon the selection of a deviation path as designated by the reduction selection, RTYP$( ) and the path option parameter, PTH %( ) said four alternate forms for tailored weighting being characterized by Equations 91 through 94 for the following four configurations: For path coincident deviations being rendered with respect to a path designator,

$${W}_{{G}_{k}} = \sqrt{{\sum }_{i} {( \frac{\partial {𝒳}_{i} / \sqrt{{𝒱}_{i}}}{\partial {ℛ}_{G} 𝒢 / \sqrt{{𝒱}_{G }}} )}_{𝒫 k}^{2}} \sqrt{\frac{{𝒱}_{{G}_{k }}}{{ℛ}_{{G}_{k }}^{2}} {\sum }_{i} \frac{1}{{𝒱}_{ik }} {( \frac{\partial {𝒳}_{i}}{\partial 𝒢} )}_{𝒫 k}^{2}} . \qquad ( 91 )$$

For path-oriented data-point projections being rendered with respect to a path designator,

$${W}_{{𝒢}_{k}} = \sqrt{{\sum }_{i} {( \frac{\partial {𝒳}_{i} / \sqrt{{𝒱}_{i}}}{\partial {ℛ}_{𝒢} 𝒢 / \sqrt{{𝒱}_{𝒢}}} )}_{𝒫 k}^{2}} \sqrt{\frac{{𝒱}_{{𝒢}_{k}}}{{ℛ}_{{𝒢}_{k}}^{2}} {\sum }_{i} \frac{1}{{𝒱}_{ik }} {( \frac{\partial {𝒳}_{i}}{\partial 𝒢 } )}_{𝒫 k}^{2}} . \qquad ( 92 )$$

For path coincident deviations being rendered with respect to a designated path,

$$\begin{matrix}{W}_{{G}_{k}} = \sqrt{{\sum }_{i} {( \frac{\partial {𝒳}_{i} / \sqrt{{𝒱}_{i}}}{\partial {ℛ}_{G} ( 𝒢 - G ) / \sqrt{{𝒱}_{G}}} )}_{𝒫 k}^{2}} \\ = \sqrt{\frac{{𝒱}_{{G}_{k}}}{{ℛ}_{{G}_{k}}^{2}} {\sum }_{i} \frac{1}{{𝒱}_{ik}} {( \frac{\partial {𝒳}_{i}}{\partial ( 𝒢 - G )} )}_{𝒫 k}^{2}} .\end{matrix} \qquad ( 93 )$$

And, for pain-oriented data-point projections being rendered with respect to a designated path,

$$\begin{matrix}{W}_{{𝒢}_{k}} = \sqrt{{\sum }_{i} {( \frac{\partial {𝒳}_{i} / \sqrt{{𝒱}_{i}}}{\partial {ℛ}_{𝒢} ( 𝒢 - G ) / \sqrt{{𝒱}_{𝒢}}} )}_{𝒫 k}^{2}} \\ = \sqrt{\frac{{𝒱}_{{𝒢}_{k}}}{{ℛ}_{{𝒢}_{k}}^{2}} {\sum }_{i} \frac{1}{{𝒱}_{ik}} {( \frac{\partial {𝒳}_{i}}{\partial 𝒢 - G} )}_{𝒫 k}^{2}} .\end{matrix} \qquad ( 94 )$$

In accordance with the present invention, the spurious weight factor generator (part 1), 109, as rendered in FIG. 11, comprises means for initiating the rendering for any of four alternate forms for spurious weighting, depending upon the selection of a deviation path as designated by the reduction selection, RTYP$( ) and the path option parameter, PTH %( ) said four alternate forms for spurious weighting being characterized by Equations 95 through 98 for the following four weight factor types and respective configurations: Spurious weight factors for path coincident deviations being rendered with respect to a path designator,

$$\begin{matrix}{W}_{{G}_{k}} = {\vert {\prod }_{i} \frac{\partial {ℛ}_{G} 𝒢 / \sqrt{{𝒱}_{G}}}{\partial {𝒳}_{i} / \sqrt{{𝒱}_{i}}} \vert}_{{𝒫}_{k}}^{- \frac{2}{N}} \\ = {\vert {\prod }_{i} \frac{{ℛ}_{{G}_{k}} \sqrt{{𝒱}_{ik}}}{\sqrt{{𝒱}_{{G}_{k}}}} {( \frac{\partial 𝒢}{\partial {𝒳}_{i}} )}_{k} \vert}_{𝒫}^{- \frac{2}{N}} .\end{matrix} \qquad ( 95 )$$

Spurious weight factors for path-oriented data-point projections being rendered with respect to a path designator,

$$\begin{matrix}{W}_{{𝒢}_{k}} = {\vert {\prod }_{i} \frac{\partial {ℛ}_{𝒢} 𝒢 / \sqrt{{𝒱}_{𝒢}}}{\partial {𝒳}_{i} / \sqrt{{𝒱}_{i}}} \vert}_{{𝒫}_{k }}^{- \frac{2}{N}} \\ = {\vert {\prod }_{i} \frac{{ℛ}_{{G}_{k}} \sqrt{{𝒱}_{ik}}}{\sqrt{{𝒱}_{{𝒢}_{k}}}} {( \frac{\partial 𝒢}{\partial {𝒳}_{i}} )}_{k} \vert}_{𝒫}^{- \frac{2}{N}} .\end{matrix} \qquad ( 96 )$$

Alternate weight factors for path coincident deviations being rendered with respect to a designated path,

$$\begin{matrix}{W}_{{G}_{k}} = {\vert {\prod }_{i} \frac{\partial {ℛ}_{G} ( 𝒢 + G ) / \sqrt{{𝒱}_{G}}}{\partial {𝒳}_{i} / \sqrt{{𝒱}_{i}}} \vert}_{{𝒫}_{k}}^{- \frac{2}{N}} \\ = {\vert {\prod }_{i} \frac{{ℛ}_{{G}_{k}} \sqrt{{𝒱}_{ik}}}{\sqrt{{𝒱}_{{G}_{k}}}} {( \frac{\partial ( 𝒢 + G )}{\partial {𝒳}_{i}} )}_{k} \vert}_{𝒫}^{- \frac{2}{N}} ,\end{matrix} \qquad ( 97 )$$

said alternate weight factors being rendered to include skew ratio representation. And, alternate weight factors for path-oriented data-point projections being rendered with respect to a designated path,

$$\begin{matrix}{W}_{{𝒢}_{k}} = {\vert {\prod }_{i} \frac{\partial {ℛ}_{𝒢} ( 𝒢 + G ) / \sqrt{{𝒱}_{𝒢}}}{\partial {𝒳}_{i} / \sqrt{{𝒱}_{i}}} \vert}_{{𝒫}_{k}}^{- \frac{2}{N}} \\ = {\vert {\prod }_{i} \frac{{ℛ}_{{𝒢}_{k}} \sqrt{{𝒱}_{ik}}}{\sqrt{{𝒱}_{{𝒢}_{k} }}} {( \frac{\partial ( 𝒢 + G )}{\partial {𝒳}_{i }} )}_{k} \vert}_{𝒫}^{- \frac{2}{N}} ,\end{matrix} \qquad ( 98 )$$

said alternate weight factors being rendered to include skew ratio representation.

In accordance with the present invention, the tailored weight factor (part 2) and essential weight factor generator, 110, as rendered in FIG. 11, comprises means for rendering representation for any of several of weight factors, including forms rendered to accommodate a skew ratio in accordance with the present invention.

Essential weighting as considered for path coincident deviations can be rendered, in accordance with the present invention, in the form of Equations 99:

$$\begin{matrix}{𝒲}_{{G}_{k}} = \frac{{ℛ}_{G}^{2} {W}_{{G}_{k}}}{{𝒱}_{G}} \\ = \frac{{ℛ}_{G}^{2}}{{𝒱}_{G} } \sqrt{{\sum }_{i = 1} {( \frac{\partial {𝒳}_{i} / \sqrt{{𝒱}_{i}}}{\partial {ℛ}_{G} 𝒢 / \sqrt{{𝒱}_{G}}} )}_{𝒫 k}^{2}} \\ \frac{{ℛ}_{G}}{\sqrt{{𝒱}_{G}}} \sqrt{{\sum }_{i = 1}^{N - 1} \frac{1}{{𝒱}_{ik}} {( \frac{\partial {𝒳}_{i}}{\partial 𝒢} )}_{𝒫 k}^{2}} ,\end{matrix} \qquad ( 99 )$$

wherein the sum over the considered subscript, i, may be assumed to include only those independent variables that are being included simultaneously in a same optimization operation or on a same hierarchical level, depending upon the order and interdependence of the respective measurements.

In accordance with the present invention, the spurious weight factor (part 2) and cursory weight factor generator, 111, as rendered in FIG. 11, comprise means for rendering representation for any of several of weight factors, including forms rendered to accommodate a skew ratio in accordance with the present invention.

Considering the likelihood, as associated with multidimensional sample deviations from an expected value with a displacement likelihood related to the N^{th} root of an associated deviation space, a cursory weight factor can be rendered in accordance with the present invention in the form of Equations 100:

$$\begin{matrix}{𝒲}_{{G}_{k}} = \frac{{ℛ}_{G}^{2} {W}_{{G}_{k}}}{{𝒱}_{G}} \\ = \frac{{ℛ}_{G}^{2}}{{𝒱}_{G}} {\vert {\prod }_{i} \frac{\partial {ℛ}_{G} 𝒢 / \sqrt{{𝒱}_{G}}}{\partial {𝒳}_{i} / \sqrt{{𝒱}_{i} }} \vert}_{{𝒫}_{k}}^{- \frac{2}{N}} \\ {\vert \frac{\sqrt{{𝒱}_{G}}}{{ℛ}_{G}} {\prod }_{i} \frac{1}{\sqrt{{𝒱}_{ik}}} {( \frac{\partial {𝒳}_{i}}{\partial 𝒢} )}_{k} \vert}_{𝒫}^{\frac{2}{N}} ,\end{matrix} \qquad ( 100 )$$

wherein N represents only the number of variable degrees of freedom that are being simultaneously considered. The name “cursory” is applied to the weight factor, as rendered in Equations 100, in consideration of the fact that for more than two dimensions, the deviation can never be truly related to the expected value, and hence, the form of Equations 100 must be generally considered as invalid for N greater than two.

Note that, in accordance to the present invention, for two degrees of freedom and for bivariate hierarchical coupling, Equations 99 and 100 reduce to a same form, that is:

$${𝒲}_{{G}_{k}} {( \frac{{ℛ}_{G}}{\sqrt{{𝒱}_{G} {𝒱}_{ik}}} \frac{\partial {𝒳}_{i}}{\partial 𝒢} )}_{𝒫 k} . \qquad ( 101 )$$

Weight factors similar to those expressed by Equations 99, 100, and 101 may be expressed in the form of composite weight factors, with the partial derivatives of or with respect to the path designators, being replaced by those of, or with respect to, the designated paths, and rendered in accordance with the present invention by the inclusion of the respective skew ratios, as in Equations 102, 107, and 104:

$$\begin{matrix}\begin{matrix}{𝒲}_{{G}_{k }} = \frac{{ℛ}_{G}^{2} {W}_{{G}_{k}}}{{𝒱}_{G}} \\ = \frac{{ℛ}_{G}^{2}}{{𝒱}_{G}} \sqrt{{\sum }_{i = 1} {( \frac{\partial {𝒳}_{i} / \sqrt{{𝒱}_{i}}}{\partial {ℛ}_{G} ( 𝒢 + G ) / \sqrt{{𝒱}_{G}}} )}_{𝒫 k}^{2}} \\ \frac{{ℛ}_{G} }{\sqrt{{𝒱}_{G}}} \sqrt{{\sum }_{i = 1}^{N - 1} \frac{1}{{𝒱}_{ik}} {( \frac{\partial {𝒳}_{i}}{\partial ( 𝒢 + G )} )}_{𝒫 k}^{2}} ;\end{matrix} & ( 102 ) \\ \begin{matrix}{𝒲}_{{G}_{k}} = \frac{{ℛ}_{G}^{2} {W}_{{G}_{k}}}{{𝒱}_{G}} \\ = \frac{{ℛ}_{G}^{2}}{{𝒱}_{G}} {\vert {\prod }_{i} \frac{\partial {ℛ}_{G} ( 𝒢 + G ) / \sqrt{{𝒱}_{G}}}{\partial {𝒳}_{i} / \sqrt{{𝒱}_{i }}} \vert}_{{𝒫}_{k}}^{- \frac{2}{N}} \\ {\vert \frac{\sqrt{{𝒱}_{G}}}{{ℛ}_{G}} {\prod }_{i} \frac{1}{\sqrt{{𝒱}_{ik}}} {( \frac{\partial {𝒳}_{i}}{\partial ( 𝒢 + G )} )}_{k} \vert}_{𝒫}^{\frac{2}{N}} ,\end{matrix} \\ and & ( 103 ) \\ {𝒲}_{{G}_{k}} {( \frac{{ℛ}_{G}}{\sqrt{{𝒱}_{G} {𝒱}_{ik}}} \frac{\partial {𝒳}_{i}}{\partial ( 𝒢 + G )} )}_{𝒫 k} . & ( 104 )\end{matrix}$$

Advantages of weight factors, as provided by Equations 99 through 101, over those of Equations 102 through 104 have not as yet been been established.

In accordance with the present invention, Equations 99 through 104 may be alternately rendered to provide respective weighting for path-oriented data-point projections by replacing the type 1 deviation variability, [symbol] with a type 2 deviation variability, [symbol] .

Essential weighting as considered for path-oriented data-point projections can be rendered, in accordance with the present invention, in the form of Equations 105:

$$\begin{matrix}{𝒲}_{{𝒢}_{k}} = \frac{{ℛ}_{𝒢}^{2} {W}_{{𝒢}_{k}}}{{𝒱}_{𝒢}} \\ = \frac{{ℛ}_{𝒢}^{2}}{{𝒱}_{𝒢}} \sqrt{{\sum }_{i} {( \frac{\partial {𝒳}_{i} / \sqrt{{𝒱}_{i}}}{\partial {ℛ}_{𝒢} 𝒢 / \sqrt{{𝒱}_{𝒢}}} )}_{𝒫 k}^{2}} \\ \frac{{ℛ}_{𝒢}}{\sqrt{{𝒱}_{𝒢}}} \sqrt{{\sum }_{i = 1}^{N - 1} \frac{1}{{𝒱}_{ik}} {( \frac{\partial {𝒳}_{i}}{\partial 𝒢} )}_{𝒫 k}^{2}} .\end{matrix} \qquad ( 105 )$$

A cursory weight factor can be rendered, in accordance with the present invention, for path-oriented data-point projections in the form of Equations 106:

$$\begin{matrix}{𝒲}_{{𝒢}_{k}} = \frac{{ℛ}_{𝒢}^{2} {W}_{{𝒢}_{k}}}{{𝒱}_{𝒢}} \\ = \frac{{ℛ}_{𝒢}^{2}}{{𝒱}_{𝒢}} {\vert {\prod }_{i = 1}^{N - 1} \frac{\partial {ℛ}_{𝒢} 𝒢 / \sqrt{{𝒱}_{𝒢}}}{\partial {𝒳}_{i} / \sqrt{{𝒱}_{i}}} \vert}_{{𝒫}_{k }}^{- \frac{2}{N}} \\ {\vert \frac{\sqrt{{𝒱}_{𝒢}}}{{ℛ}_{𝒢}} {\prod }_{i = 1}^{N - 1} \frac{1}{\sqrt{{𝒱}_{ik}}} {( \frac{\partial {𝒳}_{i}}{\partial 𝒢} )}_{k} \vert}_{𝒫}^{\frac{2}{N}} ,\end{matrix} \qquad ( 106 )$$

wherein N represents only the number of variable degrees of freedom that are being simultaneously considered. The name “cursory” is also applied to the weight factor, as rendered in Equations 106, as being consistent with Equation 100.

Note that, in accordance to the present invention, for two degrees of freedom and for bivariate hierarchical coupling, Equations 105 and 106 reduce to a same form, that is:

$${𝒲}_{{𝒢}_{k}} {( \frac{{ℛ}_{𝒢}}{\sqrt{{𝒱}_{𝒢} {𝒱}_{ik}}} \frac{\partial {𝒳}_{i}}{\partial 𝒢} )}_{𝒫 k} . \qquad ( 107 )$$

Weight factors similar to those expressed by Equations 105, 106, and 107 may be expressed in the form of composite weight factors, with the partial derivatives of the path designators being replaced by those of the designated paths, and rendered in accordance with the present invention by the inclusion of the respective skew ratios, as in Equations 108, 109, and 110:

$$\begin{matrix}\begin{matrix}{𝒲}_{{𝒢}_{k}} = \frac{{ℛ}_{𝒢}^{2} {W}_{{𝒢}_{k}}}{{𝒱}_{𝒢}} \\ = \frac{{ℛ}_{𝒢}^{2}}{{𝒱}_{𝒢}} \sqrt{{\sum }_{i = 1} {( \frac{\partial {𝒳}_{i} / \sqrt{{𝒱}_{i}}}{\partial {ℛ}_{𝒢} ( 𝒢 + G ) / \sqrt{{𝒱}_{𝒢}}} )}_{𝒫 k}^{2}} \\ \frac{{ℛ}_{𝒢}}{\sqrt{{𝒱}_{𝒢}}} \sqrt{{\sum }_{i = 1}^{N - 1} \frac{1}{{𝒱}_{ik}} {( \frac{\partial {𝒳}_{i}}{\partial ( 𝒢 + G )} )}_{𝒫 k}^{2}} ,\end{matrix} & ( 108 ) \\ \begin{matrix}{𝒲}_{{𝒢}_{k}} = \frac{{ℛ}_{𝒢}^{2} {W}_{{𝒢}_{k}}}{{𝒱}_{𝒢}} \\ = \frac{{ℛ}_{𝒢}^{2}}{{𝒱}_{𝒢}} {\vert {\prod }_{i = 1}^{N - 1} \frac{\partial {ℛ}_{𝒢} ( 𝒢 + G ) / \sqrt{{𝒱}_{𝒢}}}{\partial {𝒳}_{i} / \sqrt{{𝒱}_{i }}} \vert}_{{𝒫}_{k}}^{- \frac{2}{N}} \\ {\vert \frac{\sqrt{{𝒱}_{𝒢}}}{{ℛ}_{𝒢}} {\prod }_{i = 1}^{N - 1} \frac{1}{\sqrt{{𝒱}_{ik}}} {( \frac{\partial {𝒳}_{i}}{\partial ( 𝒢 + G )} )}_{k} \vert}_{𝒫}^{\frac{2}{N}} ,\end{matrix} \\ and & ( 109 ) \\ {𝒲}_{{𝒢}_{k}} {( \frac{{ℛ}_{𝒢}}{\sqrt{{𝒱}_{𝒢} {𝒱}_{ik}}} \frac{\partial {𝒳}_{i}}{\partial ( 𝒢 + G )} )}_{𝒫 k} . & ( 110 )\end{matrix}$$

Although tailored weight factors, typified by Equations 91 through 94, and spurious weight factors, as typified by Equations 95 and 96, and alternate weight factors, as typified by Equations 97 and 98, may be considered as inherent factors in the rendition of essential and/or cursory weight factors, in accordance with the present invention, they do not necessarily need to be evaluated or distinctly represented in order to render said essential or cursory weight factors in accordance with the present invention.

It should be noted that for deviation paths which correspond to skew ratios which are not rendered as functions of independent variables, the weight factors that would be provided by Equations 100, 101, 103, 104, 106,107, 109, and 110 may reduce to forms characterized in earlier patents (ref. U.S. Pat. Nos. 5,619,432; 5,652,713; 5,884,245; 6,181,976 B1; 7107048; and 7,383,128.) In accordance with the present invention, both functions which include independent variables and functions which include derivatives taken of or with respect to independent variables are considered as being functions of independent variables.

Referring back to FIG. 8, with continued reference to FIG. 11, the normalized weight factor and skew ratio weight factor generator, 112, of FIG. 11 renders a skew ratio weight factor as the skew ratio generated by the mapped deviation path and skew ratio generator, 90, of FIG. 8. The normalized weight factor which is generated by said weight factor generator, 112, is generated as the ratio of said skew ratio divided by the square root of the respectively considered deviation variability.

Skew ratios which are functions of independent variables are considered to be accommodated, in accordance with the present invention, by being implemented as weight factors, as the square root of weight factors, as integral parts of essential weight factors, as integral parts of cursory weight factors, or as integral parts of alternately formulated weight factors.

Skew ratios which are not rendered as functions of independent variables are only considered to be accommodated in accordance with the present invention by being implemented as integral parts of essential weight factors, said essential weight factors being rendered in correspondence with more than two degrees of freedom.

In accordance with the present invention, said skew ratio may be defined as the evaluated ratio of a non-skewed representation for dependent component deviation to a respective coordinate representation for a respectively considered reduction deviation, said ratio including an inverse of said reduction deviation, being evaluated in correspondence with successive estimates for fitting parameters, said successive estimates being held constant during optimizing manipulations, said reduction deviation being rendered in correspondence with undetermined representation for said fitting parameters whose updated values are determined as a result of said optimizing manipulation, said optimizing manipulations including forms of minimizing sums and maximizing likelihood.

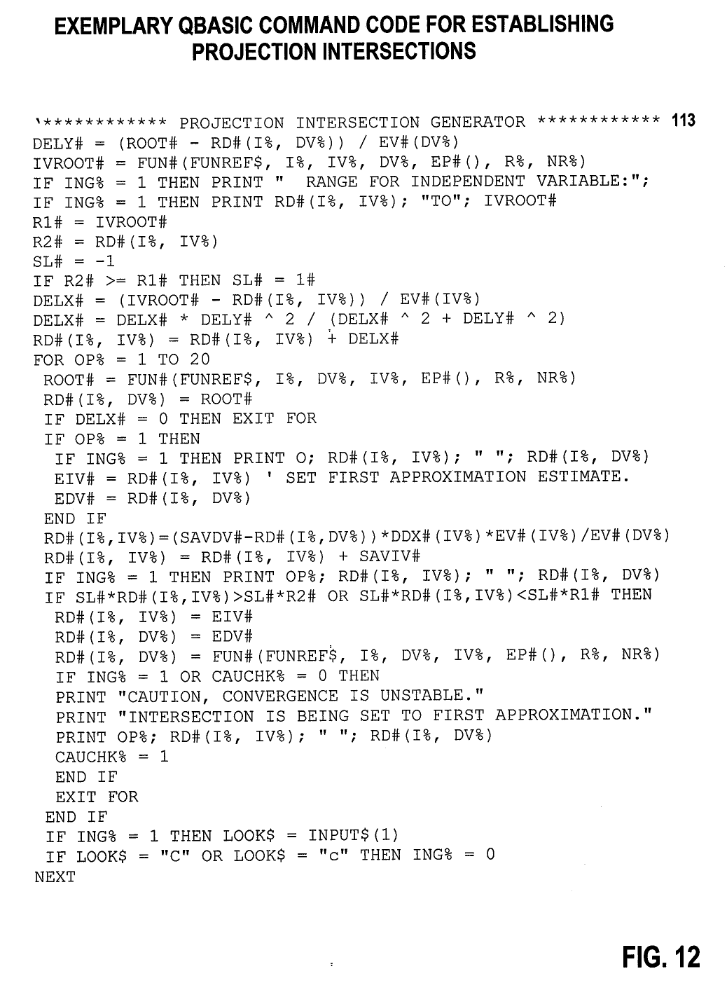

Referring now to FIG. 12 with reference to Equations 44 and 45 and also to FIG. 7, the option to optimize, 81, as provided by the monitor configuration display of FIG. 7 provides for evaluation of the intersection of path-oriented data-point projections with successive estimates for a fitting function as provided by Equations 44 and 45. FIG. 12 provides the exemplary QBASIC command code for rendering a projection intersection generator, 113, for establishing said projection intersections.

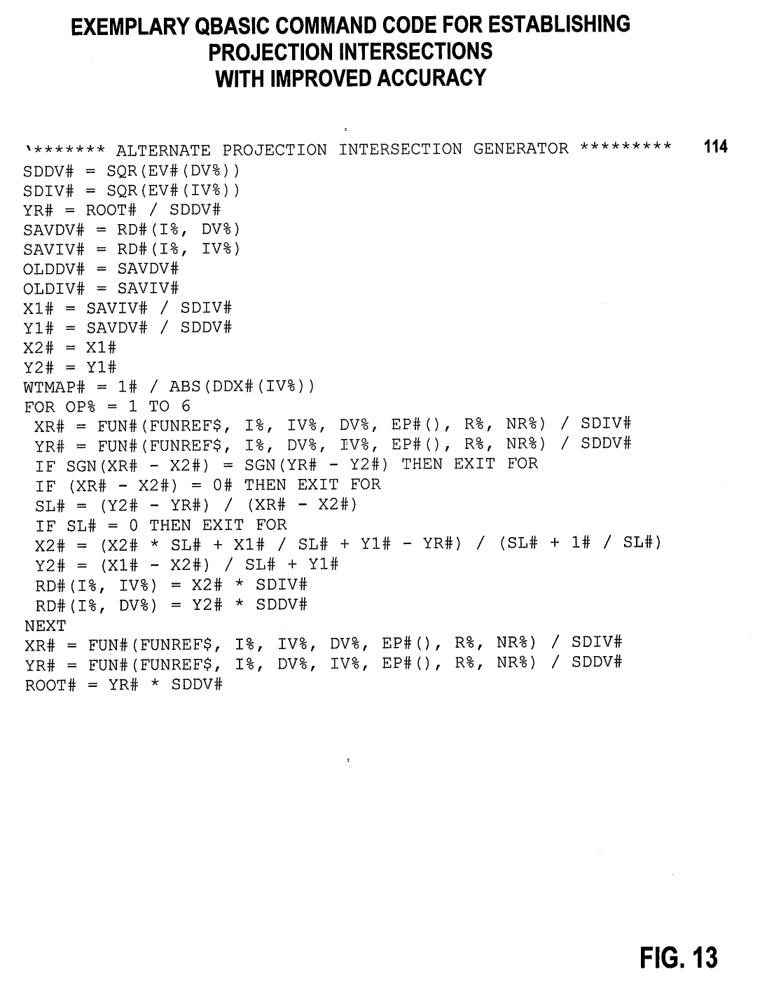

Referring to FIG. 13 with reference to FIG. 12, note that the projection intersection generator, 113, as described in FIG. 12, which was rendered as originally described in FIG. 8 of the Pending U.S. patent application Ser. No. 11/802,533, may only represent a first approximation. In accordance with the present invention, an alternate projection intersection generator, 114, is presented in FIG. 13. This alternate rendition, which is accurate to approximately eight significant figures, has been included in the QBASIC command code files, Einv.txt and Srch.txt, found in the said Appendix File C, and in other command code files that are included in Appendices A and B.

Realize that the easiest and quite often the most accurate approach for maximum likelihood estimating thus far available is the traditional approach of implementing a simple unweighted reduction deviation represented by a simple two-dimensional dependent component deviation normalized as divided by the square root of the effective variance, but the applicability of this approach is restricted to simple two-dimensional regressions and hierarchical representations of the same, with restrictions on rendering likelihood which must be consistent with assumptions in the formulation of Equation 3. When these restrictions cannot be met, for whatsoever reason, an alternate option should be considered.

Referring back to FIG. 5, with regard to an accurate formulation of the normal projection from data to fitting function, 44:

The QBASIC command code of FIG. 13 makes it possible to render a reasonable representation for normal path-oriented data-point projections to be rendered between the data samples along an actual normal to the fitting function. This capability can be accessed via the FIG. 7 option to optimize, 81. However, the associated regressions as provided by said QBASIC command code, even when implemented by improved computer systems, may end up with a somewhat slow convergence to what might possibly represent a valid inversion, or to what might prove to be merely a dip in the locus of convergence. On the other hand, convergence of path coincident deviations and path-oriented data-point projections, being considered over estimated paths, may converge more rapidly and over a wider range but are not defined to necessarily converge to an ideal fit to the data. It appears that convergence of a sum of squared reduction deviations, when appropriately selected and correspondingly rendered to include essential weighting, may be rendered to follow a locus of convergence which will include a close approximation to a best fit for the considered data and corresponding fitting function.

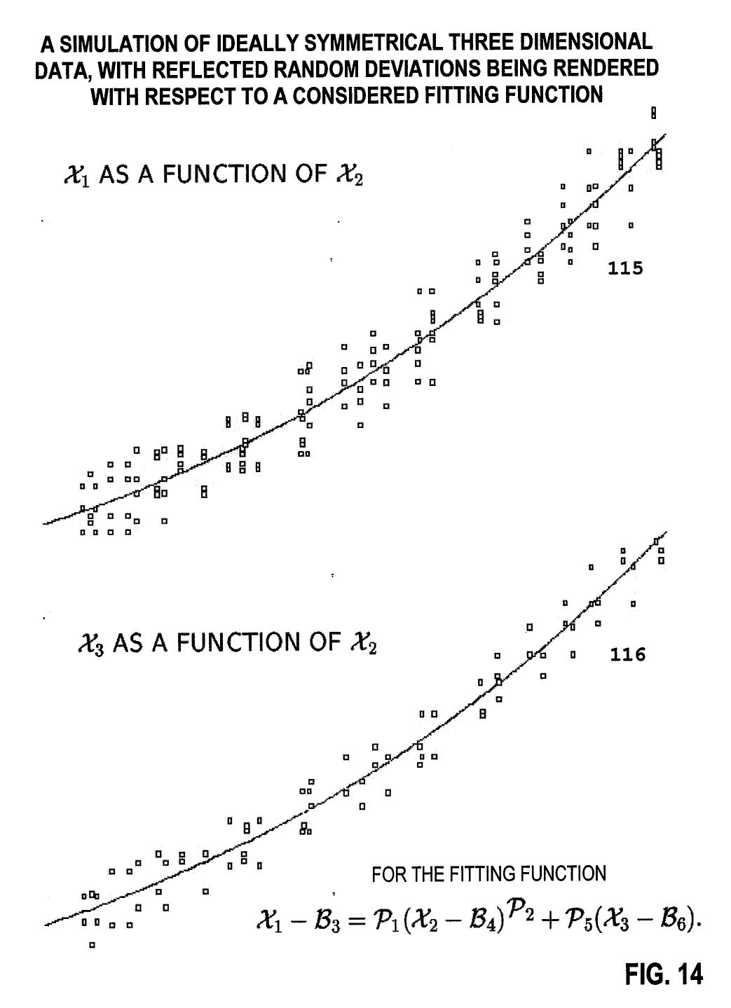

Referring now to FIG. 14 and the QBASIC command code files, Einv.txt and Srch.txt, found in the said compact disk appendix File C, FIG. 14 represents plots of X₁ as a function of X₂, 115, and X₃ as a function of X₂, 116, of simulated ideally symmetrical three-dimensional data, with reflected random deviations being rendered with respect to a considered base function for comparison of inversions being rendered in accordance with the present invention; said base function is expressed by Equation 111:

$${𝒳}_{1} - {ℬ}_{3} = {{𝒫}_{1} ( {𝒳}_{2} - {ℬ}_{4} )}^{{𝒫}_{2}} + {𝒫}_{5} ( {𝒳}_{3} - {ℬ}_{6} ) . \qquad ( 111 )$$

Referring back to FIG. 7 and FIG. 4, data samples rendered by Equation 111 are generated utilizing the data simulation option “8”, 79. To execute the processing of these data either by file Einv.txt or by Srch.bas, follow a procedure similar to that suggested in Example 3 with exception that the option “8” is used to render the data simulation rather that the option “7”, on the monitor display and option selector 26 of FIG. 4

### Example 4

Render the file and processing system for operations of DOS QBASIC.

Initiate execute of the command code by pressing F5. Select the file 3D followed by a period; then enter the following set of keyboard commands: enter 1 1 enter enter enter 8 1 4 2 1 enter enter 2 4 2 1 enter enter 3 4 2 1 enter enter enter enter 1 4 enter enter enter C enter enter enter C to prepare for the actual processing. Then, to render the processing of normal data-point projections, for example, enter the keyboard commands 4 3 enter enter 2 enter enter.

Results of the inversion appear when fifteen iterations occur without increasing the number of significant figures between iterations:
1.510582226068141> [symbol] >1.501831647634542
3.294509057651466< [symbol] <3.295814169183735
8340.364073736591< [symbol] <8469.453119415808
0.2152301160732322> [symbol] >0.2151552611517005
0.01234074027189325> [symbol] >0.01232134250102255
2522.350986144637> [symbol] >2049.759269477669.

The interesting thing is that if you continue the iterations long enough, you might eventually find another locus to follow. Realize that in using essential weight factors type 1, the answer you get is not statistically reliable, and in using essential weight factors type 1, you will always find only a locus of points, without indication which is the preferred fit.

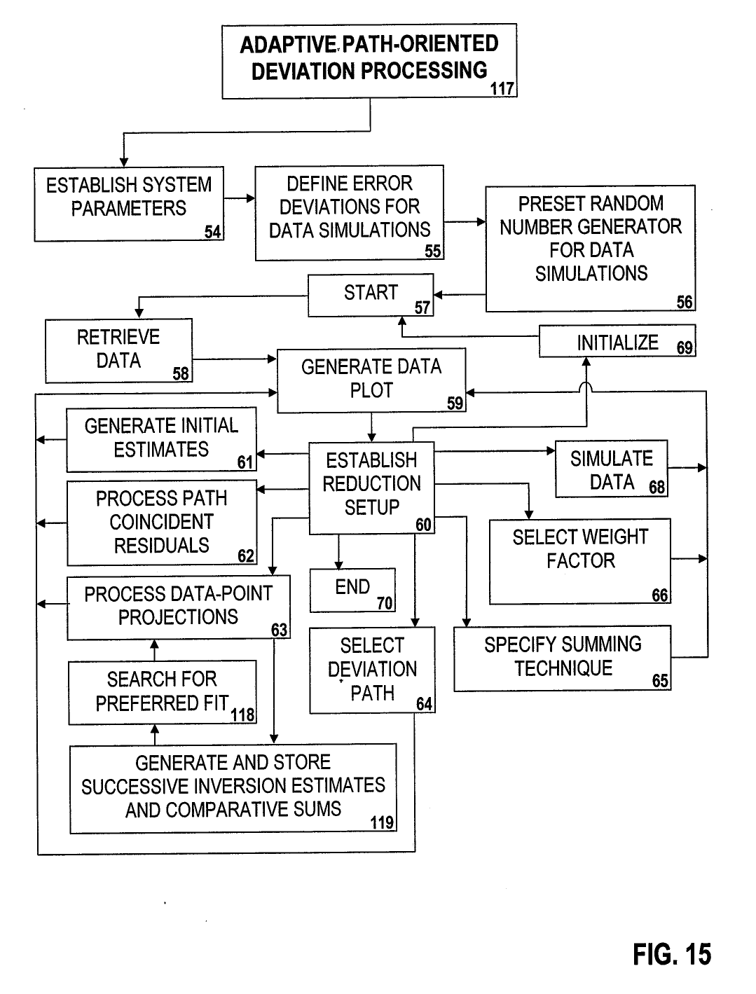

Referring now to FIG. 15, with further reference to the QBASIC command code Locus.txt of Appendix A, as an example of adaptive path-oriented deviation processing implemented to include generating and searching over loci of successive data inversion estimates with a feasibility of encountering a preferred description of system behavior, in accordance with the present invention, FIG. 15 is a repeat of FIG. 6 with exception that the combined techniques processor 67 of FIG. 6 is rendered as means to generate and store successive inversion estimates and comparative sums 119, and provide search for a preferred fit, 118. The QBASIC command code, Locus.txt, as included in Appendix A has been rendered to illustrate and provide this capability including the storing of respective data representations for at least one form of external application as exemplified by the external rendition of FIG. 1.

Options being considered in accordance with the present invention, as provided by the inversion loci generating data processor 22 as exemplified in FIG. 4 in addition to processes exemplified by the flow diagrams of FIG. 6 and FIG. 15 along with the examples of QBASIC command code files of Appendi A, B, and C, of the compact disk appendix file folder, include provision for the rendering of output products comprising memory for storing data for access by application programs being executed on processing systems with data representation being stored in said memory, and rendering alternate forms of output products which provide access to data inversions and evaluated fitting parameters and/or which establish means for producing data representations which establish descriptive correspondence of determined parametric form in order to determine values, implement means of control, or characterize descriptive correspondence by generated parameters and product output in forms including memory, registers, media, machine with memory, printing, and/or graphical representations.

In accordance with the present invention, operations of accessing, processing, and representing information may be provided by a processing system comprising a control system being configured to activate and effectuate said operations, and to formulate, generate, and render associated data representations.

Forms of the present invention are not intended to be limited to the preferred or exemplary embodiments described herein. Advantages and applications of the present invention will be understood from the foregoing specification or practice of the invention, and alternate embodiments will be apparent to those skilled in the art to which the invention relates. Various omissions, modifications and changes to the specification or practice of the invention as disclosed herein may be made by one skilled in the art without departing from the true scope and spirit of the invention which is indicated by the following claims.

What is claimed is:

1. A data processing system comprising a control system, and means for accessing, processing, and representing information,
said control system being configured for activating and effectuating said accessing, processing, and representing said information,
said data processing system comprising means for rendering errors-in-variables data processing whereby at least one data representation is generated,
said data representation comprising results of a search over a plurality of data inversions being rendered to minimize differences between successive fitting parameter approximations in search of specific inversions which respectively coincide with common minimum values for sums of two alternate forms of weighted squares of path coincident deviations,
said path coincident deviations an respective weight factors being rendered in correspondence with said successive fitting parameter approximations,
Weighting of said two alternate forms respectively corresponding to representation of type 1 and type 2 deviation variability,
Said data inversions being rendered in correspondence with sums of weighted squares of a plurality of reduction⁻deviations,
said reduction deviations being rendered in correspondence with path oriented data-point projections and type 2 deviation variability,
said path oriented data-point projections being rendered in the form of dependent coordinate mappings of two-dimensional displacements which characterize restraints associated with the displacement of said observation sampling measurements from a fitting function,
Weighting of said squares of path oriented data-point projections be held constant during optimization by methods of calculus of variation,
said data representation being generated in correspondence with an ensemble of observation samples.

2. A data processing system as in claim 1 comprising means for generating representations for a plurality of weight factor estimates in correspondence with said plurality of reduction deviations,
said weight factor estimates being rendered to accommodate respective skew ratios,
said skew ratios comprising ratios of pre-estimated representations for dependent component deviations respectively divided by pre-estimated representations for said reduction deviations, with said dependent component deviations preferably rendered so as to be characterized by non-skewed uncertainty distributions,
said reduction deviations not being the same as said dependent component deviations, and
representations for said skew ratios being substantially included in rendering said plurality of weight factor estimates;
said data representation being generated by:
establishing said fitting function as a parametric approximative form presumed to correspond to the characteristics of said observation sampling measurements,
representing information whereby at least one automated form of data processing is established in correspondence with said parametric approximative form,
implementing said control system for effecting said at least one automated form of data processing,
activating said control system for accessing, representing and processing said observation sampling measurements,
using said control system to effect said data processing, and
using said control system to render said data representation in the form of said product output;
said effecting including:
rendering said representations for said weight factor estimates as functions of at least one estimate for said at least one fitting parameter in correspondence with said observation sampling measurements and said parametric approximative form,
implementing at least one form of calculus of variation for optimizing representation for at least one estimate for said at least one fitting parameter in correspondence with at least one sum of weighted squares of said plurality of reduction deviations,
The squares of said reduction deviations being respectively weighted as multiplied by respective representation for said weight factor estimates,
said said weight factor estimates being held constant during said optimizing, and
Successive estimates for said skew ratios being substantially included and held constant while rendering representations for said weight factor estimates.

3. A data processing system as in claim 2 wherein said weight factor estimates are essential weight factors,
said data processing system comprising a weight factor generator,
said weight factor generator being implemented with means for generating representations for a plurality of said essential weight factors in correspondence with said plurality of reduction deviations, and
said control system effectuating said generating;
representations for said essential weight factors substantially including products of the squares of said skew ratios multiplied by respective tailored weight factors and divided by respective dependent component deviation variabilities,
said respective dependent component deviation variabilities corresponding in type to the considered form of said reduction deviations,
said tailored weight factors being rendered in correspondence with at least one considered dependent variable as square roots of the squares of partial derivatives of at least one respectively considered independent variable,
combined operations of the squaring of and the taking of the square root of the square of said considered independent variable not being essential for applications in which partial derivatives of only one independent variable are being included in said operations,
measurements of said respectively considered independent variable as rendered in correspondence with respective said observation sampling being substantially characterized by non-skewed homogeneous error distributions, said measurements preferably being rendered as normalized on the square root of respective variability,
said partial derivatives being taken with respect to respective path designators multiplied by respective said skew ratios and divided by the square roots of respective said dependent component deviation variabilities,
respective said dependent component deviation variabilities as well as said skew ratios being held constant during the associated differentiations of said partial derivatives,
said path designators comprising a function portion of said reduction deviations, and
said partial derivatives being evaluated in correspondence with pre-estimated values for said at least one fitting parameter along with considered coordinate values corresponding to respective said observation sampling measurements;
representations for said essential weight factors being generated by:
establishing said parametric approximative form for said fitting function in correspondence with said plurality of observation sampling measurements,
using said control system to substantially represent said plurality of essential weight factors as products of the squares of said skew ratios multiplied by respective said tailored weight factors and divided by respective said dependent component deviation variabilities, and
storing representations comprising said essential weight factors in memory for access by said processing system for representing said weight factor estimates for generating said data representation.

4. A data processing system as in claim 3 wherein said type of dependent component deviation variabilities is rendered in correspondence with pre-estimated variabilities of evaluations for the dependent variable being determined as a function of independent variable observation samples,
said reduction deviations being rendered as path-oriented data-point projections, and
said tailored weight factors being rendered in correspondence with said path-oriented data-point projections.

5. A data processing system as in claim 4 wherein weighting of said two alternate forms of weighted squares of path coincident deviations are rendered in correspondence with prior fitting parameter estimates an respectively rendered as including essential weighting with the first said form one form including type 1 deviation variabilities being rendered as sampling variabilities, said sampling variabilities being associated with respective dependent component observation sampling, and the second said form including type 2 deviation variabilities being rendered in correspondence with pre-estimated variabilities of evaluations for the dependent variable being determined as a function of independent variable observation samples.

6. A data processing system as in claim 5 including means for rendering said data representation in output forms including types of media, memory, registers, printing, graphical representations, and renditions of at least one type of machine with memory, said at least one type of machine comprising memory with descriptive correspondence of said determined parametric form being stored in said memory,
said descriptive correspondence comprising said data representation being stored in said memory for access by an application program being executed on a processing system for rendition of said printing and said graphical representations.

7. A data processing system as in claim 3 wherein said two-dimensional displacements comprise a plurality of transverse displacements being rendered normal to the respectively considered dependent component coordinate axis, and
said transverse displacements extending between observation sampling data points and respective lines which are normal to said fitting function.

8. A data processing system as in claim 3 wherein said data representation is generated in correspondence with at least one common regression of said plurality of observation sampling measurements being simultaneously considered in correspondence with a plurality of variable pairs,
said variable pairs being rendered in correspondence with respectively considered dependent variables,
said processing system comprising means for alternately representing any system related variable as the dependent variable,
said common regression allowing for alternate variables to be represented as the dependent variable within respective said variable pairs,
said two-dimensional displacements being established within the confines of the degrees of freedom that correspond to respective said variable pairs,
the squares of said reduction deviations being respectively weighted to establish compatibility for being included in representing addends comprising alternately considered dependent variables in the rendering of said at least one common regression in a form consistent with said variable pairs, and
said common regression simultaneously including representation of each of said plurality of paired combinations in rendering said at least one data inversion.

9. A data processing system as in claim 3 wherein said observation sampling measurements are multivariate observation sampling measurements representing at least three degrees of freedom, and whereby at least one of data inversion is rendered in correspondence with at least one common regression of a plurality of said multivariate observation sampling measurements being simultaneously considered in correspondence with a plurality of variable pairs,
said variable pairs being rendered in correspondence with respectively considered dependent variables,
said common regression allowing for alternate variables to be represented as the dependent variable within respective said variable pairs,
said plurality of variable pairs comprising a plurality of paired combinations from a set of variables respectively corresponding to said at least three degrees of freedom,
said two-dimensional displacements being established within the confines of the degrees of freedom that correspond to respective said variable pairs with variables not of said pairs being represented as constant during the representation of said two-dimensional displacements,
the squares of said reduction deviations being respectively weighted to establish compatibility for being included in representing addends in the rendering of said at least one common regression in a form consistent with said at least three degrees of freedom, and
said common regression simultaneously including representation of each of said plurality of paired combinations in rendering said at least data inversion;
said effecting including:
establishing said common regression in correspondence with dependent variable descriptions, respectively considered derivatives, and said plurality of multivariate observation sampling measurements,
using said control system to access said plurality of multivariate observation sampling measurements, and
using said control system to render said at least one data inversion in correspondence with said common regression as comprising simultaneous representation of said plurality of variable pairs, with respectively considered dependent variables being considered within said pairs.

10. A data processing system as in claim 2 wherein said weight factors are cursory weight factors comprising products of the square of said skew ratios multiplied by respective pre-estimated spurious weight factors and divided by respective dependent component deviation variabilites, and
said respective dependent component deviation variabilities corresponding in type to the considered form of said reduction deviations.

11. A data processing system as in claim 1 wherein said means for generating representations for a plurality of weight factor estimates is a weight factor generator,
said weight factor generator comprising means for generating representations for a plurality of essential weight factors in correspondence with a plurality of reduction deviations,
said representations being generated by said control system and stored in memory for access by an application program being executed on a processing system,
said representations being implemented by said data processing system for rendering product output comprising descriptive correspondence of determined parametric form being rendered by said processing system to describe behavior as related to at least one data inversion,
said descriptive correspondence comprising a data representation being generated in correspondence with at least one regression of a plurality of observation sampling measurements,
said sampling measurements being included in representing said plurality of reduction deviations so as to characterize restraints associated with the displacement of said observation sampling measurements from a fitting function,
said essential weight factors substantially including representations of products of the squares of skew ratios multiplied by respective tailored weight factors and divided by respective dependent component deviation variabilities,
said respective dependent component deviation variabilities corresponding in type to the considered form of said reduction deviations,
said skew ratios comprising ratios of pre-estimated representations for dependent component deviations respectively divided by pre-estimated representations for said reduction deviations, with said dependent -component deviations preferably rendered so as to be characterized by non-skewed uncertainty distributions,
said reduction deviations not being the same as said dependent component deviations,
said pre-estimated representations being related to pre-estimated values for least one fitting parameter,
said tailored weight factors being rendered in correspondence with at least one considered dependent variable as square roots of the squares of partial derivatives of at least one respectively considered independent variable,
combined operations of the squaring of and the taking of the square root of the square of said considered independent variable not being essential for applications in which partial derivatives of only one independent variable are being included in said operations,
measurements of said respectively considered independent variable as rendered in correspondence with respective said observation sampling being substantially characterized by non-skewed homogeneous error distributions, said measurements preferably being rendered as normalized on the square root of respective variability,
said partial derivatives being taken with respect to respective path designators multiplied by respective said skew ratios and divided by the square root of respective said dependent component deviation variabilities,
said skew ratios and respective said dependent component deviation variabilities being held constant during the associated differentiations,
said path designators comprising a function portion of said reduction deviations, and
said partial derivatives being evaluated in correspondence with pre-estimated values for said at least one fitting parameter along with considered coordinate values corresponding to respective said observation sampling measurements;
representations for said essential weight factors being generated by:
establishing a parametric approximative form for said fitting function in correspondence with said plurality of observation sampling measurements,
utilizing said control system to substantially represent, generate, and establish respective values in memory for said plurality of essential weight factors as products of the squares of said skew ratios multiplied by respective said tailored weight factors and divided by respective said dependent component deviation variabilities, and
representations for said essential weight factors being rendered as considered to be constant between successive approximations for said at least one fitting parameter.

11. A data processing system as in claim 10 wherein said tailored weight factors are rendered in correspondence with said considered dependent variable as the partial derivatives of a single respectively considered independent variable being taken with respect to respective path designators multiplied by respective said skew ratios and divided by the square root of respective said dependent component deviation variabilities, with said skew ratios and respective said dependent component deviation variabilities being held constant during the associated differentiations.

12. A weight factor generator as in claim 10 wherein said tailored weight factors are rendered in correspondence with said considered dependent variable as square roots of the sum of squares of partial derivatives of a plurality of considered independent variables being taken with respect to respective path designators multiplied by respective said skew ratios and divided by the square root of respective said dependent component deviation variabilities, with said skew ratios and respective said dependent component deviation variabilities being held constant during the associated differentiations.

13. A weight factor generator as in claim 10 wherein said type of dependent component deviation variabilities is rendered as sampling variabilities,
said sampling variabilities being associated with respective dependent component observation sampling,
said reduction deviations being rendered as assumed path coincident deviations, and
said tailored weight factors, being rendered in correspondence with said path coincident deviations.

14. A weight factor generator as in claim 10 wherein said type of dependent component deviation variabilities is rendered in correspondence with pre-estimated variabilities of evaluations for the dependent variable being determined as a function of independent variable observation samples,
said reduction deviations being rendered as path-oriented data-point projections, and
said tailored weight factors being rendered in correspondence with said path-oriented data-point projections.

15. A weight factor generator as in claim 10 wherein said data representation is generated in correspondence with at least one common regression of said plurality of observation sampling measurements being simultaneously considered in correspondence with a plurality of variable pairs,
said variable pairs being rendered in correspondence with respectively considered dependent variables,
said common regression allowing for alternate variables to be represented as the dependent variable within said variable pairs,
said sampling measurements being included in representing said plurality of reduction deviations in the form of dependent coordinate mappings of two-dimensional displacements,
said two-dimensional displacements characterizing said restraints,
said two-dimensional displacements being established within the confines of the degrees of freedom that correspond to respective said variable pairs,
the squares of said reduction deviations being respectively weighted to establish compatibility for being included in representing addends in the rendering of said at least one common regression in a form consistent with said variable pairs, and
said common regression simultaneously including representation of each of said plurality of paired combinations in rendering said at least one data inversion.

16. A data processing system wherein at least one data inversion is rendered by determining at least one preferred approximating form in correspondence with a locus of successive data inversion estimates,
said successive data inversion estimates including said at least one data inversion,
said locus being generated by a constrained minimizing of respective sums of weighted squares of reduction deviations,
said minimizing being constrained by holding estimates of said weight factors constant during said optimizing, and
said weight factors being evaluated in correspondence with prior estimates for at least one fitting parameter;
said effecting including:
establishing criteria for searching over a grid for at least one said preferred approximating form over said locus of successive data inversion estimates, and implementing said criteria,
said criteria being established in conjunction specific inversions which respectively coincide with common minimum values for sums of two alternate forms of weighted squares of path coincident deviations,
said path coincident deviations an respective weight factors being rendered in correspondence with said last related inversion estimates,
Weighting of said two alternate forms respectively corresponding to representation of type 1 and type 2 deviation variability.

17. A data processing system as in claim 16 comprising means for generating representations for a plurality of weight factor estimates in correspondence with said plurality of reduction deviations,
said weight factor estimates being rendered to accommodate respective skew ratios,
said skew ratios comprising ratios of pre-estimated representations for dependent component deviations respectively divided by pre-estimated representations for said reduction deviations, with said dependent component deviations preferably rendered so as to be characterized by non-skewed uncertainty distributions,
said reduction deviations not being the same as said dependent component deviations,and
representations for said skew ratios being substantially included in rendering said plurality of weight factor estimates;
said data representation being generated by:
establishing said fitting function as a parametric approximative form presumed to correspond to the characteristics of said observation sampling measurements,
representing information whereby at least one automated form of data processing is established in correspondence with said parametric approximative form,
implementing said control system for effecting said at least one automated form of data processing,
activating said control system for accessing, representing and processing said observation sampling measurements,
using said control system to effect said data processing, and
using said control system to render said data representation in the form of said product output;
said effecting including:
rendering said representations for said weight factor estimates as functions of at least one estimate for said at least one fitting parameter in correspondence with said observation sampling measurements and said parametric approximative form,
implementing at least one form of calculus of variation for optimizing representation for at least one estimate for said at least one fitting parameter in correspondence with at least one sum of weighted squares of said plurality of reduction deviations,
The squares of said reduction deviations being respectively weighted as multiplied by respective representation for said weight factor estimates,
said said weight factor estimates being held constant during said optimizing, and
Successive estimates for said skew ratios being substantially included and held constant while rendering representations for said weight factor estimates.

18. A data processing system as in claim 17 wherein said weight factor estimates are essential weight factors,
said data processing system comprising a weight factor generator,
said weight factor generator being implemented with means for generating representations for a plurality of said essential weight factors in correspondence with said plurality of reduction deviations, and
said control system effectuating said generating;
representations for said essential weight factors substantially including products of the squares of said skew ratios multiplied by respective tailored weight factors and divided by respective dependent component deviation variabilities,
said respective dependent component deviation variabilities corresponding in type to the considered form of said reduction deviations,
said tailored weight factors being rendered in correspondence with at least one considered dependent variable as square roots of the squares of partial derivatives of at least one respectively considered independent variable,
combined operations of the squaring of and the taking of the square root of the square of said considered independent variable not being essential for applications in which partial derivatives of only one independent variable are being included in said operations,
measurements of said respectively considered independent variable as rendered in correspondence with respective said observation sampling being substantially characterized by non-skewed homogeneous error distributions, said measurements preferably being rendered as normalized on the square root of respective variability,
said partial derivatives being taken with respect to respective path designators multiplied by respective said skew ratios and divided by the square roots of respective said dependent component deviation variabilities,
respective said dependent component deviation variabilities as well as said skew ratios being held constant during the associated differentiations of said partial- derivatives,
said path designators comprising a function portion of said reduction deviations, and
said partial derivatives being evaluated in correspondence with pre-estimated values for said at least one fitting parameter along with considered coordinate values corresponding to respective said observation sampling measurements;
representations for said essential weight factors being generated by:
establishing said parametric approximative form for said fitting function in correspondence with said plurality of observation sampling measurements,
using said control system to substantially represent said plurality of essential weight factors as products of the squares of said skew ratios multiplied by respective said tailored weight factors and divided by respective said dependent component deviation variabilities, and
storing representations comprising said essential weight factors in memory for access by said processing system for representing said weight factor estimates for generating said data representation.

19. A product being rendered to include output from an automated data processing system,
said data processing system comprising an automated control system, and means for accessing, processing, and representing information,
said control system being configured for activating and effectuating said accessing, processing, and representing,
said output comprising a data representation being rendered as descriptive correspondence of a determined parametric form,
said descriptive correspondence being represented and stored in the form and embodiment of product output by said data processing system to characterize the behavior of sampled data as related to a plurality of observation sampling measurements,
said embodiment comprising said product being rendered to include said output,
rendition of said descriptive correspondence being generated by said plurality of sampling measurements being stored in memory and transformed by representing and rendering at least one data inversion to describe said behavior in correspondence with said determined parametric form,
said determined parametric form being rendered as a determined fitting function in correspondence with a parametric approximative form,
said fitting function being rendered in at least one preferred approximating form in correspondence with a locus of successive data inversion estimates,
said successive data inversion estimates including said at least one data inversion,
said locus being generated by a constrained minimizing of respective sums of weighted squares of reduction deviations,
said minimizing being constrained by holding estimates of said weight factors constant during said optimizing, and
said weight factors being evaluated in correspondence with prior estimates for at least one fitting parameter;
said effecting including:
establishing criteria for searching over a grid for at least one said preferred approximating form over said locus of successive data inversion estimates, and implementing said criteria,
said criteria being established in conjunction specific inversions which respectively coincide with common minimum values for sums of two alternate forms of weighted squares of path coincident deviations,
said path coincident deviations an respective weight factors being rendered in correspondence with said successive fitting parameter approximations,
Weighting of said two alternate forms respectively corresponding to representation of type 1 and type 2 deviation variability.

20. A product as in claim 19 wherein said data representation is generated in correspondence with at least one common regression of said plurality of observation sampling measurements being simultaneously considered in correspondence with a plurality of reduction deviations,
said sampling measurements being included in representing said plurality of reduction deviations in the form of dependent coordinate mappings of two-dimensional displacements,
said two-dimensional displacements characterizing restraints associated with the displacement of said observation sampling measurements from said fitting function,
said two-dimensional displacements being established within the confines of the degrees of freedom that correspond to respective variable pairs,
each of said variable pairs comprising a considered dependent variable being related to an associated independent variable,
said common regression allowing for alternate variables to be represented as the dependent variable within respective said variable pairs,
the squares of said reduction deviations being respectively weighted to establish compatibility for being included in representing addends in the rendering of said at least one common regression in a form consistent with said plurality of reduction deviations being established within respective said confines,
said processing including generating representations for a plurality of weight factor estimates in correspondence with said plurality of reduction deviations,
said weight factor estimates being rendered to accommodate respective skew ratios,
said skew ratios comprising ratios of pre-estimated representations for dependent component deviations respectively divided by pre-estimated representations for said reduction deviations, with said dependent component deviations preferably rendered so as to be characterized by non-skewed uncertainty distributions, and
said reduction deviations not being the same as said dependent component deviations;
said at least one data inversion being rendered by the method including:
establishing said parametric approximative form for said fitting function in correspondence with said plurality of observation sampling measurements,
establishing said mappings of two-dimensional displacements as related to said respective variable pairs,
implementing said processing system with representations for said weight factor estimates in correspondence with at least one dependent variable description and respectively considered derivatives,
establishing the weighting of said mappings as the weighting of the squares of said reduction deviations being respectively rendered by said plurality of weight factor estimates, and
generating said data representation by using said control system in order to control the functions of activating said accessing, processing, and representing of said information;
using said control system to establish said common regression in correspondence with dependent variable descriptions, respectively considered derivatives, and said plurality of observation sampling measurements,
using said control system to access said plurality of observation sampling measurements,
using said control system to generate representations for the sum of squares of said plurality of reduction deviations being weighted as respectively multiplied by said plurality of weight factor estimates,
using said control system to establish said at least one data inversion in correspondence with said common regression as comprising simultaneous representation of said plurality of respective said variable pairs being included in rendering a sum of weighted squares of said plurality of reduction deviations, with respectively considered dependent variables being represented within said pairs,
using said control system to implement at least one form of calculus of variation in optimizing representation for at least one estimate of said at least one fitting parameter in correspondence with said sum of weighted squares of said plurality of reduction deviations.
